(19) United States
(12) Patent Application Publication
(10) Pub. No.: US 2018/0205546 A1
(43) Pub. Date: Jul. 19, 2018

(54) SYSTEMS, METHODS, APPARATUSES FOR SECURE MANAGEMENT OF LEGAL DOCUMENTS

(71) Applicant: ASSETVAULT LIMITED, London (GB)

(72) Inventors: Farid Haque, London (GB); Vishnu Teja Chundi, London (GB)

(73) Assignee: ASSETVAULT LIMITED, London (GB)

(21) Appl. No.: 15/851,874

(22) Filed: Dec. 22, 2017

Related U.S. Application Data
(60) Provisional application No. 62/441,186, filed on Dec. 31, 2016.

(51) Int. Cl. H04L 9/32; G06F 21/60

(52) U.S. Cl. CPC H04L 9/3213; H04L 9/3297; G06F 21/602; H04L 9/3247

(57) ABSTRACT

The disclosed technology relates generally to systems, methods, or apparatus for secure management/monitoring, recordation, transaction, exchange and/or analysis of assets of asset information via a ledger (e.g., decentralised or distributed) and applications thereof. The system and methods provide, for example, a web-based (e.g., online) and mobile platforms which enables users to securely catalogue or record assets digitally, for instance through cryptographic-enable security techniques. Through machine learning and analysis of value of net assets of a single user or across users, advanced artificial intelligence techniques can be applied to intelligently provide predictive actionable data for use in managing, leveraging and/or protecting assets, including but not limited to suggesting/recommending enhanced insurance coverage, assisting with financing, exchange/transaction of assets, assisting with legal services (e.g., tax advise, facilitating creation of trusts, wills, other legal documents, other asset protection or inheritance related matters), or leveraging assets for lending (e.g., asset-backed lending with collateral).

### PRIORITY CLAIM

This application claims priority as a non-provisional continuation of U.S. Pat. App. No. 62/441,186, filed on Dec. 31, 2016, which is hereby incorporated by reference in its entirety for all that it teaches.

### FIELD OF INVENTION

The disclosed technology relates generally to systems, methods, or apparatus for secure management/monitoring, recordation, transaction, exchange and/or analysis of assets of asset information via a ledger (e.g., decentralized or distributed) and applications thereof.

### BACKGROUND

The invention relates to the secure management of testamentary legal documents by use of a secure encryption system and method. The use of computer systems for providing document verification as well as securely preserving extrinsic evidence of capacity introduces more security, verifiability and convenience into the process of preparing, executing and acting on testamentary documents. Through machine learning and analysis of value of net assets of a single user or across users, advanced artificial intelligence techniques can be applied to intelligently provide predictive actionable data for use in managing, leveraging and/or protecting assets, including but not limited to suggesting/recommending enhanced insurance coverage, assisting with financing, exchange/transaction of assets, assisting with legal services (e.g., tax advice, facilitating creation of trusts, wills, other legal documents, other asset protection or inheritance related matters), or leveraging assets for lending (e.g., asset-backed lending with collateral).

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 104 is first introduced and discussed with respect to FIG. 1).

FIG. 1A illustrates an example block diagram of a host server of able to securely manage/monitor, record, transaction, exchange and/or analyze of assets/asset information/data/metadata via a decentralized ledger (e.g., distributed ledger, distributed database/repository) and applications thereof, in part provided by the host server with the ledger platform, in accordance with embodiments of the present disclosure.

FIG. 1B depicts a schematic of a decentralized ledger implemented using an example of a computerized system with multiple nodes interconnected in a peer-to-peer (point-to-point directly or indirectly) fashion, according to one embodiment. An example configuration of a typical node (e.g., a general purpose computer or special-purpose computer) in the computerized system is further diagrammatically depicted.

FIG. 2 depicts a diagram illustrating example applications (third party or hosted by host server) and/or add-on services facilitated by the host server using a ledger platform which cryptographically secures catalogues/records of physical and digital assets and any associated metadata, in accordance with embodiments of the present disclosure.

FIG. 3 depicts an example block diagram of a host server able to securely manage, monitor, catalogue or log assets via a decentralized ledger and facility various applications and add-on services (third party or hosted) thereof.

FIG. 4A-B depict flow charts illustrating example processes for a user to catalogue assets and its associated data/information in a ledger platform, for a new user and an existing/returning user.

FIG. 5A-D depict flow charts illustrating example processes for recording insurance policies or warranty for assets recorded in the ledger, by new users and existing/returning users.

FIG. 6A-C depict flow charts illustrating example processes to facilitate preparation and submission of insurance claims of assets logged using the insurance policies recorded in the ledger platform.

FIG. 6D depicts a flow chart illustrating example processes for the host server via AI and machine learning techniques, to assess and evaluate sufficiency of an insurance policy (e.g., home contents insurance recorded in the ledger platform).

FIG. 7A-C depicts example screenshots showing views of an advisor portal administered by the host server showing user information, asset information, insurance information and/or other financial information stored, generated and/or logged on the ledger platform.

FIG. 8A-H depict example screenshots of the web application administered by the host server for the secure management, monitoring, cataloguing of assets and asset information and providing access to add on services (e.g., advanced machine learning, analytics, artificial intelligence and actionable insights) and third party applications/services (legal, accounting, financial advisor, insurance provider, etc.).

FIG. 9A-B depict flow charts illustrating example processes for the host server to intelligently determine or generate appropriate will templates to provide to the user and to facilitate completion of the will using information of the user's assets and the user's family stored in the ledger platform, according to one embodiment.

FIG. 10A-G depicts example screenshots showing processes for the host server to securely notify a designated executor of a testator's triggering life event and securely providing access of, the testator's will recorded in the ledger platform, to the executor, according to one embodiment.

FIG. 11A-P depict example screenshots of the web application administered by the host server for obtaining user information, family information and information about other potential beneficiaries for use in administering and facilitating the creation of a will (e.g., a digital will, e-will, eWill). In some embodiments, similar processes can be used to facilitate the creation, generation, administration, and/or management of trusts and/or other legal documents or inheritance related matters.

FIG. 12A-J depict example screenshots of the web application administered by the host server for obtaining asset list, asset information/data/metadata, user's business information, employment information, retirement account information, pension, insurance information, and enabling the user to specify details in bequeathing assets for the administering and the creation of a will (e.g., a digital will, e-will, eWill to be stored and managed on the ledger platform). In some embodiments, similar processes can be used to facilitate the creation, generation, administration, and/or management of trusts and/or other legal documents or inheritance related matters.

FIG. 13A-D depict additional example screenshots of the web application administered by the host server for determining a user's preferences regarding funeral ceremony type, religious affiliation and any other wishes.

FIG. 14 depicts an example screenshots of the web application administered by the host server which enables the user to create a mirror will. An example of a mirror will is included in Appendix I.

FIG. 15 depicts an example screenshot of the web application administered by the host server which enables the user to create a video message to be delivered to family members or other beneficiaries upon the occurrence of a life event, according to one embodiment.

FIG. 16 depicts an example screenshots of a will and testament created by the host server for a user and recorded in the ledger platform for access and administration by authorized individuals (e.g., executors, trustees, family members, other beneficiaries), according to one embodiment.

FIG. 17A-N depict example screenshots of a mobile application administered by the host server for secure management and monitoring of assets and asset information on a ledger platform in accordance with embodiments of the present disclosure.

FIG. 18 shows a diagrammatic representation of a machine in the example form of a computer system within which a set of instructions, for causing the machine to perform any one or more of the methodologies discussed herein, may be executed.

FIG. 19A-B depicts a flow chart illustrating example processes to facilitate preparation and submission of a multi-country will for a first time user.

FIG. 20A-C depicts a flow chart illustrating example processes to facilitate preparation and submission of a multi-country will for a returning user.

FIG. 21A-C depict a process to conduct a logistic regression model to classify models of watches and assess their market value.

FIG. 22 depicts a flow chart illustrating example processes to utilize cryptographic techniques to establish a verifiable record of an electronic will or other testamentary legal instrument.

FIG. 23 depicts a process for T+1 features where T is a life event.

FIG. 24 depicts an inheritance family tree flow chart.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments. Additional embodiments are described in the attached Appendix, which is incorporated into this Specification for all that it teaches.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems, methods, or apparatus for secure management/monitoring or analysis or assets via a ledger (e.g., decentralized or distributed ledger, database or repository) and applications thereof.

Embodiments of the present disclosure include systems, methods, or apparatus for secure management/monitoring or analysis or assets via a ledger (e.g., decentralized or distributed ledger, database or repository) and applications thereof. Embodiments may include a computer system comprised of at least one server for securely storing verifiable copies of testamentary documents comprising:

a module adapted by logic to receive text description of an asset and to receive a selection of an asset category, and to assign the received text and selection to a corresponding encryption token;
a database adapted by logic to store at least one data record representing an electronic will, said data record comprised of at least one asset listing and one corresponding encryption token, said data record having a corresponding token and time stamp, said token calculated using the time stamp and contents of the data record;
a module adapted by logic to implement a video chat room and electronic signature operation that receives an electronic signature from the user while the chat room is active, and further, records the video chat room into a video data file that is a component of the will data record;
a ledger comprised of the at least one token associated the at least one data record.

The computer system may be comprised of a server and a user's remote device and a witness' remote device, performing a method of verifying an electronic will document comprising:

Commencing a video chat session hosted on the server between a user's remote device and the witness' remote device;
Displaying in the chat session a will document;
Receiving from the user an electronic signature associated with the document;
Transmitting to the witness remote device the receipt of the electronic signature;
Recording the video chat session and encoding the recorded video into a digital video file;
Determining a digital signature for the digital video file;
Updating and storing a data record associated with the user to include a reference to the digital video file;
Recalculating a security token for the data record associated with the user;
Updating a ledger to include the security token and a reference to the updated and stored data record.

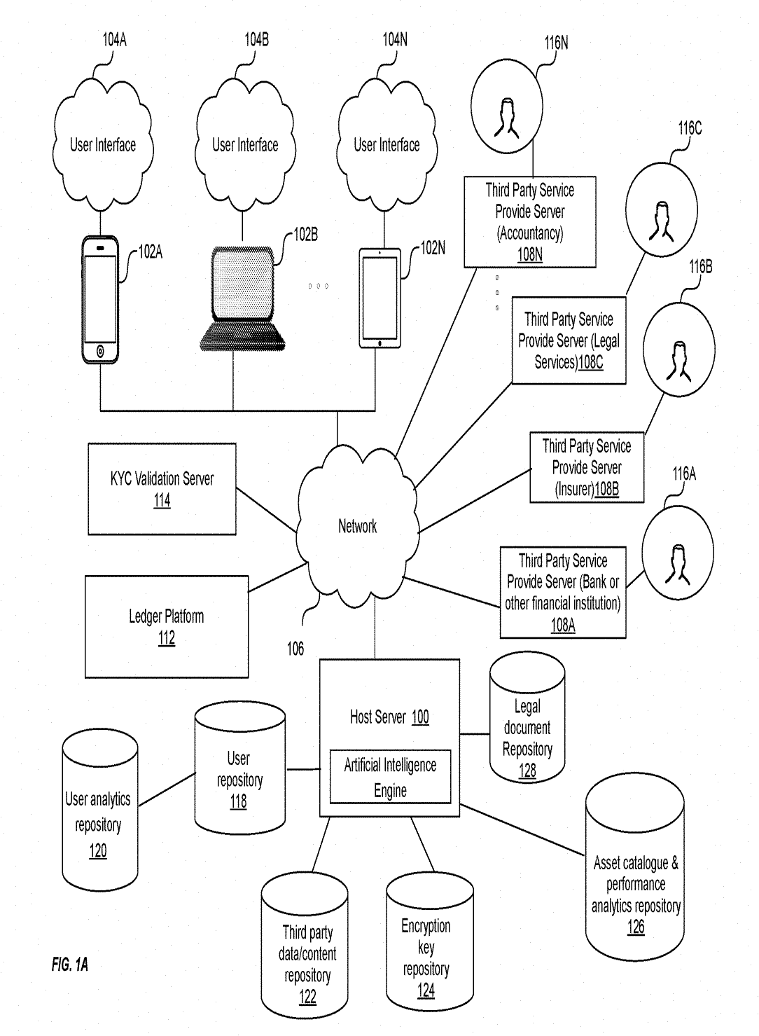

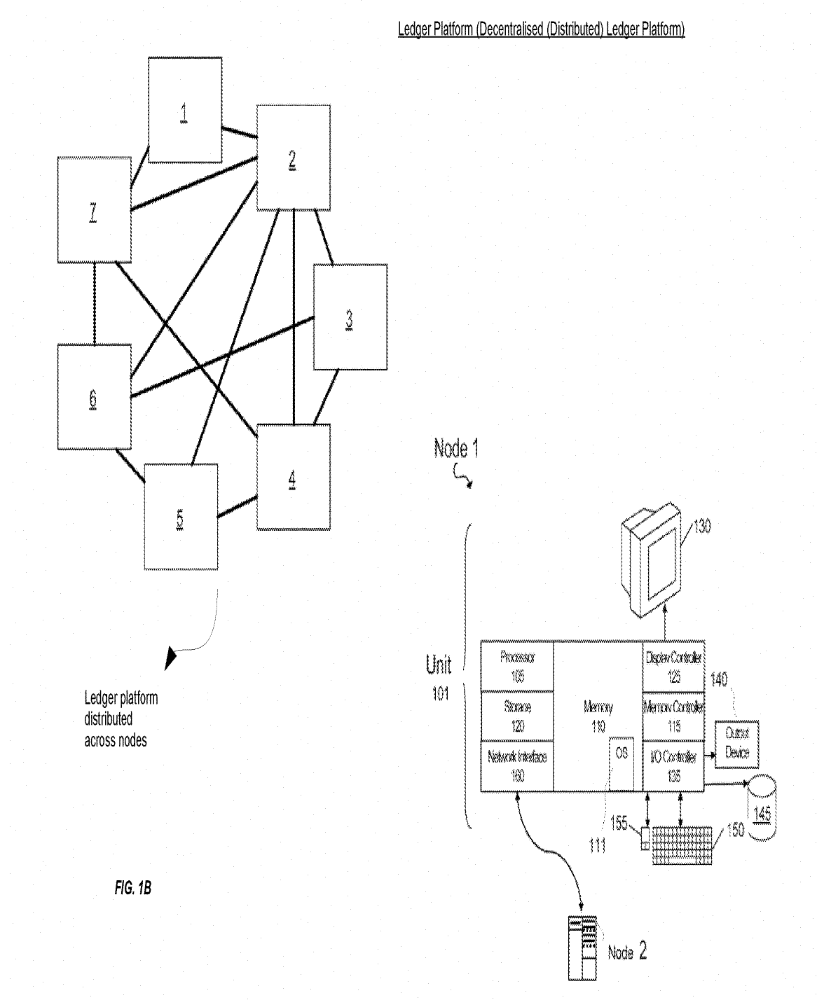

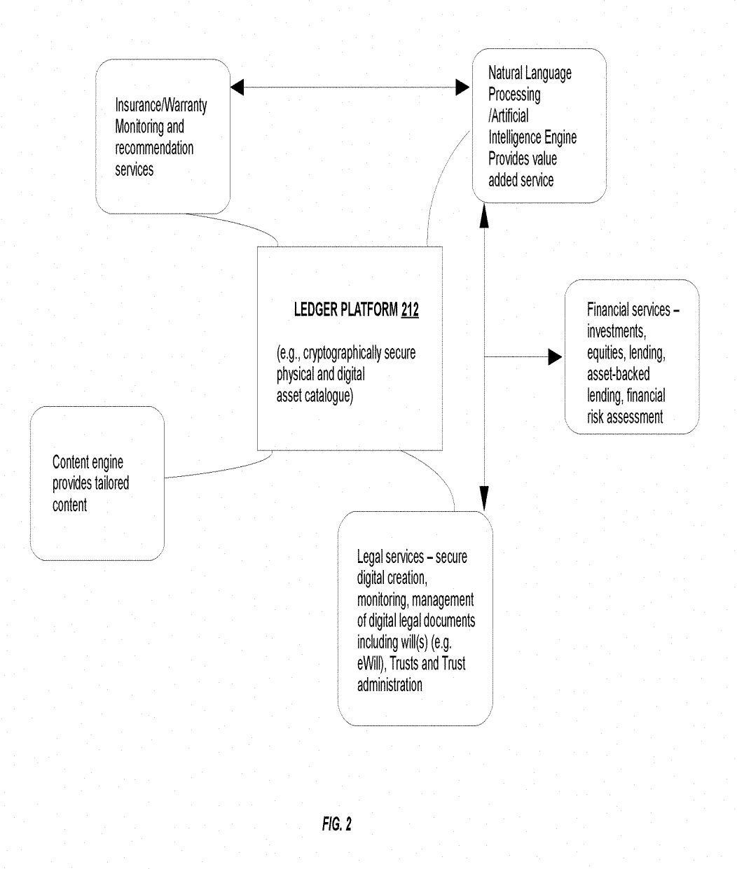

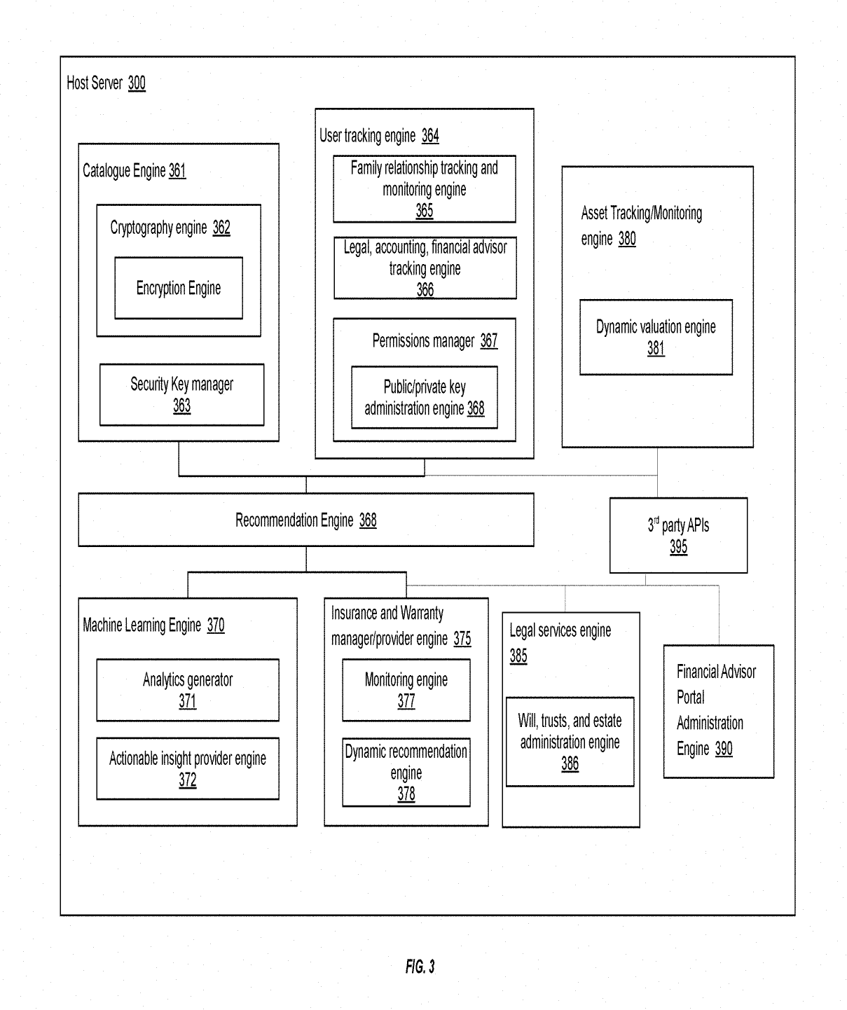

FIG. 1A illustrates an example block diagram of a host server of able to securely manage/monitor, record, transaction, exchange and/or analyze of assets/asset information/data/metadata via a decentralized ledger (e.g., distributed ledger, distributed database/repository) and applications thereof, in part provided by the host server 100 with the ledger platform 112.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. The input mechanism on client devices 102 can include touch screen keypad (including single touch, multi-touch, gesture sensing in 2D or 3D, etc.), a physical keypad, a mouse, a pointer, a track pad, motion detector (e.g., including I-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

The client devices 102A-N, the host server 100, third party service provider servers 108A-N, the respective networks of users 116A-N, a ledger platform 112, and/or the KYC validation server 114, can be coupled to the network 106 and/or multiple networks. In some embodiments, the devices 102A-N and host server 100 may be directly connected to one another. The third party services hosted by the third party service provider servers 108A-N can include any brick and mortar, online or web-based services including, banking/financial institution services, insurance services, legal services, and/or accountancy services.

In one embodiment, the host server 100 is operable to securely log, manage, monitor, track and/or assess assets using information or metadata stored or recorded regarding the assets on the ledger platform 112. Embodiments of the present technology is compatible with various decentralized or distributed ledger platforms, by way of example not limitation, Ethereum or other public, semi-public, semi-private or private ledger platforms or ledger network.

In general, in recording or logging an asset, its associated data or metadata can be received in a data message or transaction record from the client devices 102A-N and/or the host server 100 at the ledger platform 112. A portion of the ledger administered by the ledger platform is created or updated to correspond to the respective asset. In one embodiment, a combination of a unique right or token as proof of ownership and/or a hash of the data or metadata associated with the asset information can be transmitted through the network 106 and recorded and stored as a transaction record as a block or other one or different data structures in the ledger platform 112. The transaction recorded in the ledger platform 112 for a given asset can include data recording the value, an address, a source address, a timestamp, permissions, and/or indicators regarding insured value or other insurance-related metadata.

Each transaction, or logging/recordation of asset information onto the ledger platform 112 can be digitally signed (e.g., cryptographically). For example, the digital signature may be, include or otherwise be associated with security metadata generated using the encryption key, which can be associated with asset information in the ledger. In some embodiments, the address may be encoded using one or more hashing and/or encoding algorithms, by way of example but not limitation as the Base58Check encoding algorithm. Additional schemes include SHA-256 algorithm and script. Other hashing algorithms which can be used include by way of example not limitation Blake, SHA-3, and Xl 1

The generation and use of security information for the transfer, exchange and/or storage of asset information in distributed ledger-based transactions using the network 106 may, in one embodiment, be apparent to persons having skill in the relevant art. The encryption key may be part of a key pair, such as a public key corresponding to a private key stored in the host server 100 or client devices 102A-N. In some instances, the users of devices 102 may provide the public key or private key to the recipients or an authorized person/entity (e.g., beneficiaries, family members, advisors (financial, insurance, legal, accountancy, tax advisors) of various assets logged in the ledger. Alternatively, the host server 100 provides the public or private key, or key combinations to a recipient or otherwise authorized person of one or more catalogued assets in the ledger 112. Note that transaction requests can be submitted through the host server 100 to be recorded, logged, or stored on the ledger of the ledger platform 112. In one embodiment, the transaction requests are recorded, logged, or stored directly in the ledger administered by the ledger platform 112.

The transaction request may be a transaction message and may be formatted based on one or more standards for the governance thereof, such as the International Organization for Standardization's ISO 8583 standard. In some instances, the host server 100 receives the transaction request to log an asset or to access data associated with a logged asset and may generate any number of subsequent transaction messages.

The transaction message can include multiple data elements, which can be associated with specific usage, for example based on the one or more standards or based on an application (e.g., third party application) or requesting entity to access the asset information. In some embodiments, the data elements can include a data element for the storage of asset information and also include one or more data elements reserved for private use by third party use (e.g., by third party financial institution, insurer, lawyer, and/or accountant). The transaction message submitted to the host server 100 may include a data element reserved for use that includes data associated with the storage address/location of asset information on the ledger of the ledger platform 112.

For instance, the data element reserved for private use may include a network identifier, an asset identifier, an asset-specific identifier a user identifier, a beneficiary identifier, or other data fields specific to the type of asset logged, recorded, exchanged, or transacted, and at least one of: a public key and an address identifier. The network identifier may be associated with a ledger associated with the ledger platform 112 in the transaction. The network identifier may be used by the host server 100 to identify the associated ledger in the ledger platform 112 for posting of the eventual transaction for logging or accessing information associated with a given asset.

In some embodiments, the transaction message may include information for multiple recipients, beneficiaries, or otherwise authorized individuals or entities with access to the asset or asset information. In such an embodiment, the data element reserved for use may include multiple transaction amounts and associated address identifiers and/or public keys. In another embodiment, the transaction message may include multiple data elements reserved for private use, with each one including a different address identifier and/or public key associated with an authorized entity.

The term “assets,” “physical assets” or “digital assets” that can be logged, managed or monitored in the ledger platform 112 can include to any tangible or intangible assets including, but not limited to, currencies, electronic currencies, bonds, stocks, patents, copyrights, buildings, land, plots, property, vehicle, equipment, documents (digital or physical) having a financial value such as mortgages, insurance documents, titles, contracts or digital tokens representing such assets. The term “electronic currency” can include, digital currency, virtual currency, crypto-currency, digital currency, digital tokens or any other electronically created and stored medium of exchange. Assets further include tangible currency or any fiat currency of a country including by way of example and not limitation, the pound sterling, the United States Dollar, the Euro, the Hong Kong Dollar, the Singaporean Dollar, the United States Dollar, the Australian Dollar, the Chinese RMB, the Canadian Dollar, etc.

Functions and techniques performed by the host server 100 and the components therein are described and illustrated in detail with further references to the examples of FIG. 3.

In general, network 106, over which the client devices 102A-N, the host server 100, and/or various third party service providers (e.g., banks, insurers, legal, accountancy services, etc.) 108A-N, ledger platform 112, and/or KYC validation server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-n and the host server 100 and may appear as one or more networks to the serviced systems and devices. In one embodiment, communications to and from the client devices 102 can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT• Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository, a user analytics repository 120, a third party data/content repository 122, an encryption key repository 124, an asset catalogue & analytics repository 126, and/or a legal document repository 128. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOinstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to provide, create, or generate data to be stored in the user repository, the user analytics repository 120, the third party data/content repository 122, the encryption key repository 124, the asset catalogue & analytics repository 126, and/or the legal document repository 128. The user repository 128 and/or user analytics repository 120 can store user information, user profile information, user location information, user's family information, demographics information, analytics, statistics regarding usage patterns/frequency of the ledger platform 112.

In general, the host server 100 operates in real-time or near real-time and is able to generate useful analytics/statistics regarding assets, asset information for a given user. In some instances, actionable insight can be intelligently generated for a user to better leverage (e.g., through extracting or releasing equity aggregated in certain assets for leveraging or financing purposes (e.g., for use in secured or asset backed lending or borrowing, release of equity for purchases or investments) or protect their assets (e.g., risk assessment; through optimized insurance or warranty coverage tweaked from automatic identification insurance/warranty products that are better priced, or detection of the need to adjust coverage based on changes in environmental, circumstantial factors, or changes in asset value).

The host server 100 can also generate analytics for asset classes using industry or expert data (e.g., stocks, DJIA, Nikkei, FX rates, S&P, equities, commodities, real estate data, etc.) regarding various asset classes or different industries to be provided to the user or for use in generating actionable insight for users in managing their assets, based on asset information logged/recorded in the ledger platform 112. Such information can also be provided to professional advisors of the user. Such examples are further illustrated in the diagram of FIG. 2. The analytics repository 126 and/or the third party content repository 122 are able to store third party (e.g., industry, expert) content/resources and analytical data generated by the host server 100, third parties or a combination thereof.

FIG. 1B depicts a schematic of a decentralized ledger implemented using an example of a computerized system with multiple nodes interconnected in a peer-to-peer (point• to-point, directly or indirectly) fashion, according to one embodiment. An example configuration of a typical node (e.g., a general purpose computer or special-purpose computer) in the computerized system is further diagrammatically depicted.

As shown in FIG. 1B, the ledger platform (e.g., the ledger platform of FIG. 1A) can in one embodiment, be comprised of any number of interconnected nodes 1-7. Each of the nodes is configured to transmit, receive and store data. In a decentralized architecture, a digital signature protocol of the ledger platform can be, for example, implemented by the interconnected nodes 1-7. The describes methods herein can be executed at one or (typically) more nodes of the system.

The ledger platform (e.g., ledger platform 112) comprised of interconnected nodes can be confined to a small system, for example a private network or a company network, or, as another example, may include a company network in communication with one or more third• party networks, to form a computerized system. Thus, the data to be stored or accessed is not necessarily stored on a particular node that triggers the crawling operations. Rather, the data may be scattered through different nodes of one or more interconnected nodes. In embodiments, the ledger platform (e.g., ledger platform 112) is decentralized, peer-to-peer, or, in variants, may encompass some hierarchical topology combined with a peer-to-peer architecture. Each node may be a computerized unit, for example, a general-purpose computer/hardware or a special purpose computer/hardware.

FIG. 2 depicts a diagram illustrating example applications (third party or hosted by host server) and/or add-on services facilitated by the host server (e.g., the host server of FIG. 1 and FIG. 3) using a ledger platform which cryptographically secures catalogues/records of physical and digital assets and any associated metadata, in accordance with embodiments of the present disclosure.

Using the ledger platform 212, innovations of the present disclosure can provide online and mobile platform that provides a secure digital asset catalogue, enabling users to catalogue, protect and/or unlock the value of their physical assets.

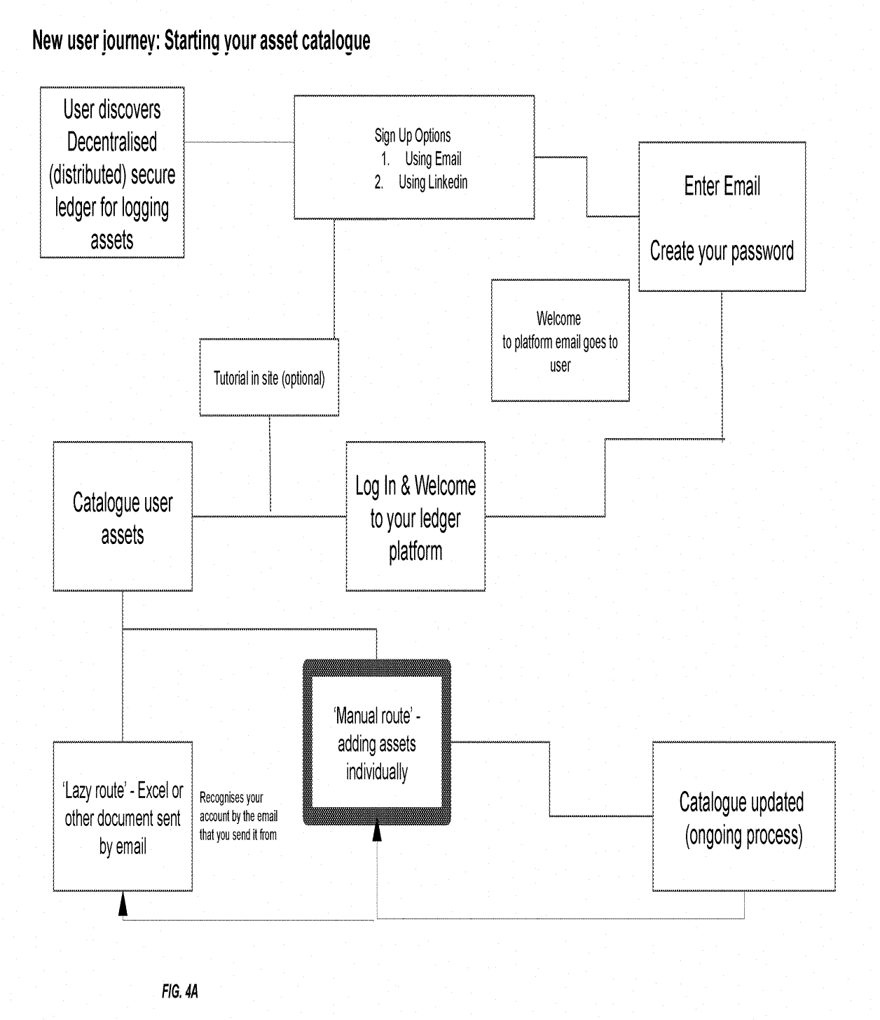

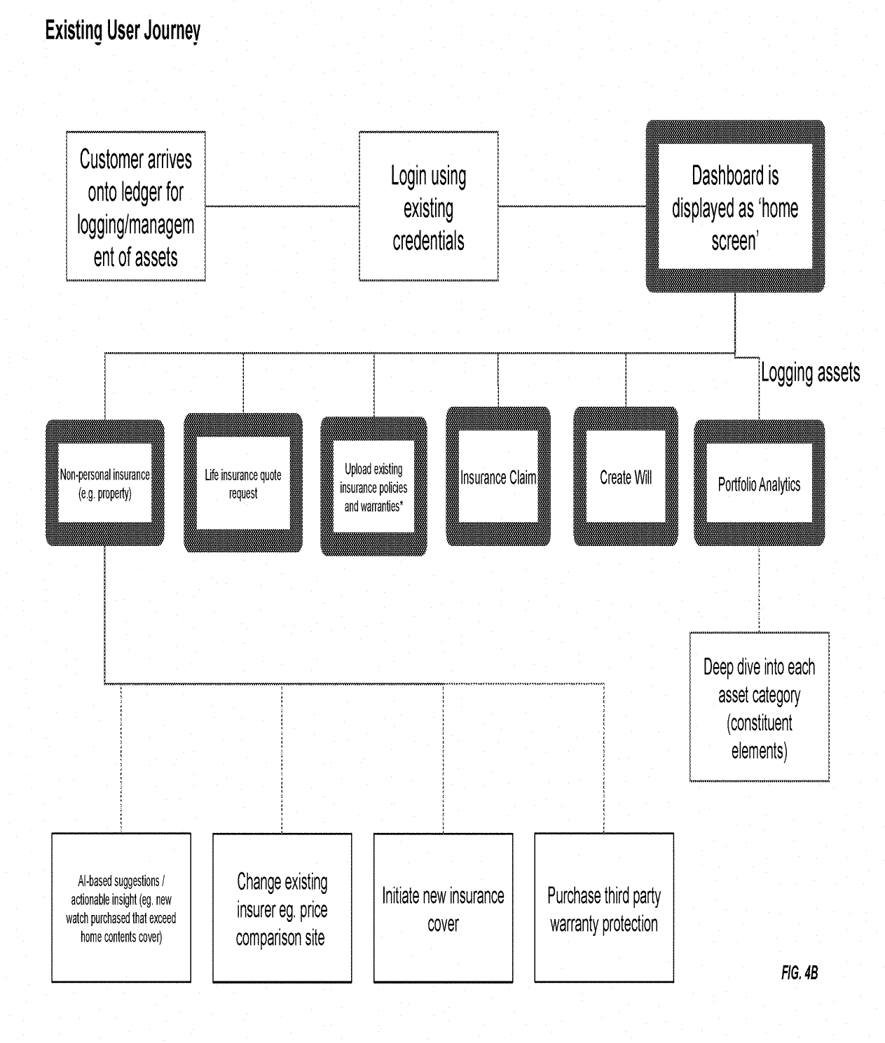

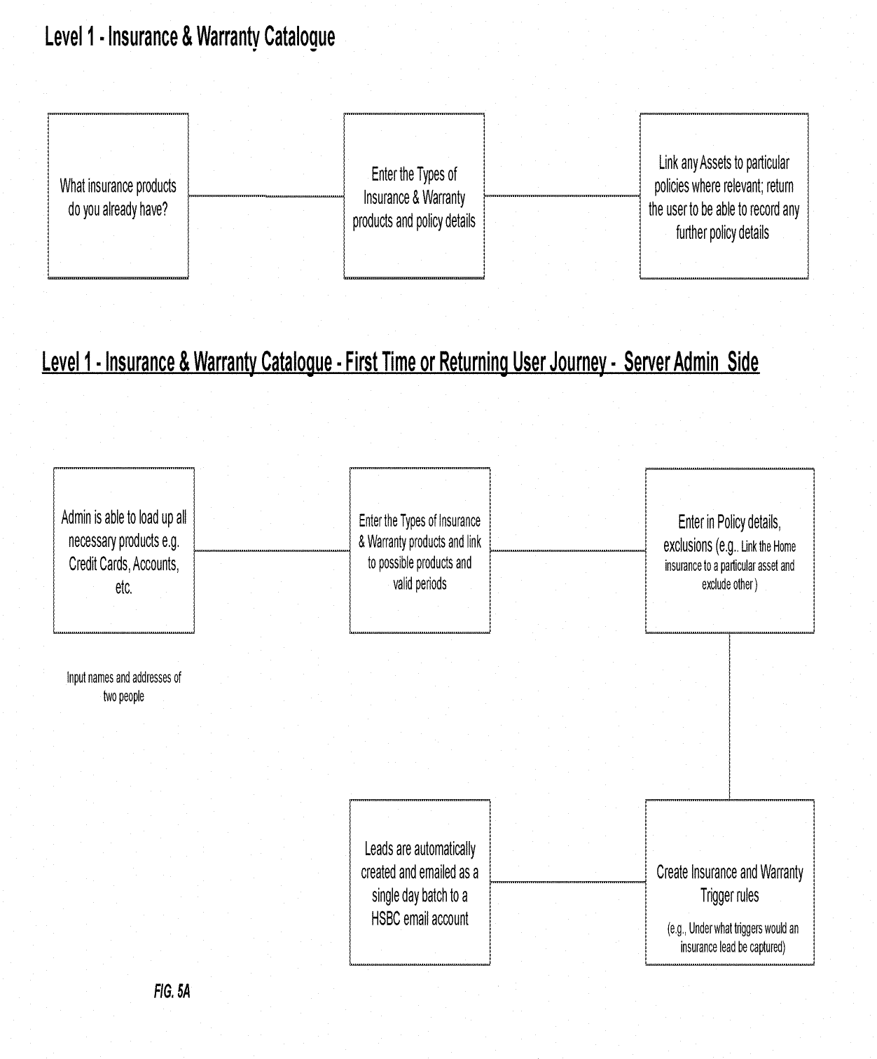

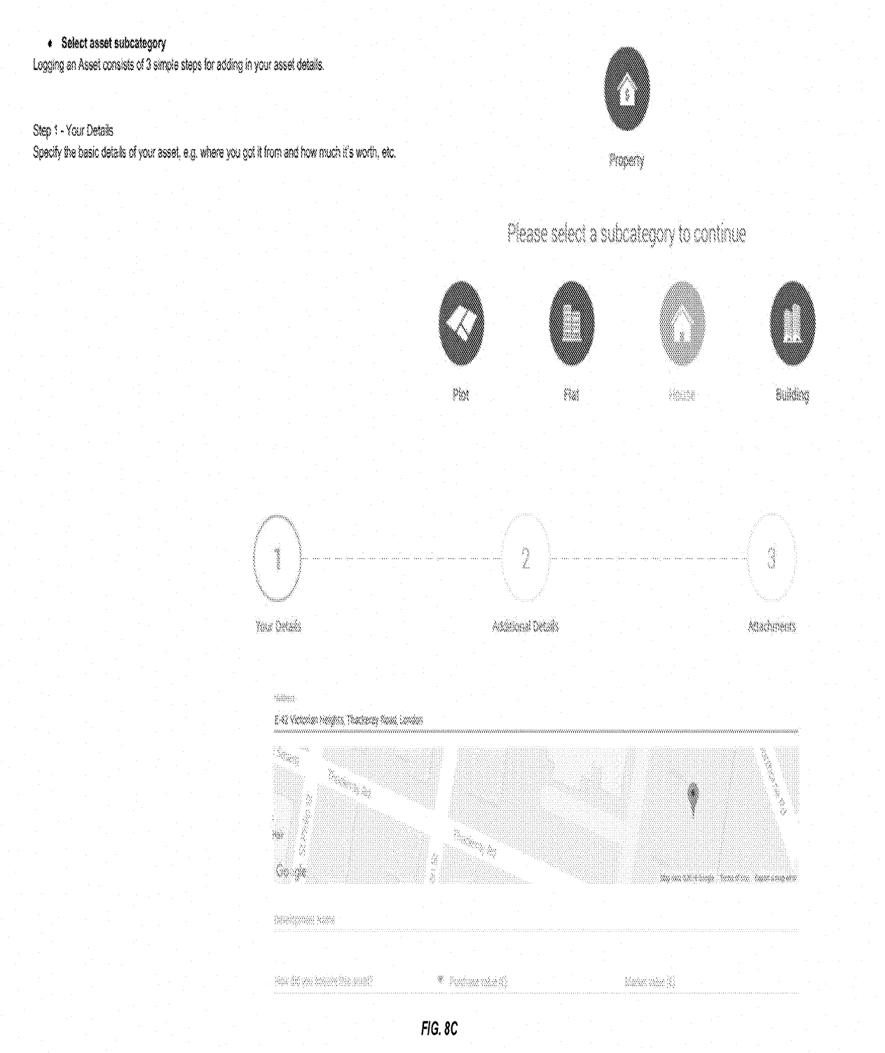

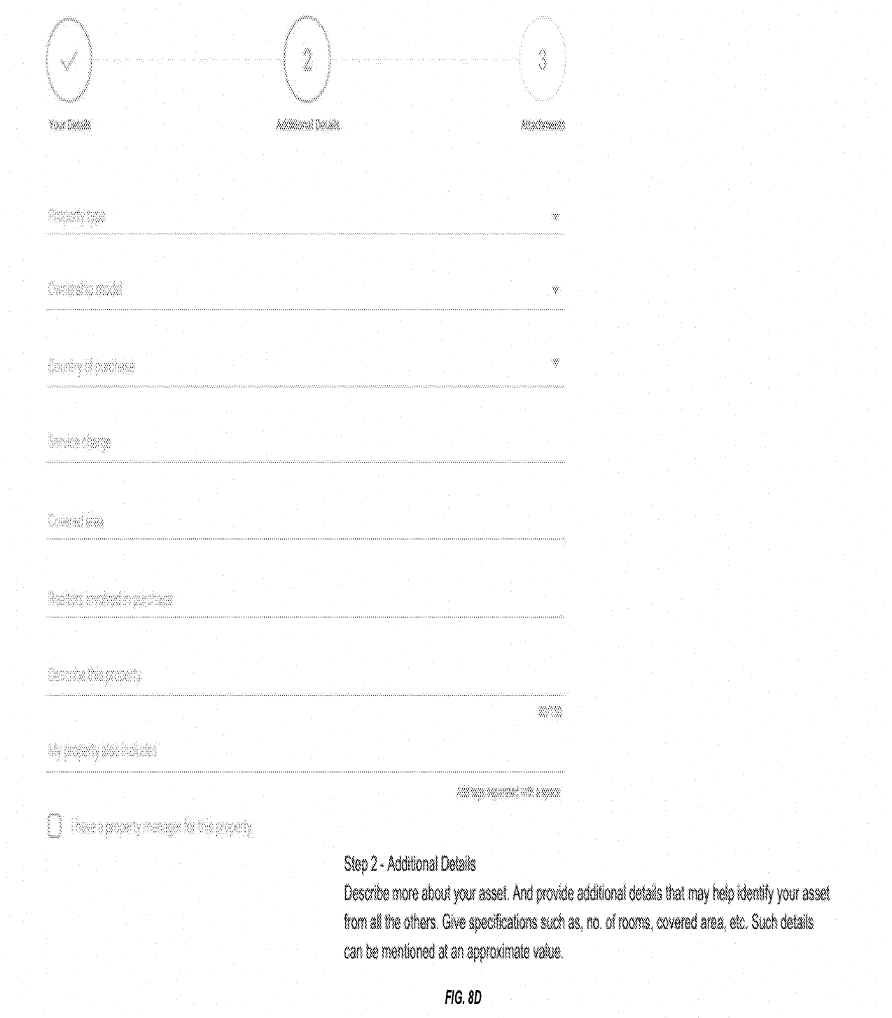

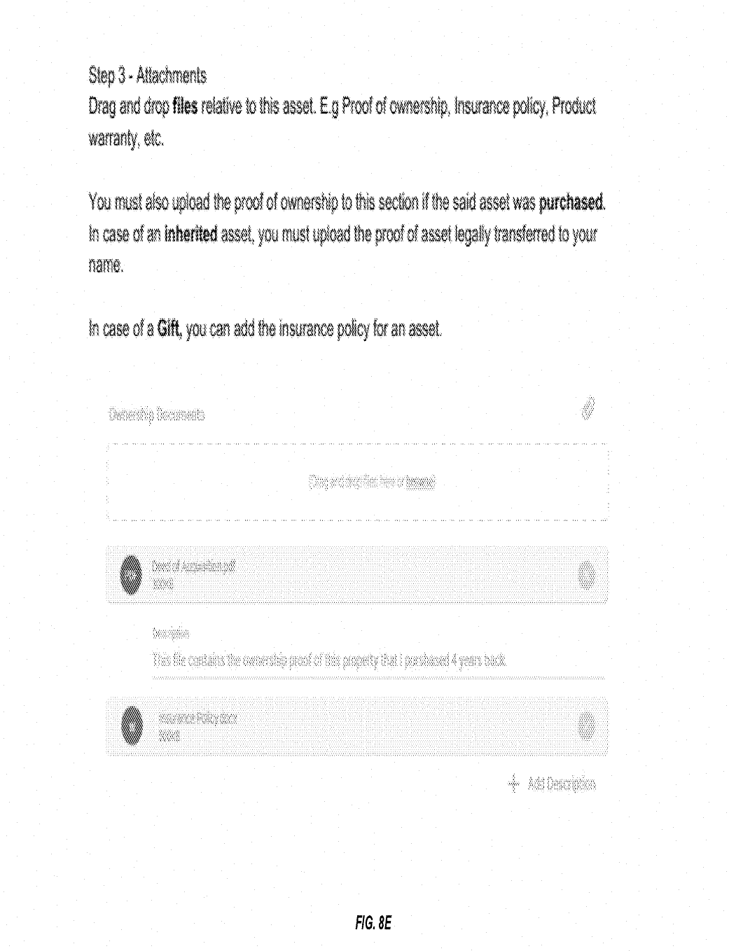

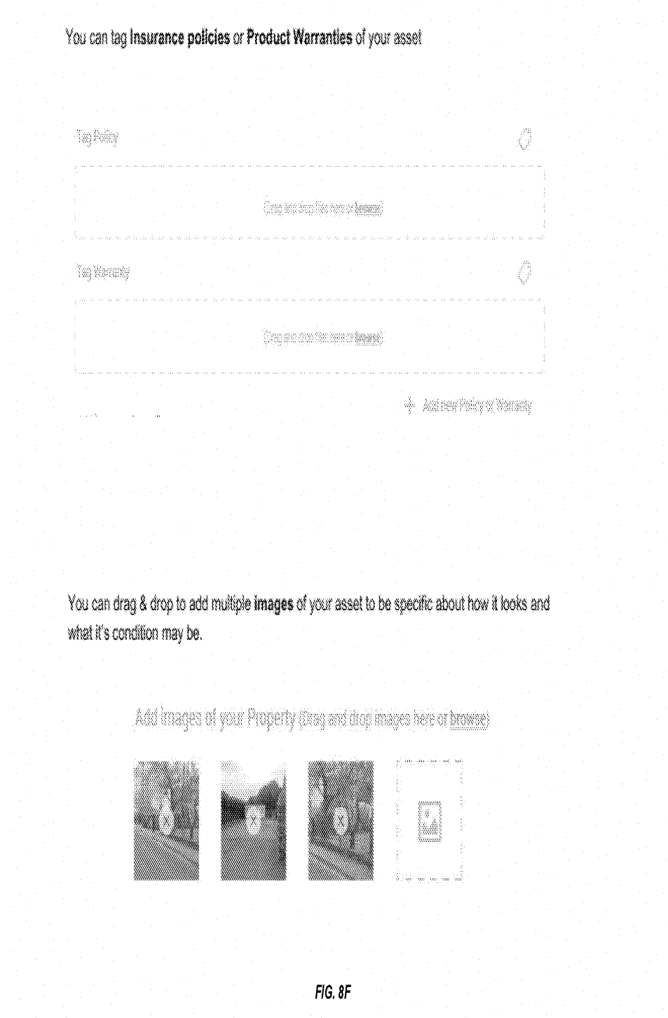

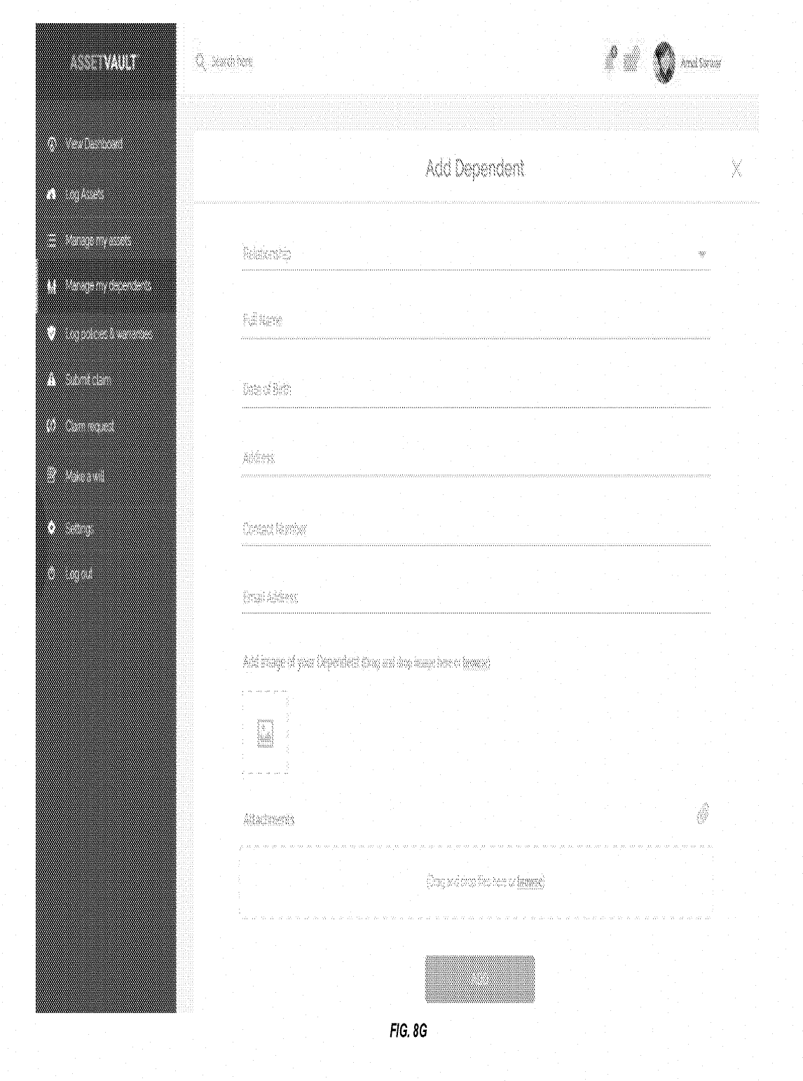

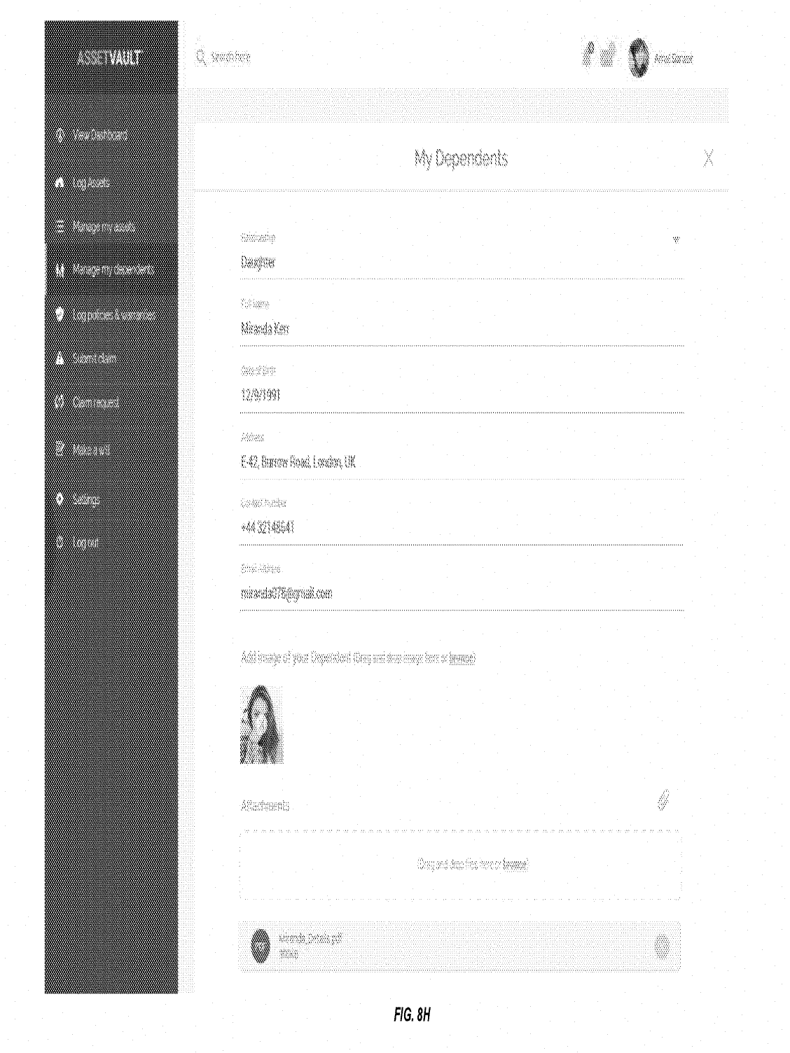

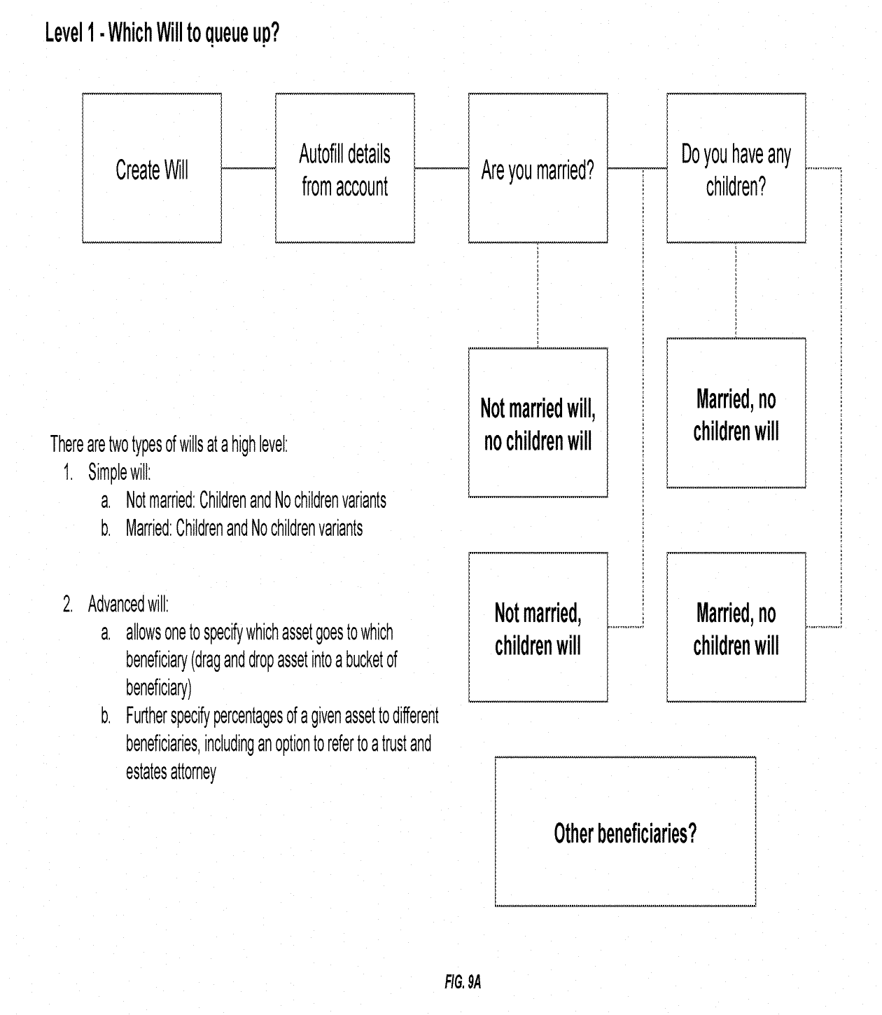

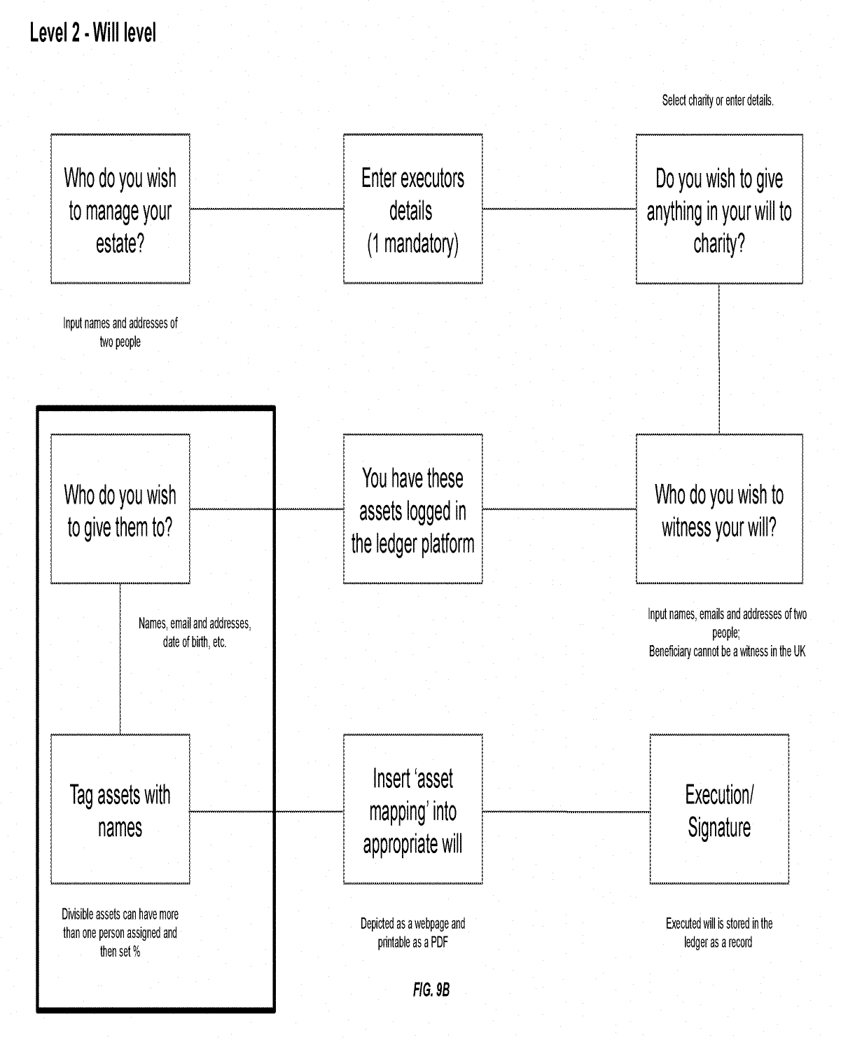

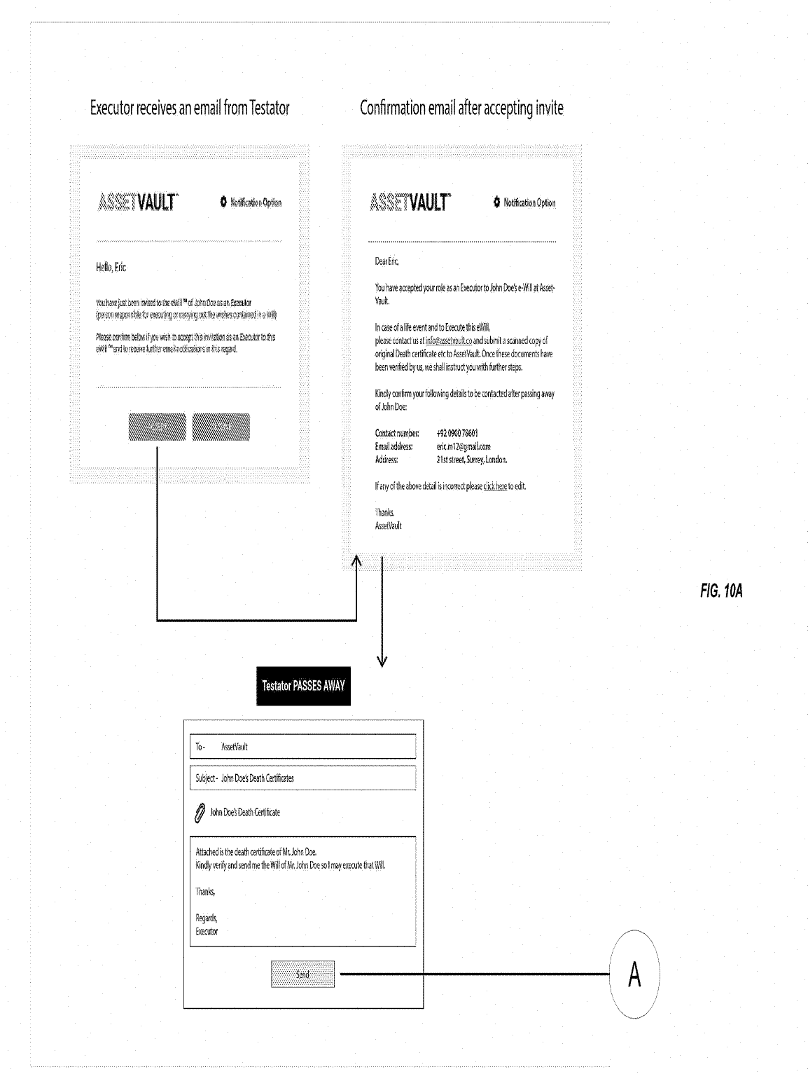

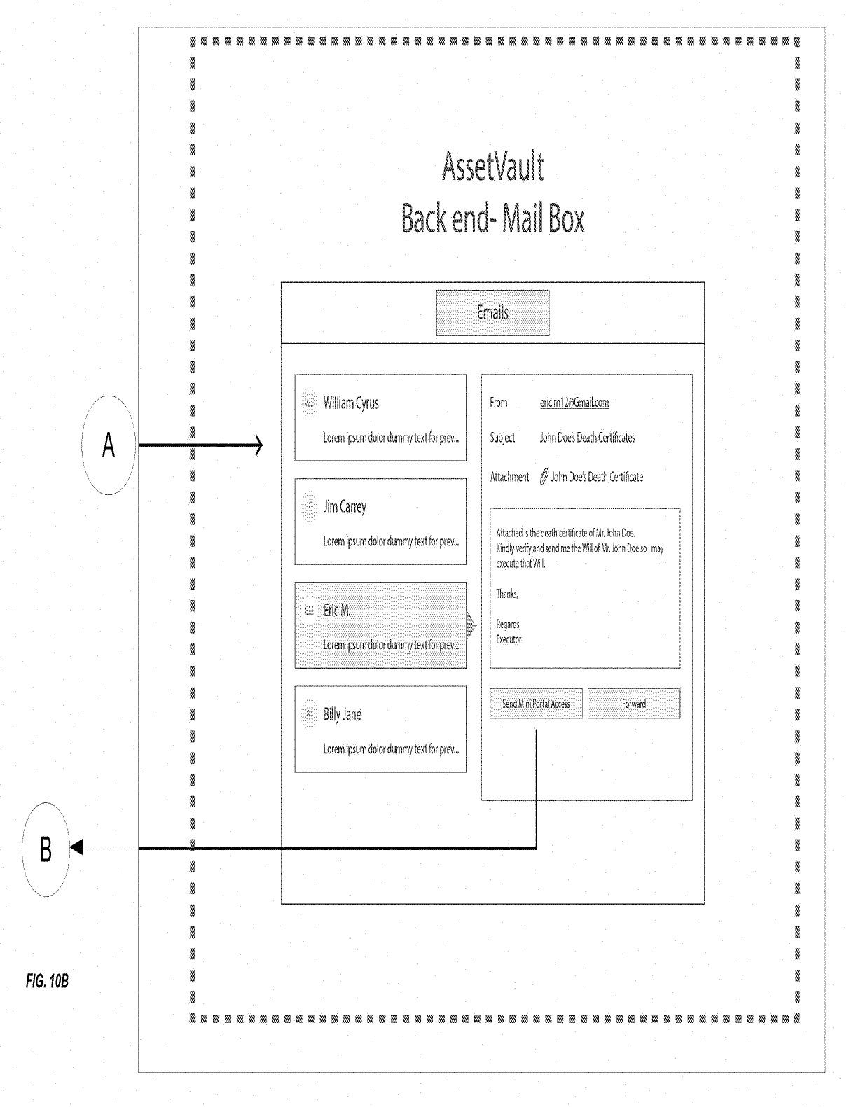

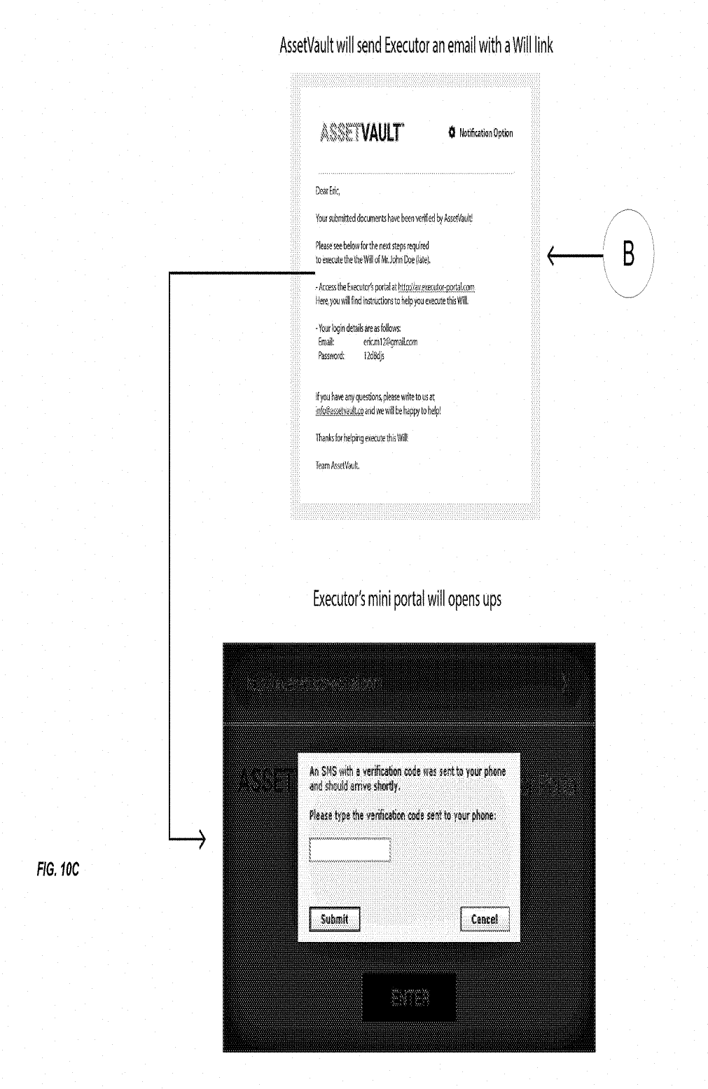

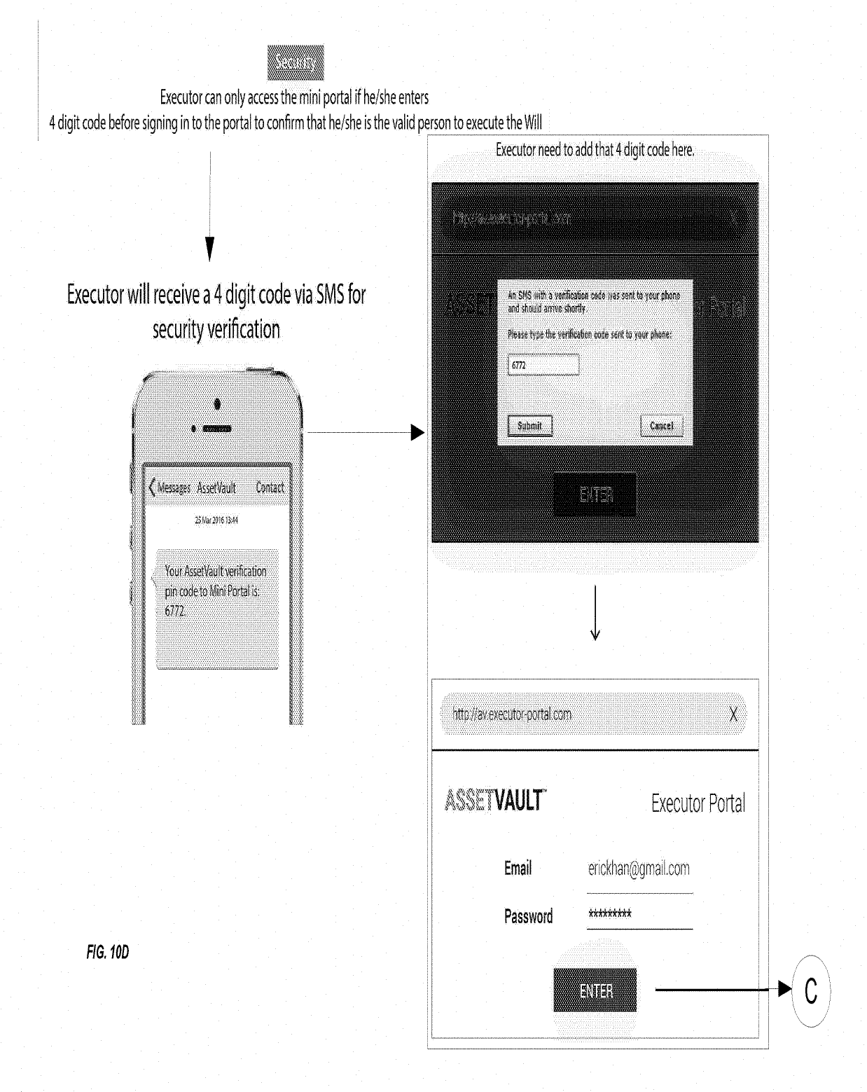

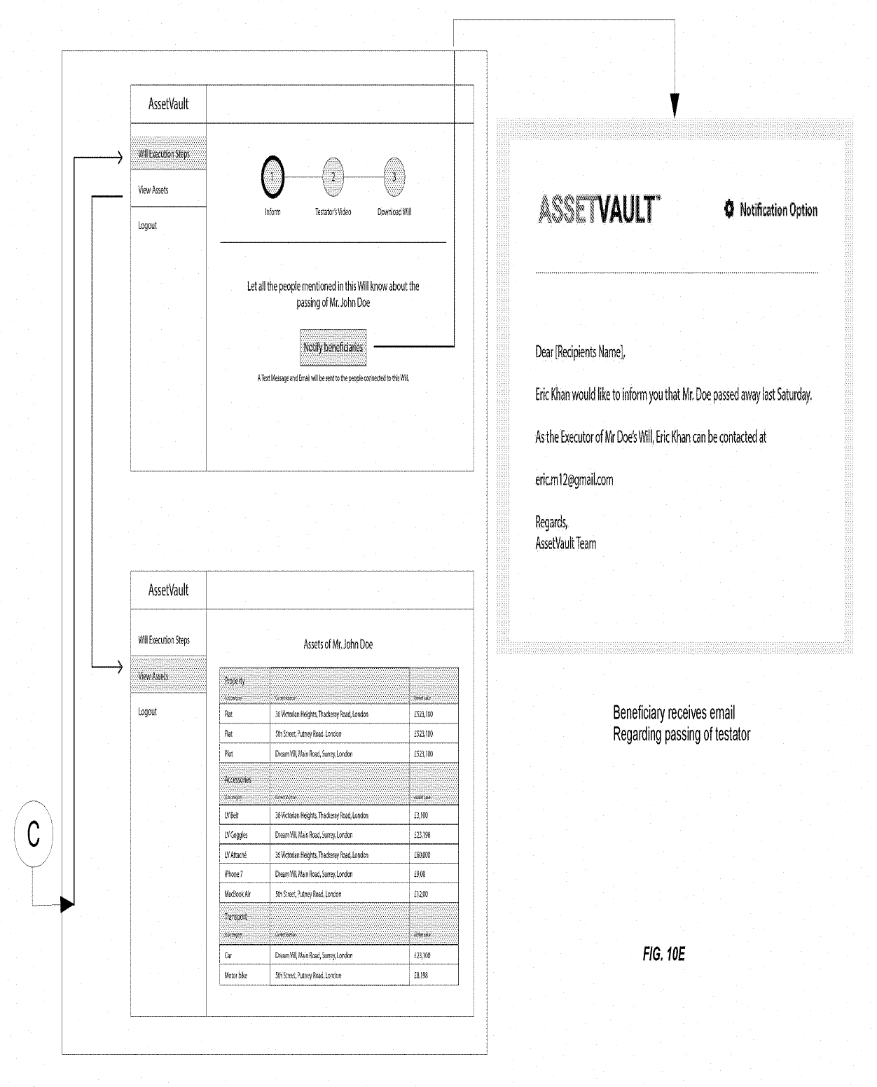

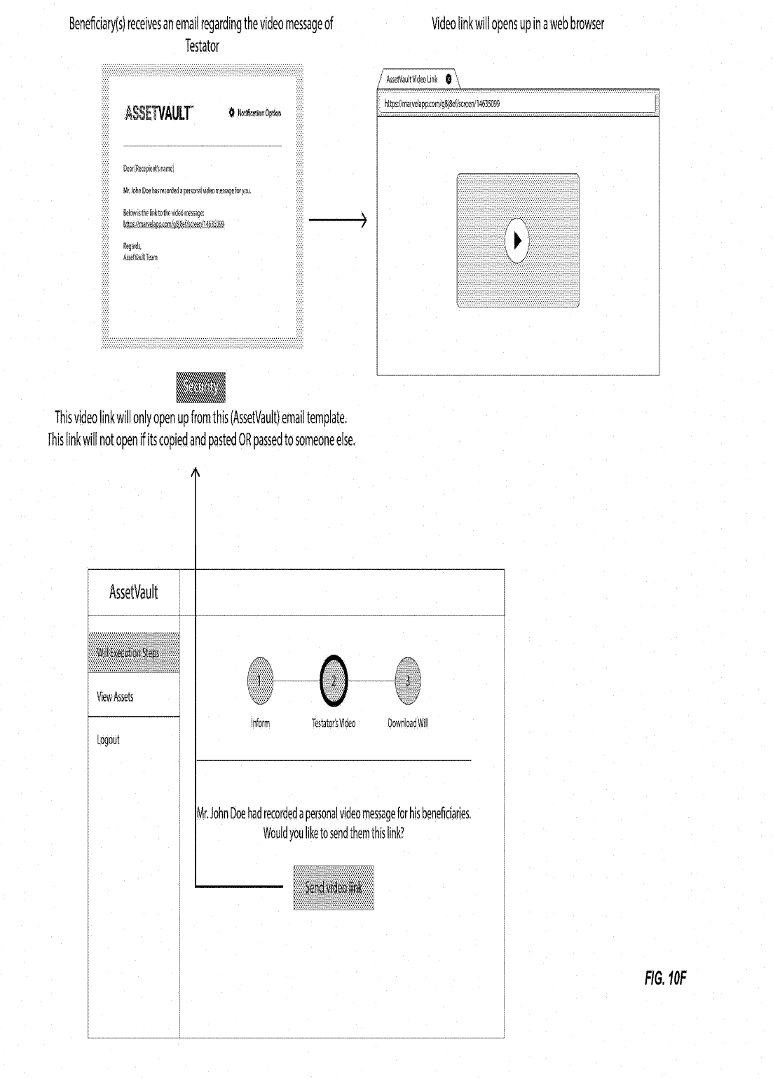

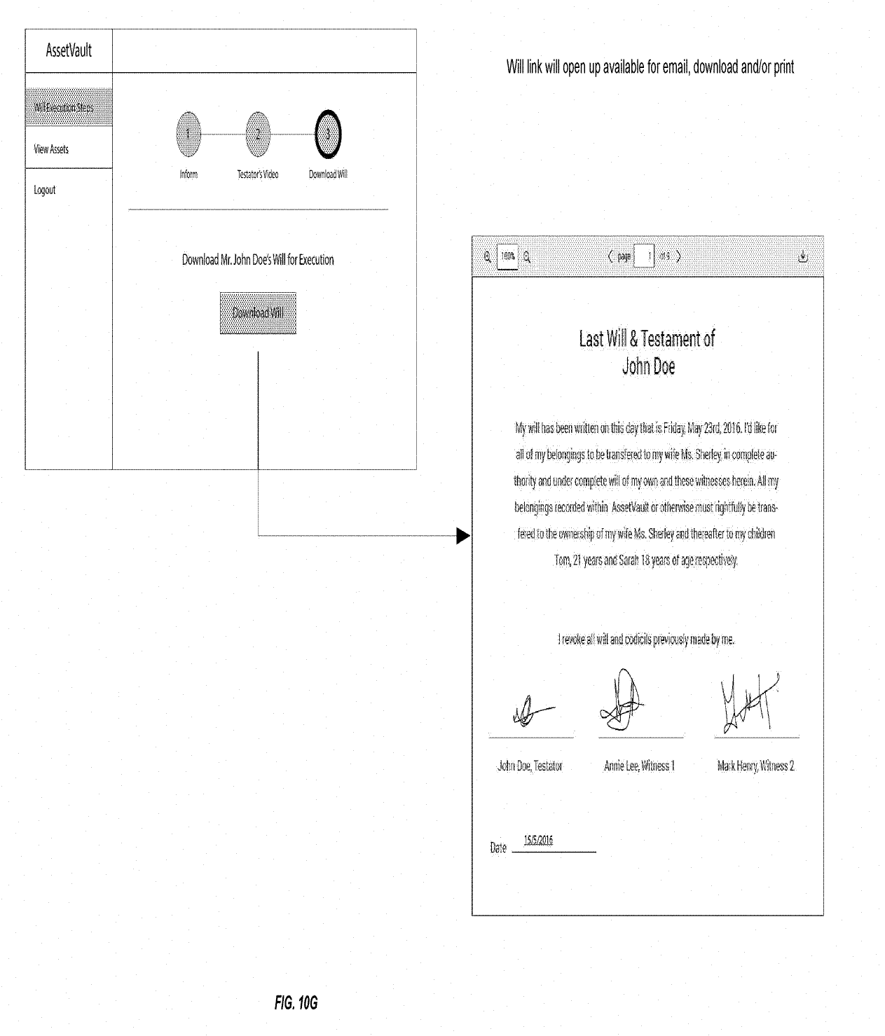

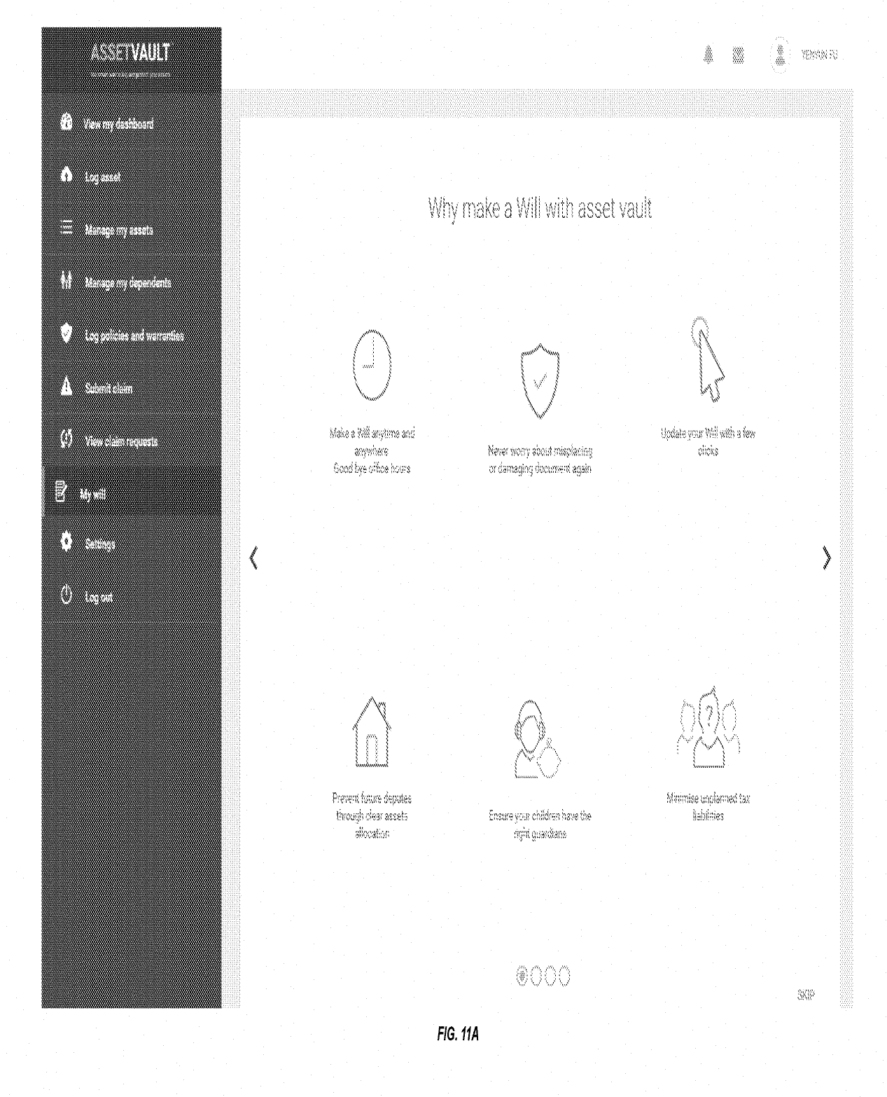

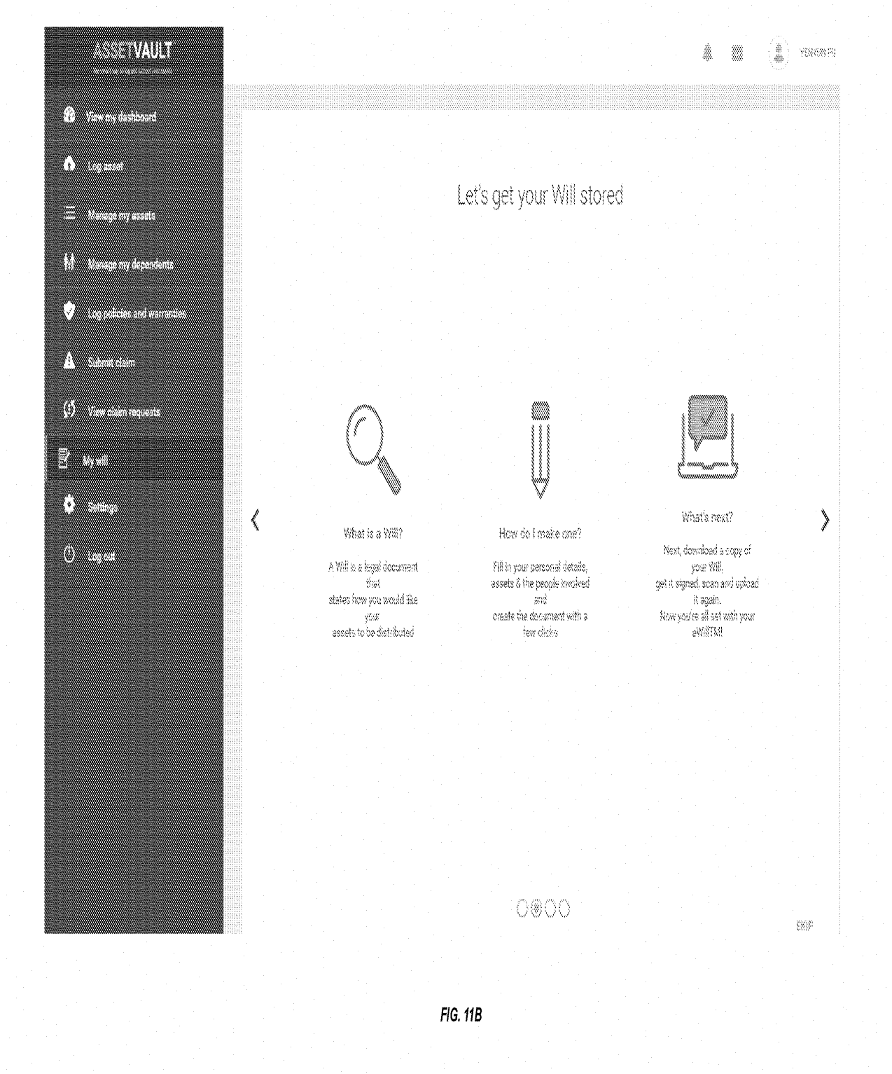

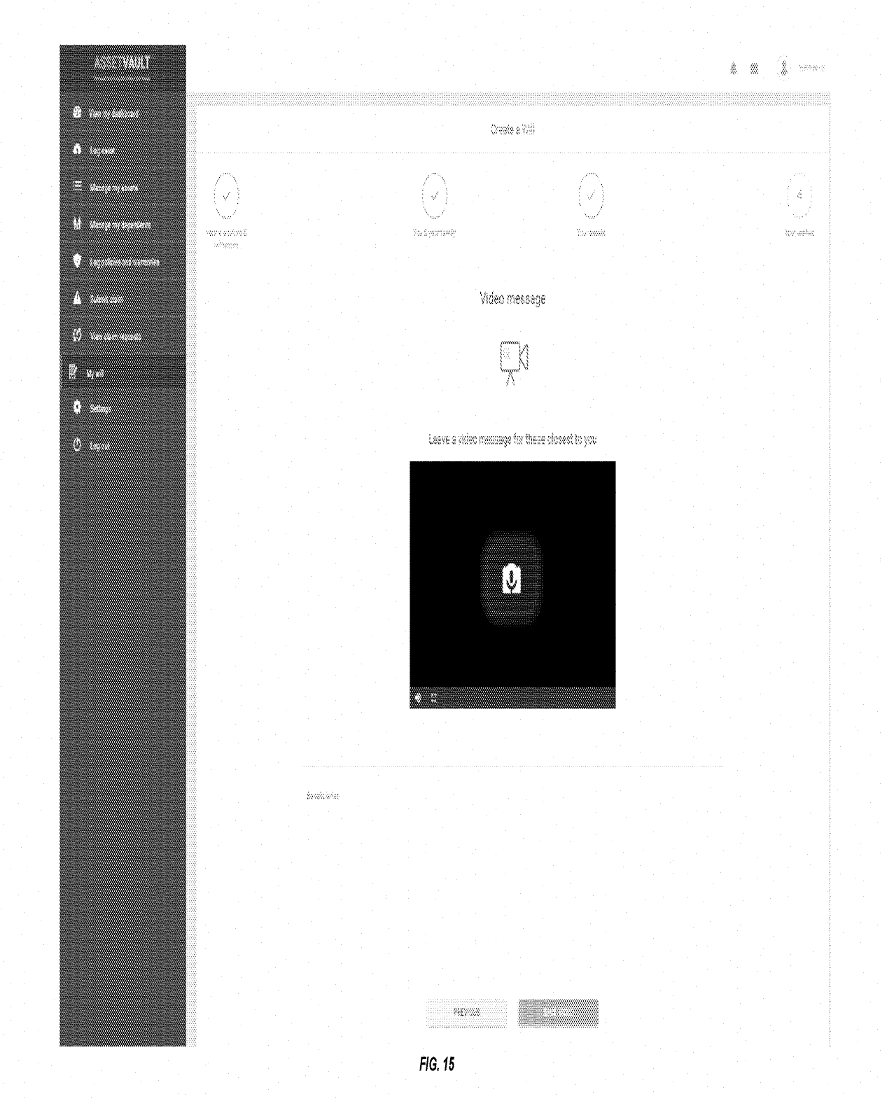

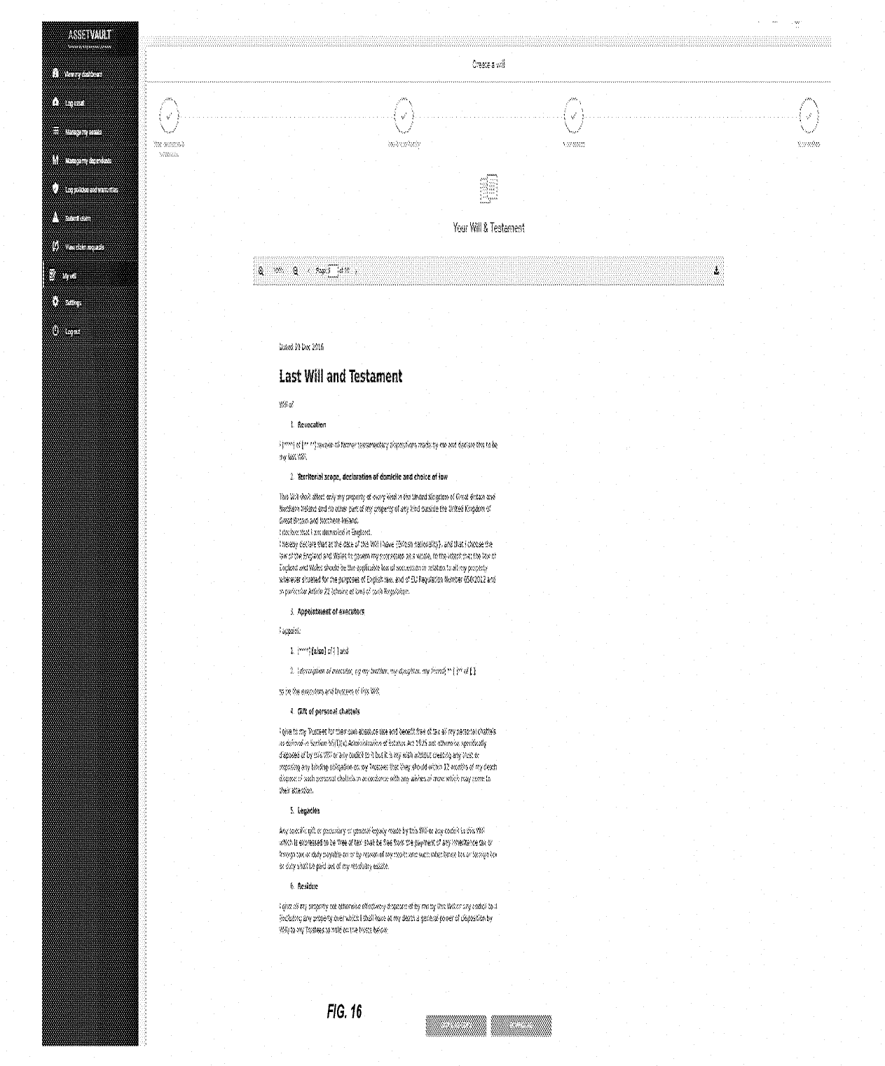

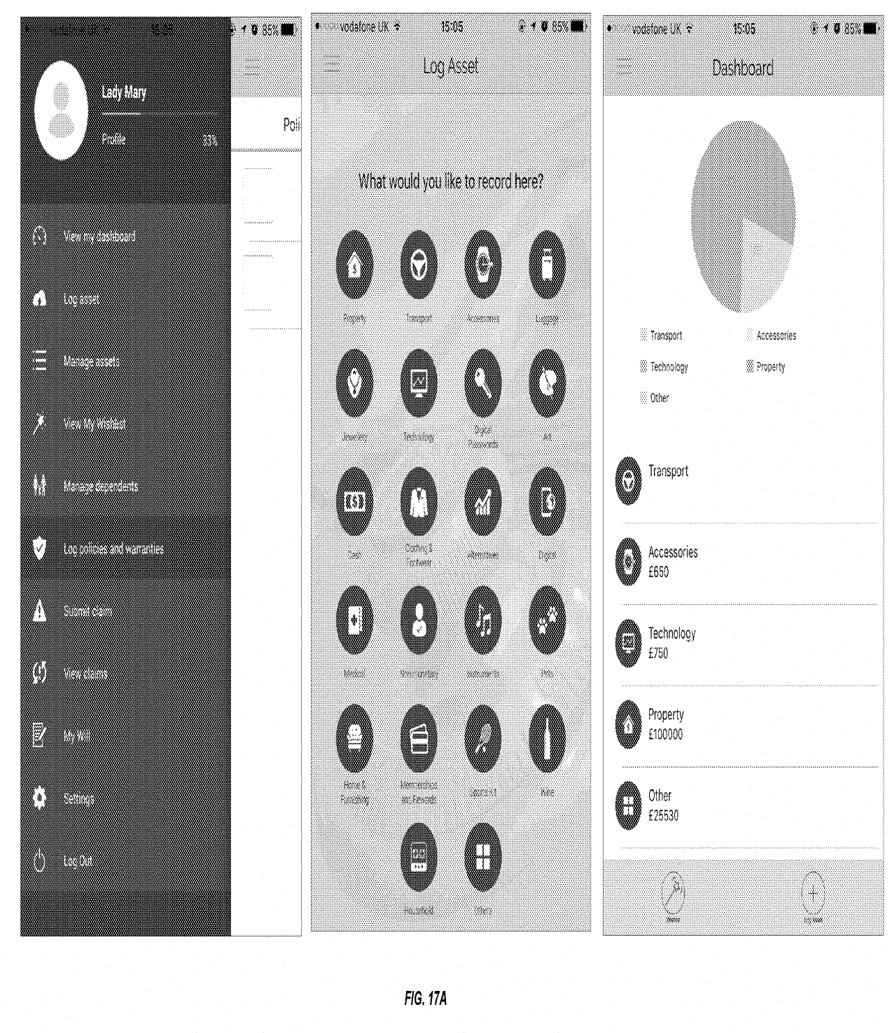

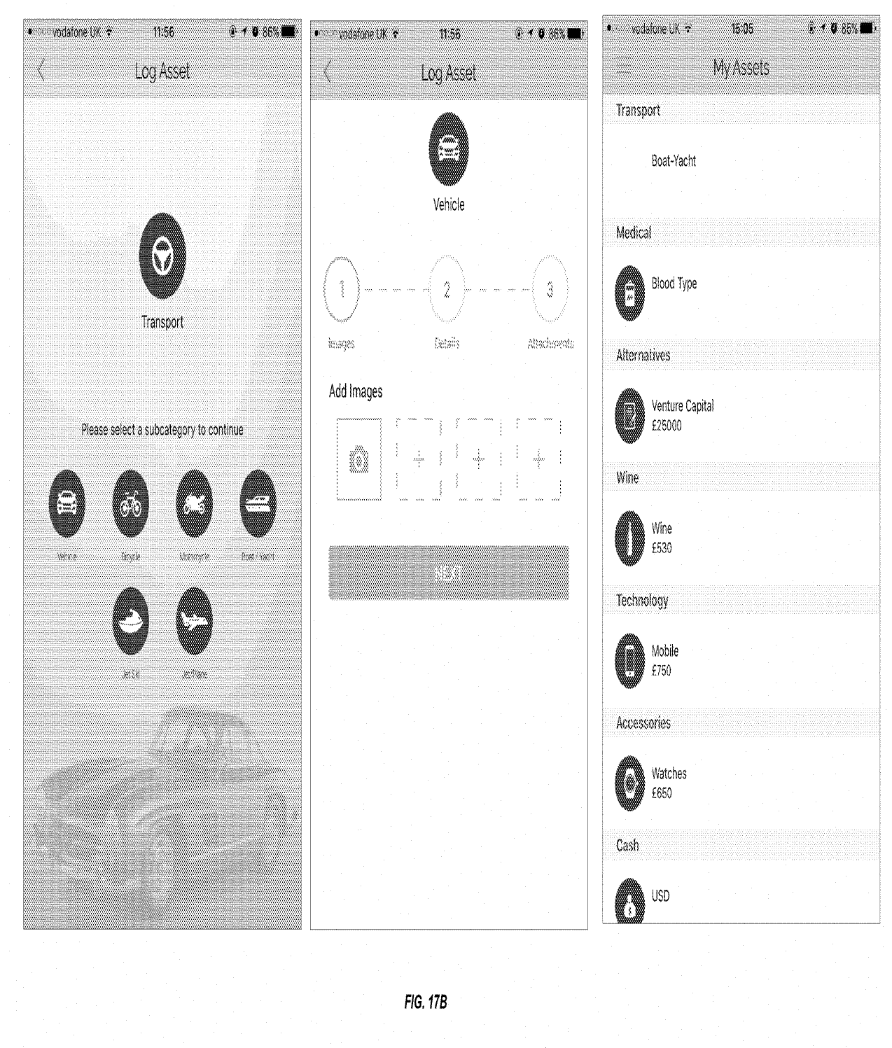

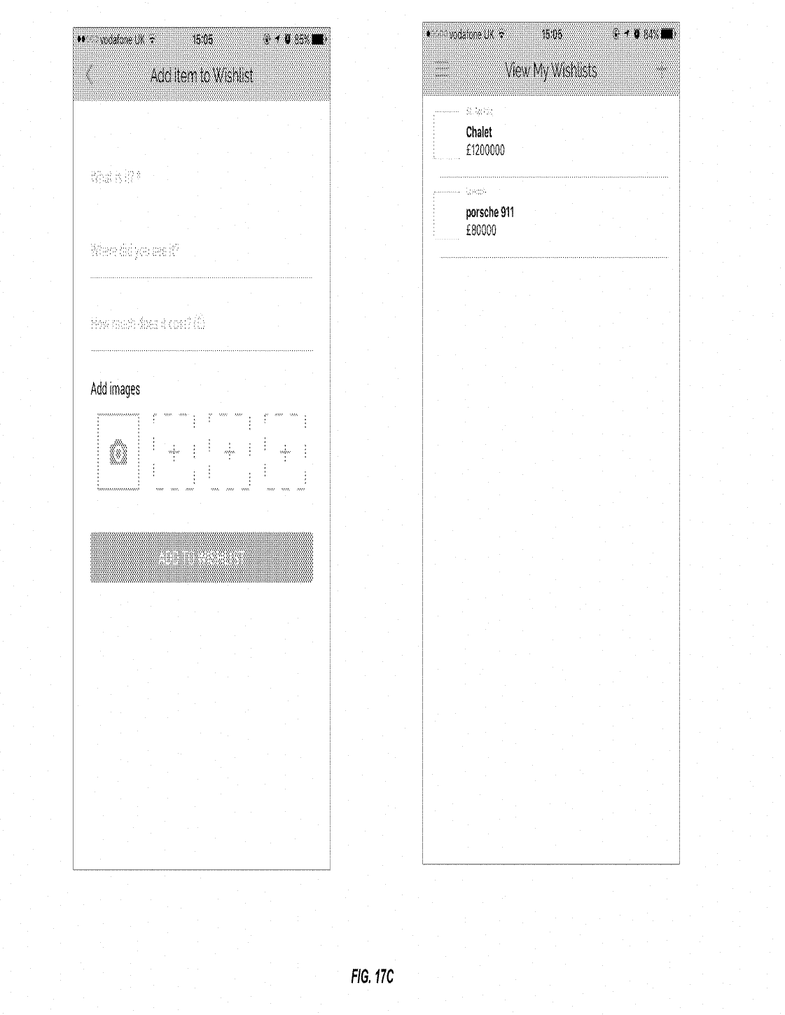

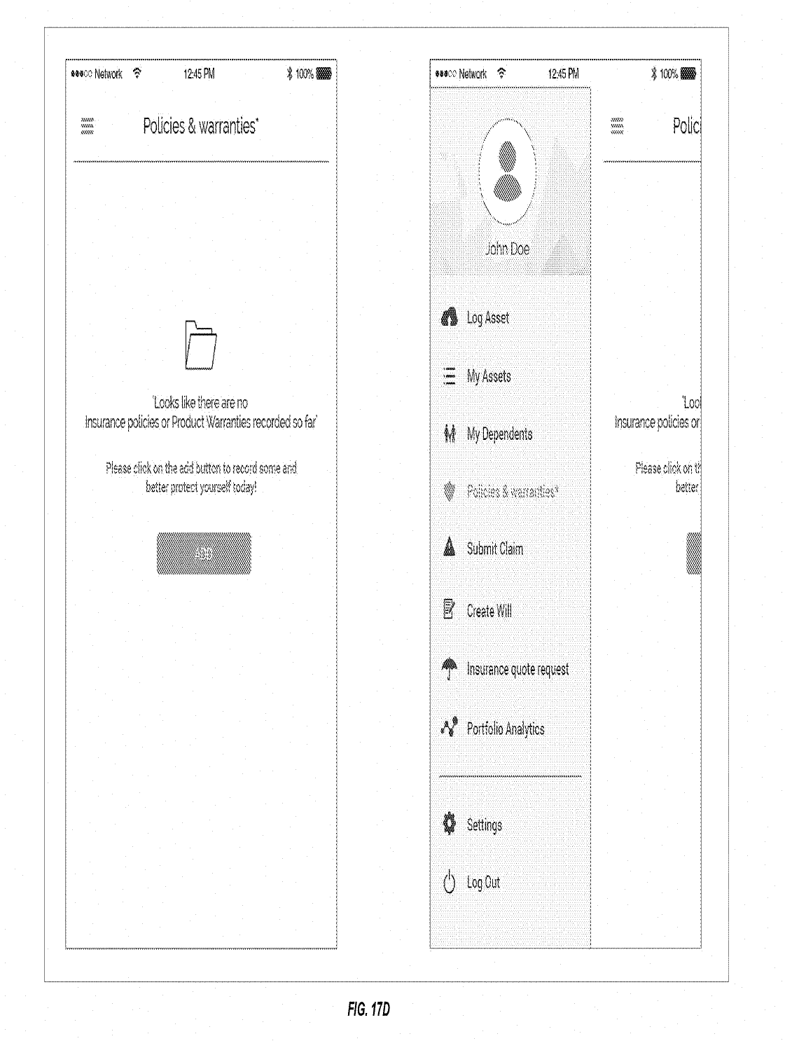

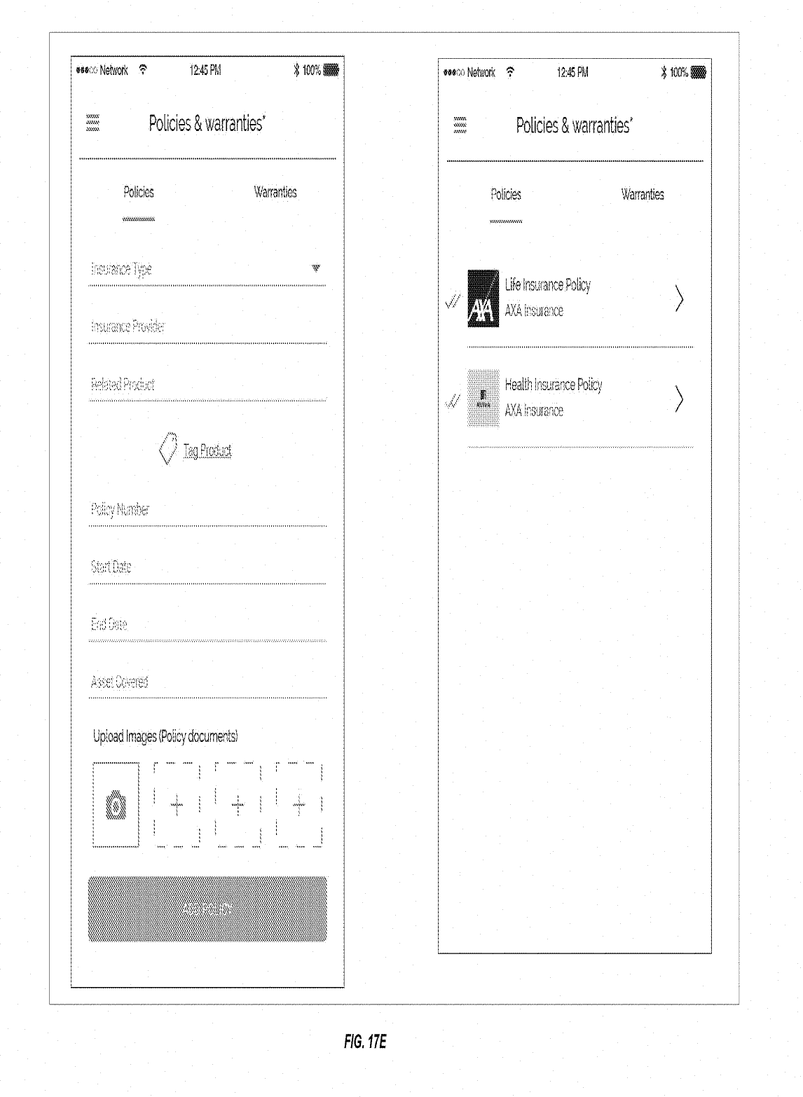

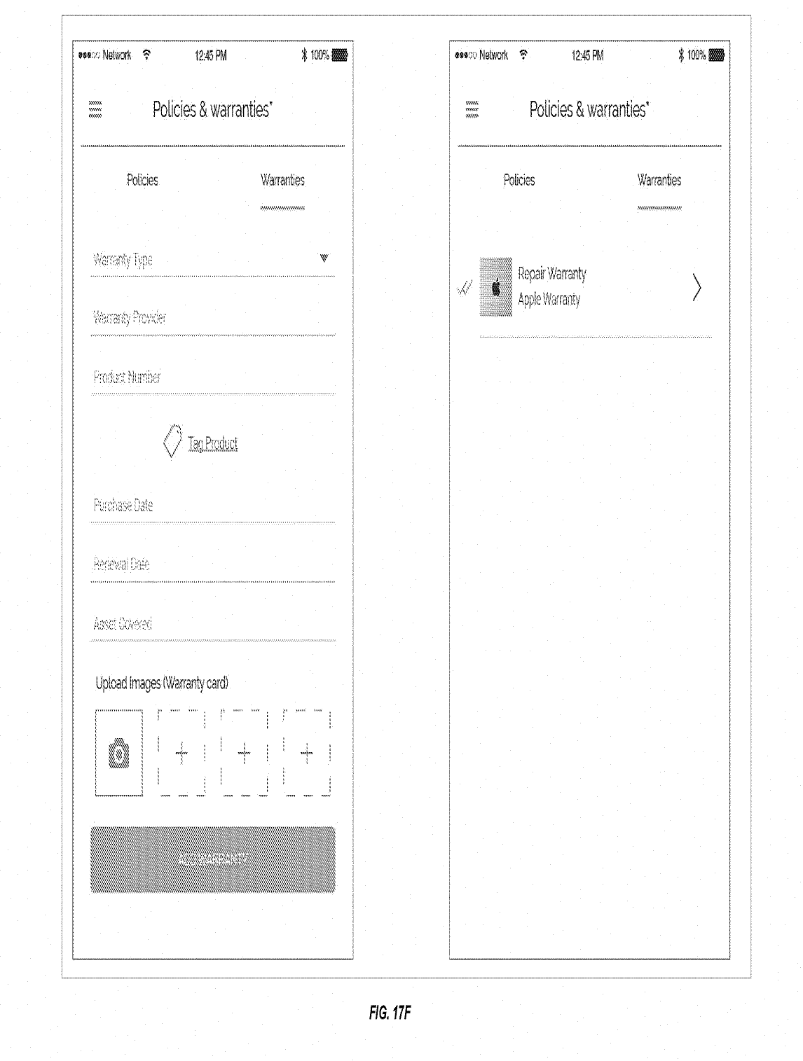

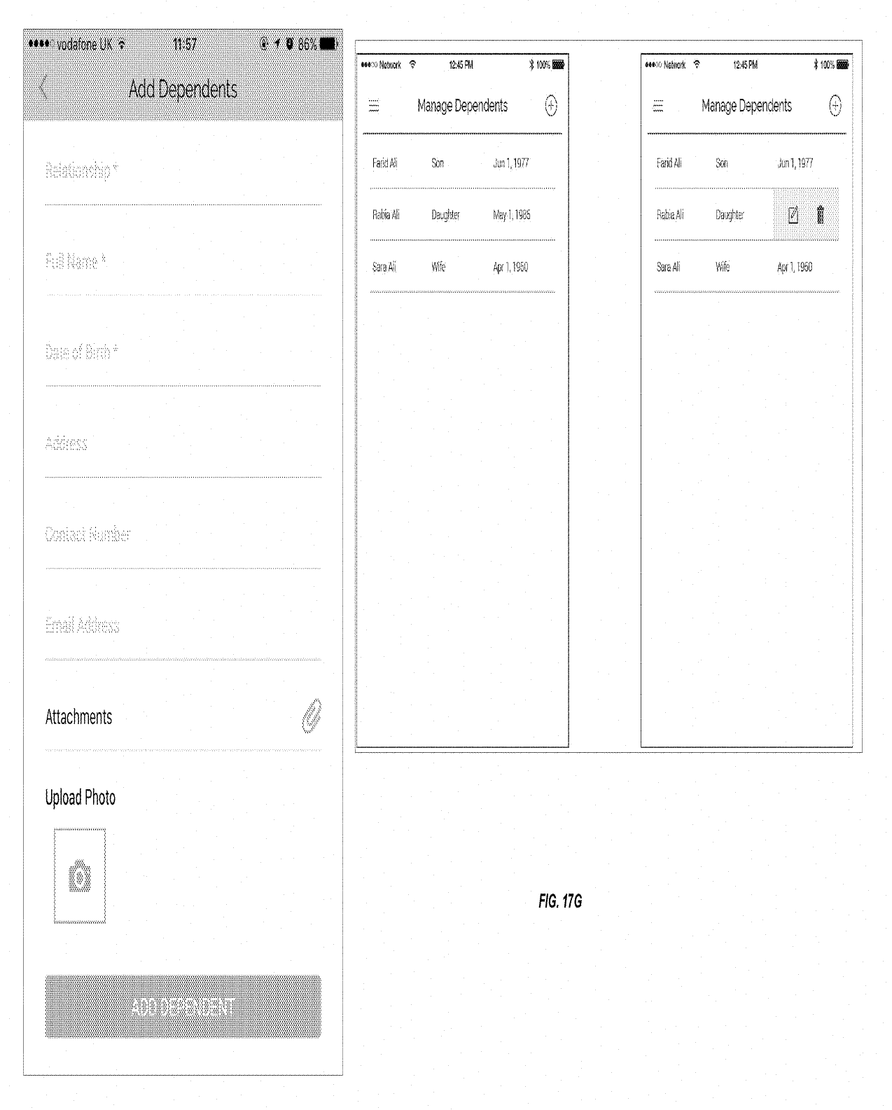

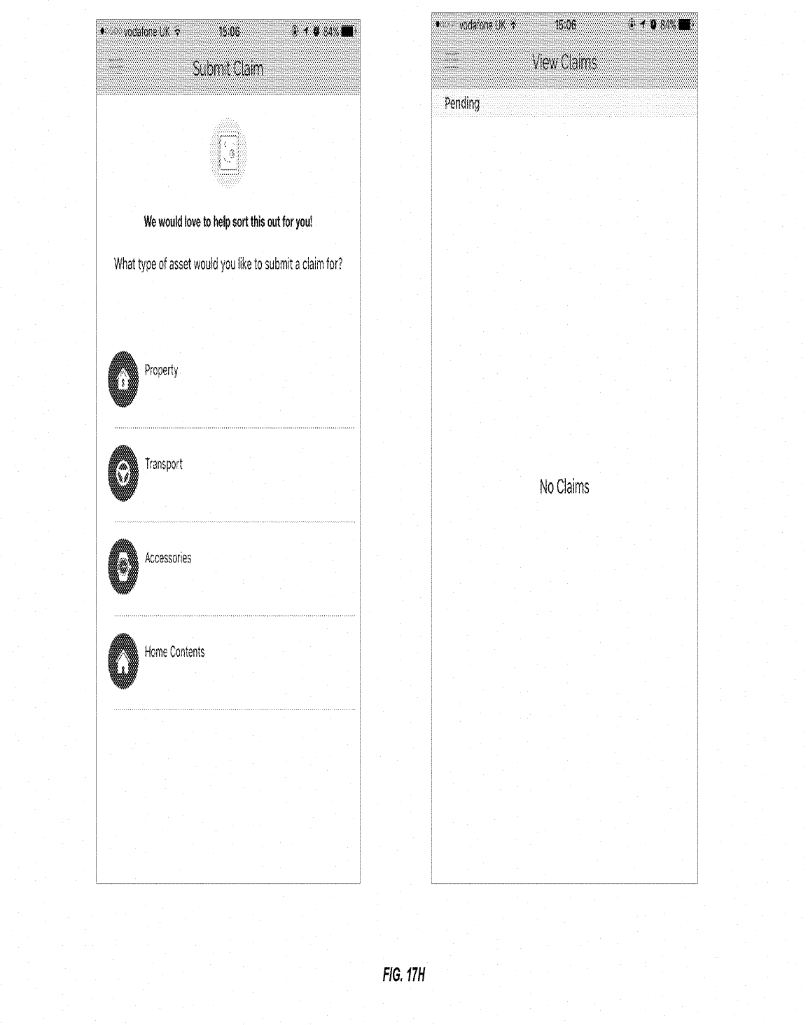

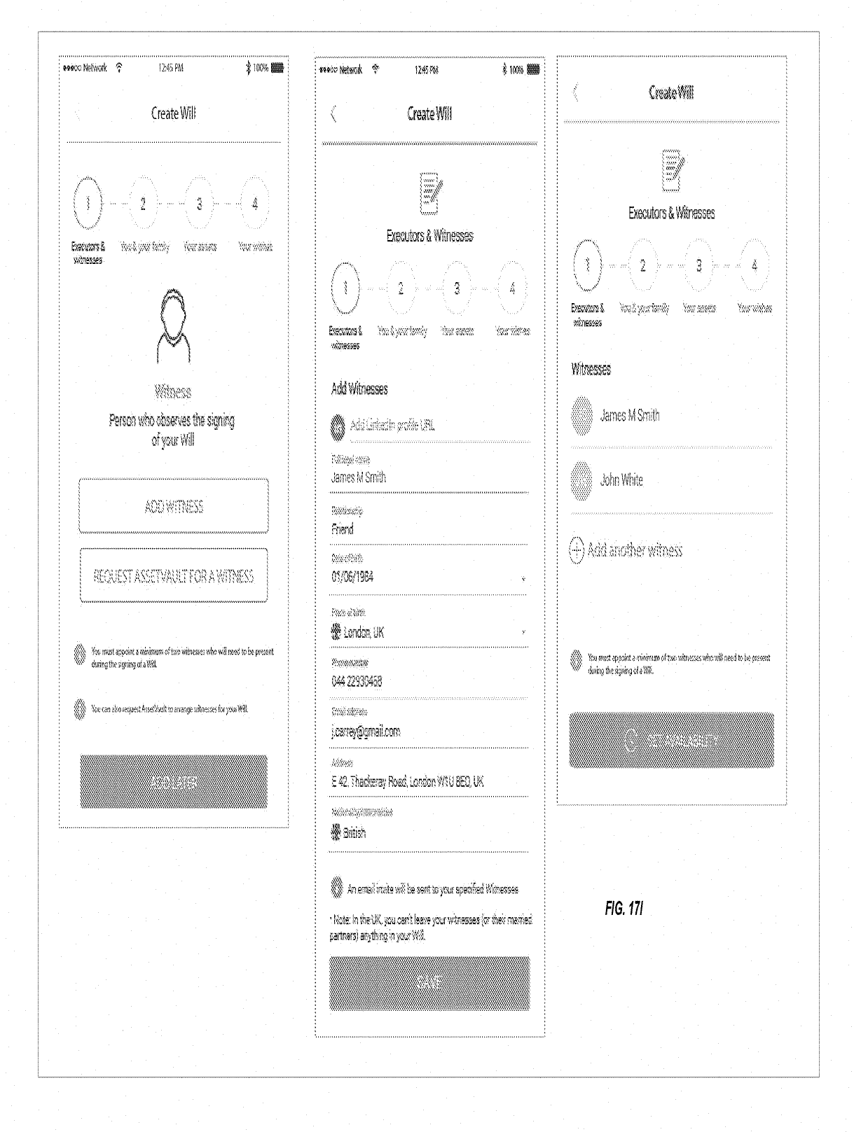

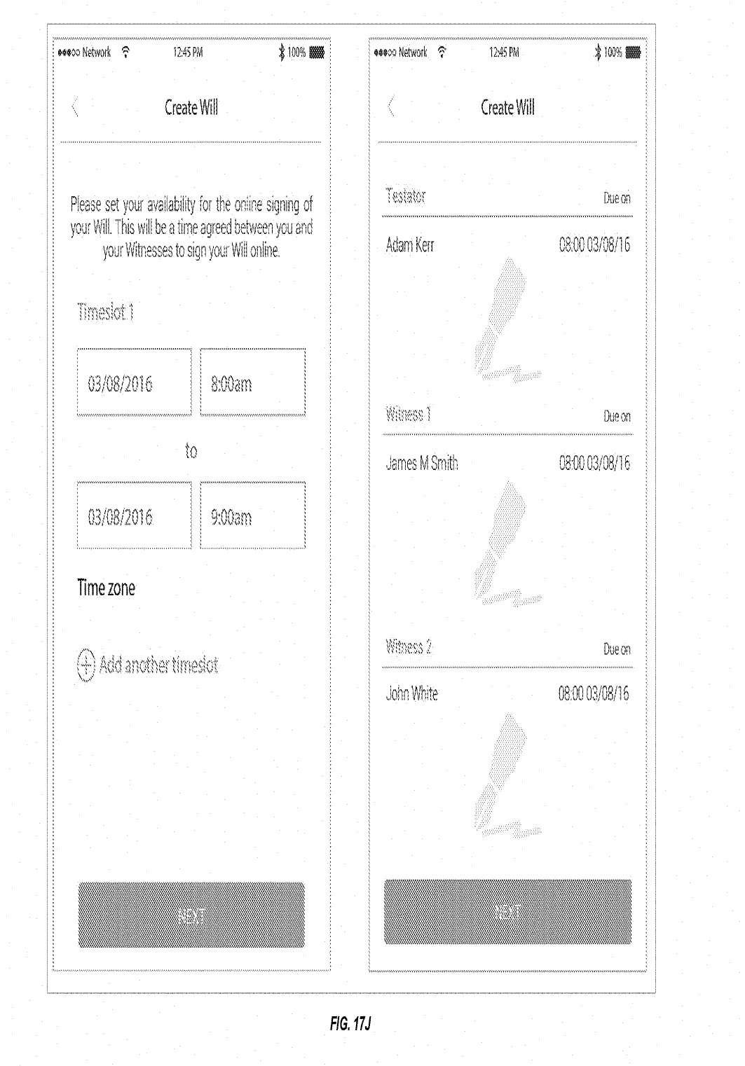

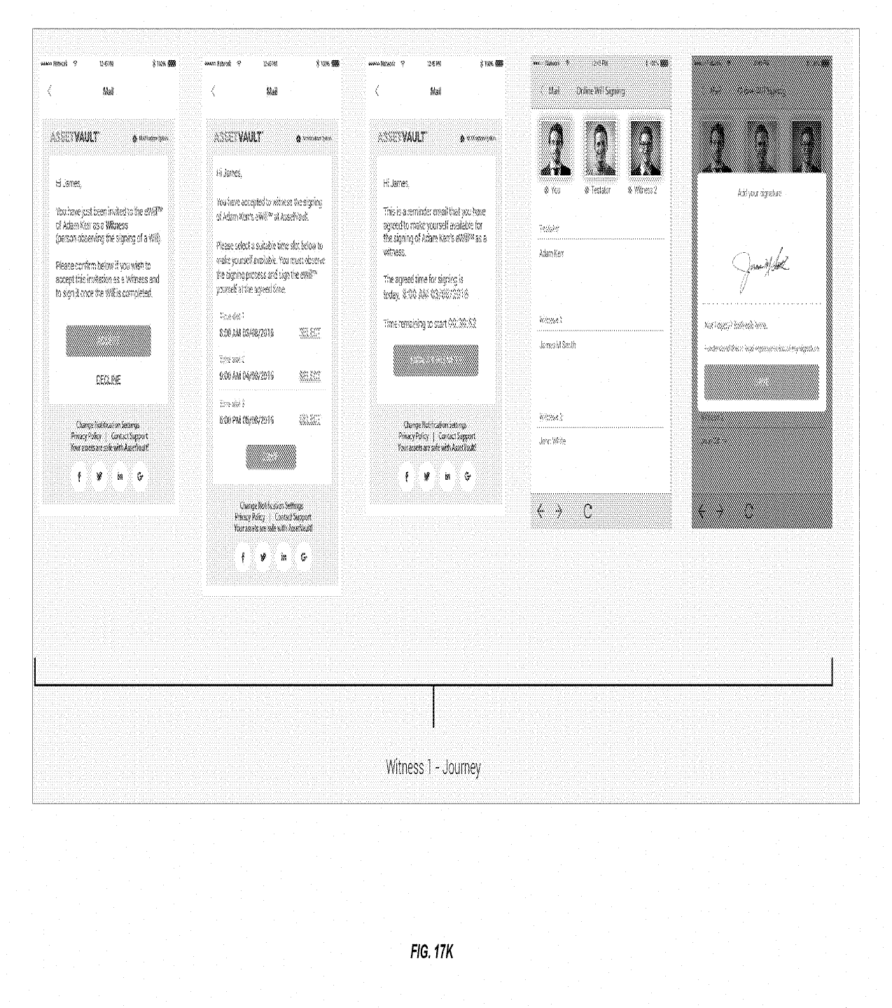

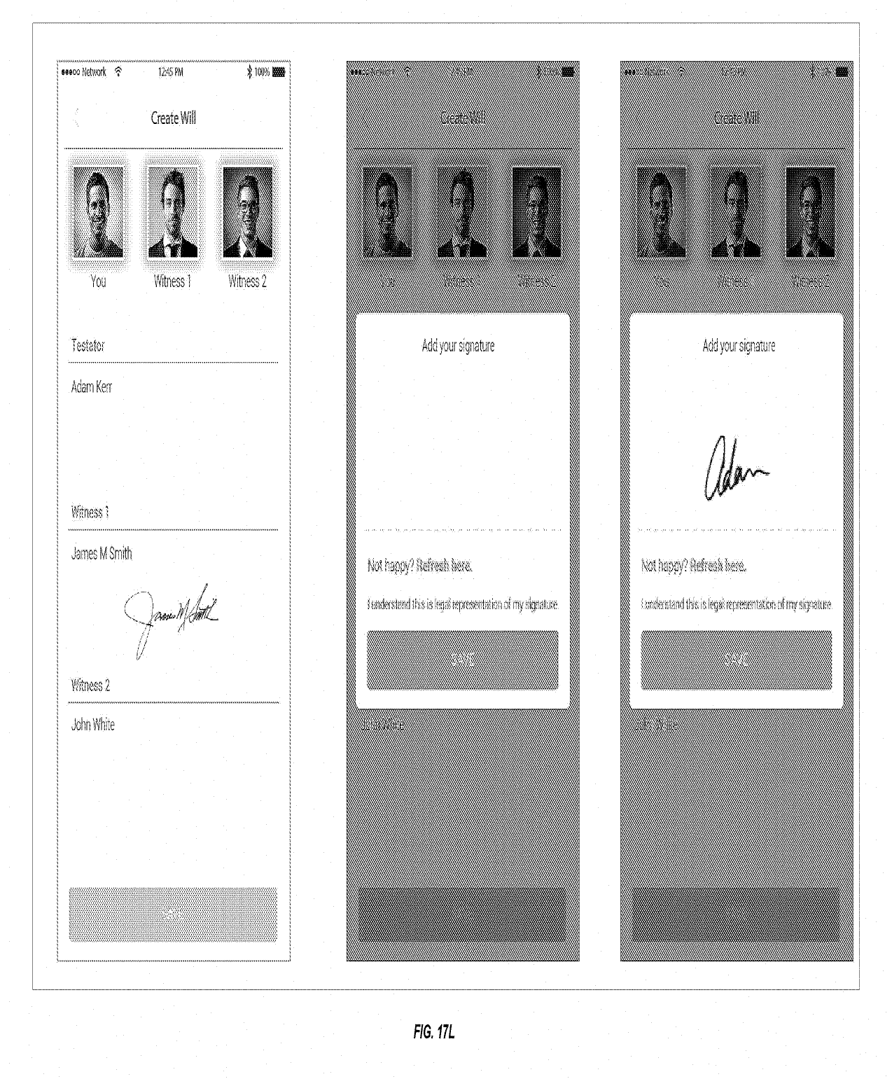

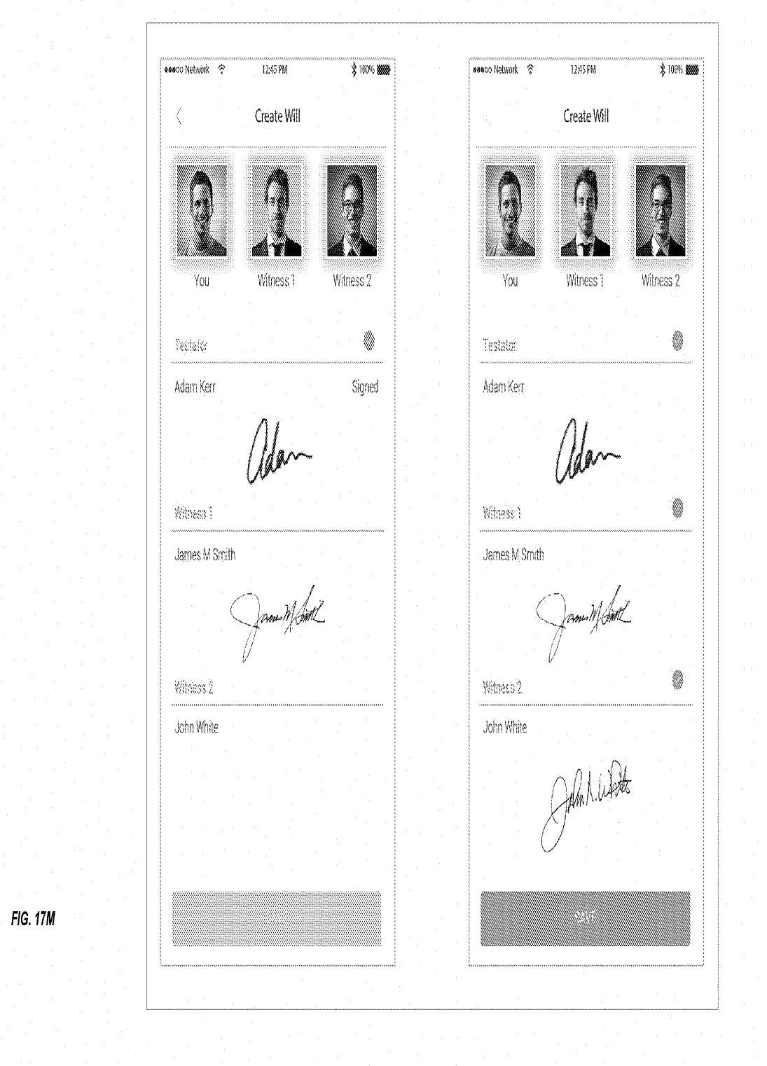

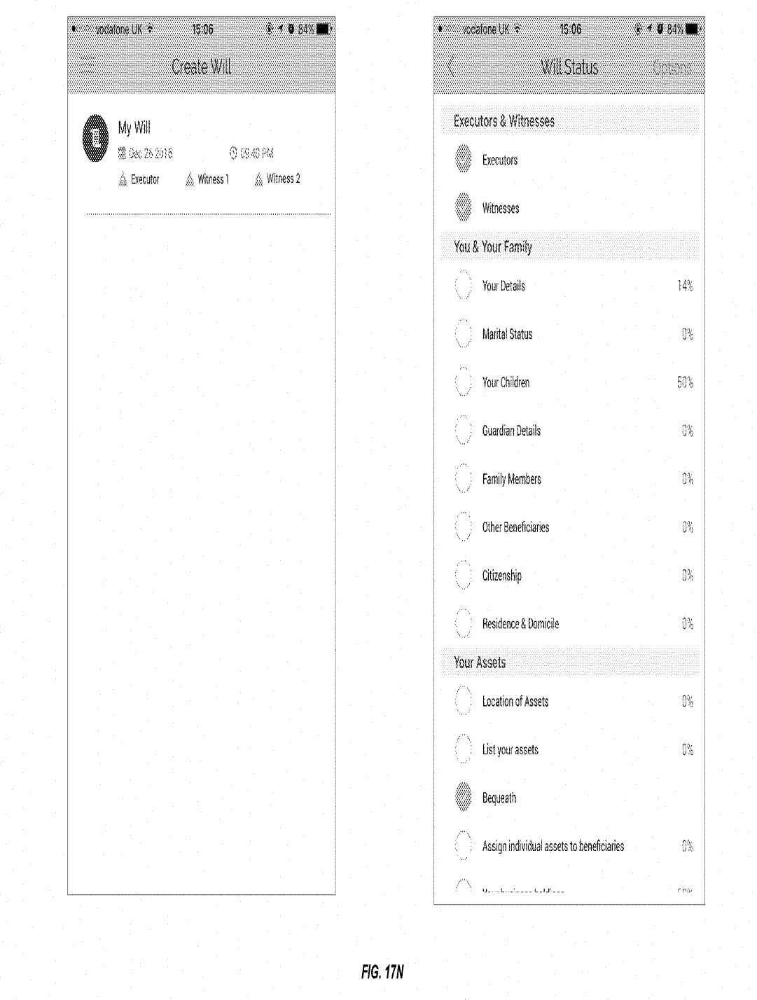

To log an asset or asset information, in one embodiment, the user can upload an image of the asset, or a receipt for the asset. Image recognition techniques can be applied to scrape the image or receipt image to populate data fields associated with a given asset type including, for example, price, location and/or date of the asset. The user can also manually enter the information or data for the asset including, one or more of a descriptor, its value (purchase price, last known valuation, or estimated present day value), the asset type, date of purchase, location of purchase, purpose of purchase (e.g., investment, personal use, leisure, etc.) and/or location of the asset. The asset location can be automatic, for example, using geo-tagging techniques. FIG. 4A-B depict flow charts illustrating example processes for a user to catalogue assets and its associated data/information in a ledger platform, for a new user and an existing/returning user. Example screenshots illustrating steps for logging of assets and the associated data/information via the web application and the mobile application are illustrated in examples of FIGS. 8A-H and FIGS. 17A-N.

In one embodiment, the host server (e.g., the host server of FIG. 1 and FIG. 3) assesses and tracks the value of these assets through advanced AI, intelligent machine learning using analytics, and notifies users of changes or anticipated changes. The host server (e.g., the host server of FIG. 1 and FIG. 3) can further provide actionable insight based on changes or anticipated changes in asset value. Actions may be taken directly by the user or through professionals (e.g., 3rct party). For example, the host server can, in one embodiment provide an advisor module which administers, via a third party, an advisor portal (e.g., as illustrated in the example screenshots of FIG. 7A-C). The advisor portal can be integrated with third party professional services to assist the user in managing, leveraging, protecting assets and/or providing advise regarding taxes, wills and estates, trusts and/or accountancy matters using the asset information and/or analytics generated or aggregated by the host server.

Financial applications include leveraging equity locked in assets (e.g., asset backed borrowing/lending with collateral), financing purchases or investments, facilitating transfer or change of title/ownership in the asset, day to day managing and monitoring the status and performance of the asset logged in the ledger platform 212 for wealth preservation. In some embodiments, the host server can assist banks in assessing utilization or adoption of the ledger platform 212 amongst its users. In addition, the host server can create lists or aggregated anonymous data regarding ultra high net worth individuals. Such information can be used by banks or other financial advisors to upsell securities or other financial products, including, IPOs, debt offering, alternative investments, etc.

Applicable insurance applications include for example, suggesting optimal coverage for the insured asset logged in the ledger platform, risk assessment/management and determining in real time, near real time or periodically, dynamically priced products based on coverage needed according to current, or present known or estimated value of the underlying asset. The user can record an insurance policy (e.g., property, vehicle, contents, life, professional indemnity, etc.) securely into the ledger platform 212. Details of an insurance policy can be determined from an uploaded insurance declaration/premium document (e.g., image recognition, OCR etc.) and/or manually entered by the user. The insurance policy can also be located through crawling user's data repository or email inbox. Policies can be forwarded to the host server for processing and recordation on to the ledger platform 212. Policies that are added can be tagged with assets for the user recorded in the ledger platform 212.

The host server can further provide methods for optimized process for creating and submitting insurance claims and ensuring adequate protection through suggestion and recommendation of the optimal insurance (life, home, property, contents, vehicle) products, warranties and/or coverage. In one embodiment, the host server implements AI techniques or utilizes bots to notify a user when their warranty is active and when it is about to expire along with suggested actionable items.

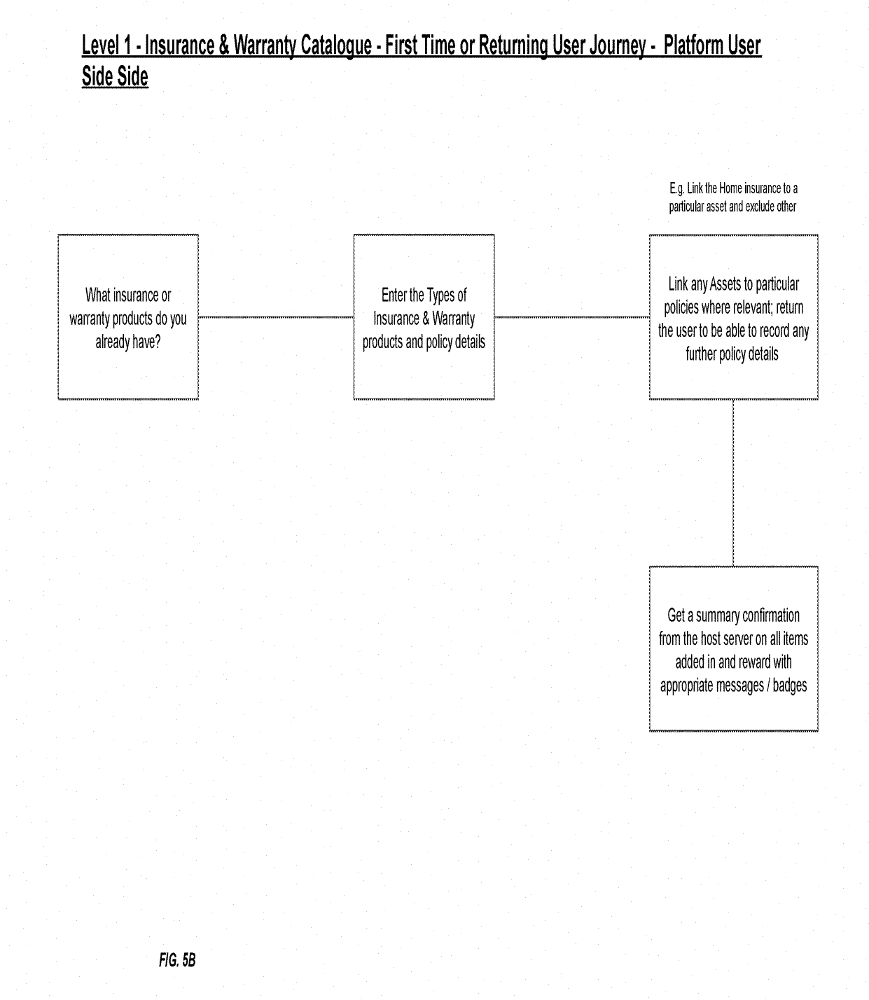

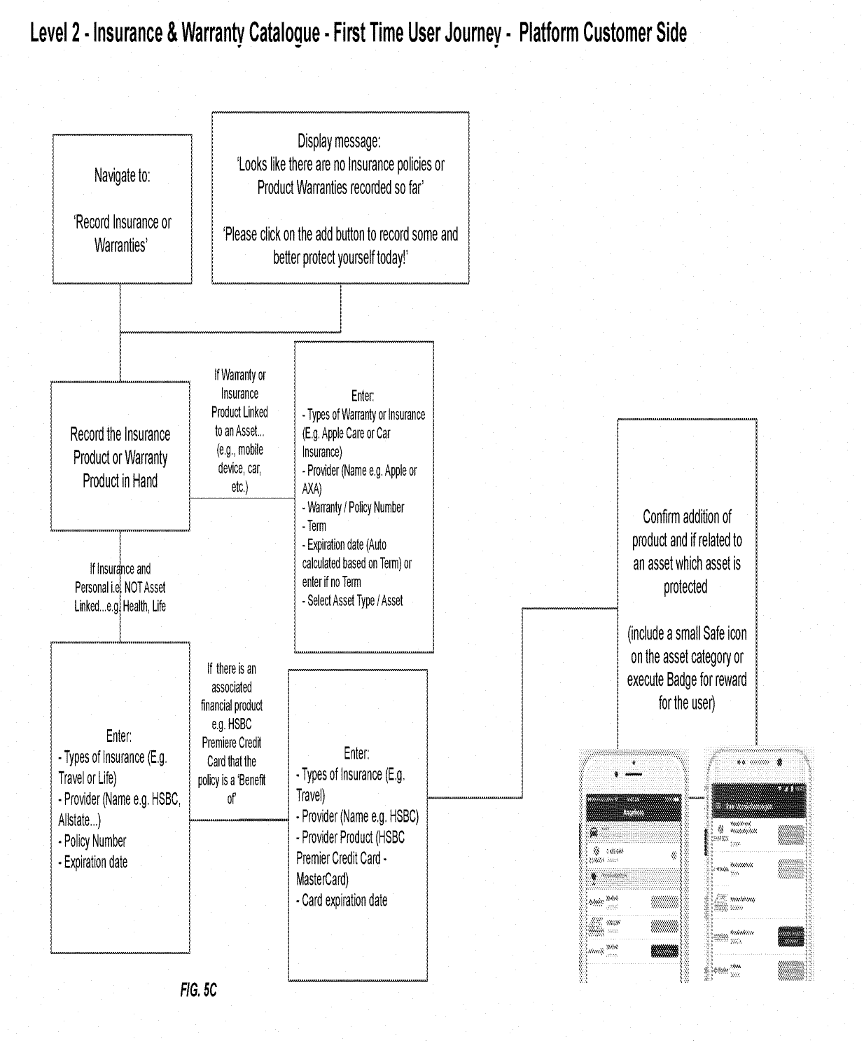

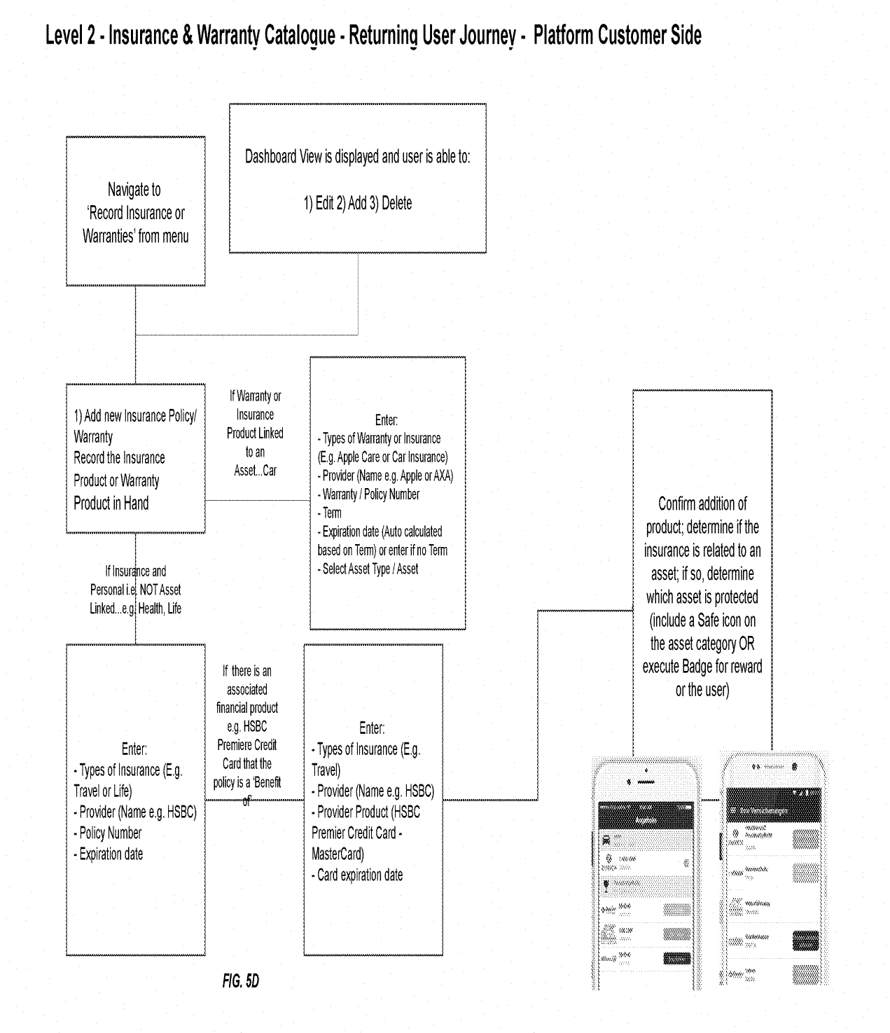

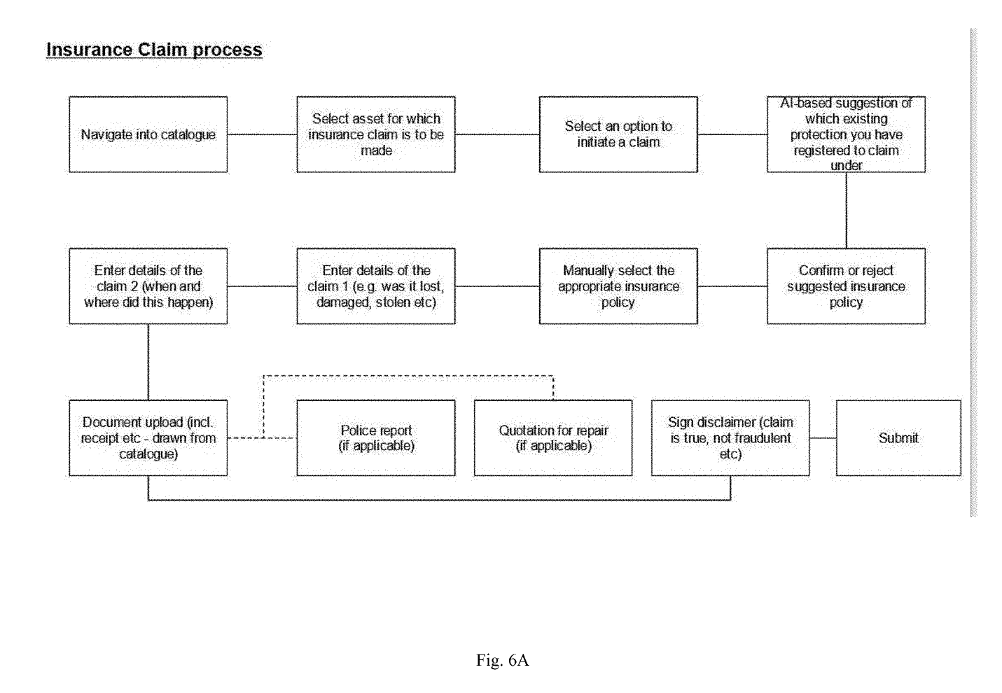

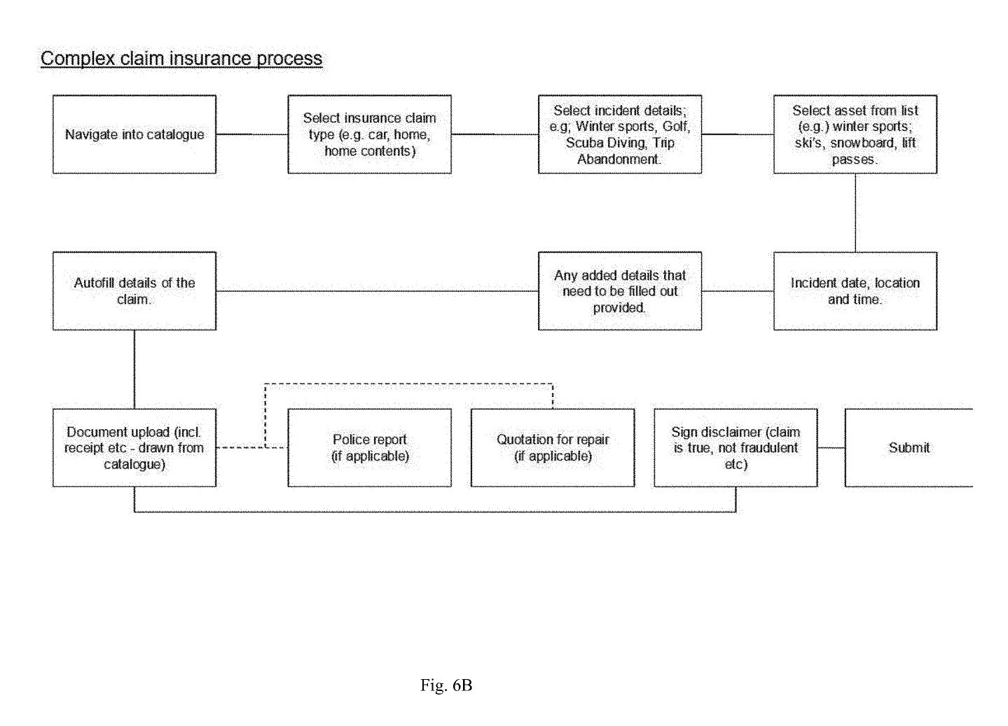

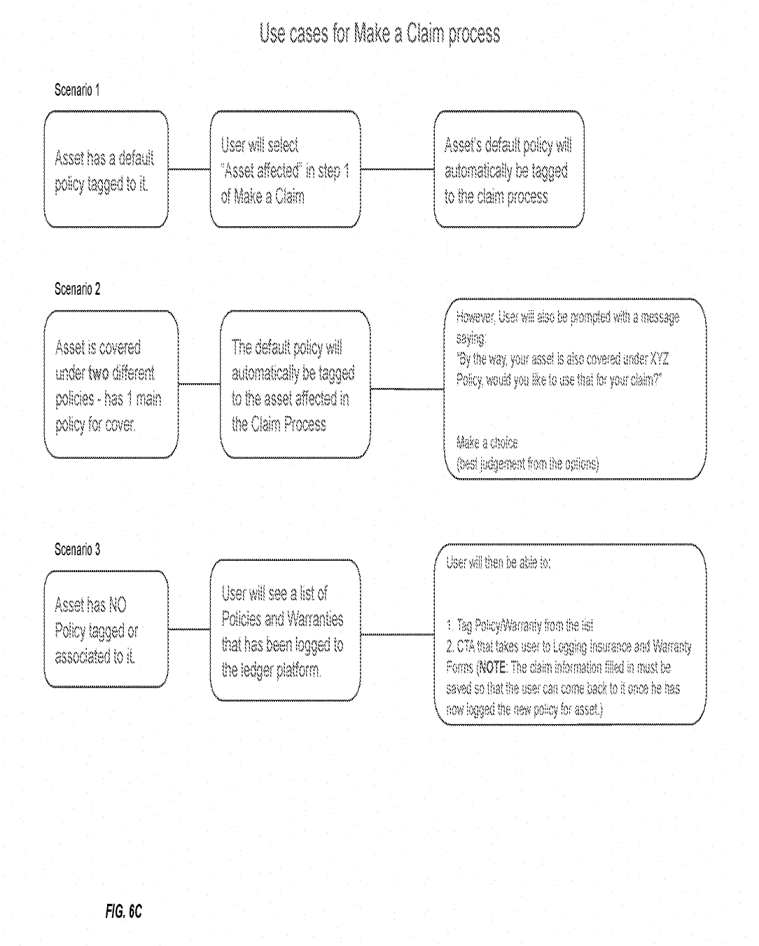

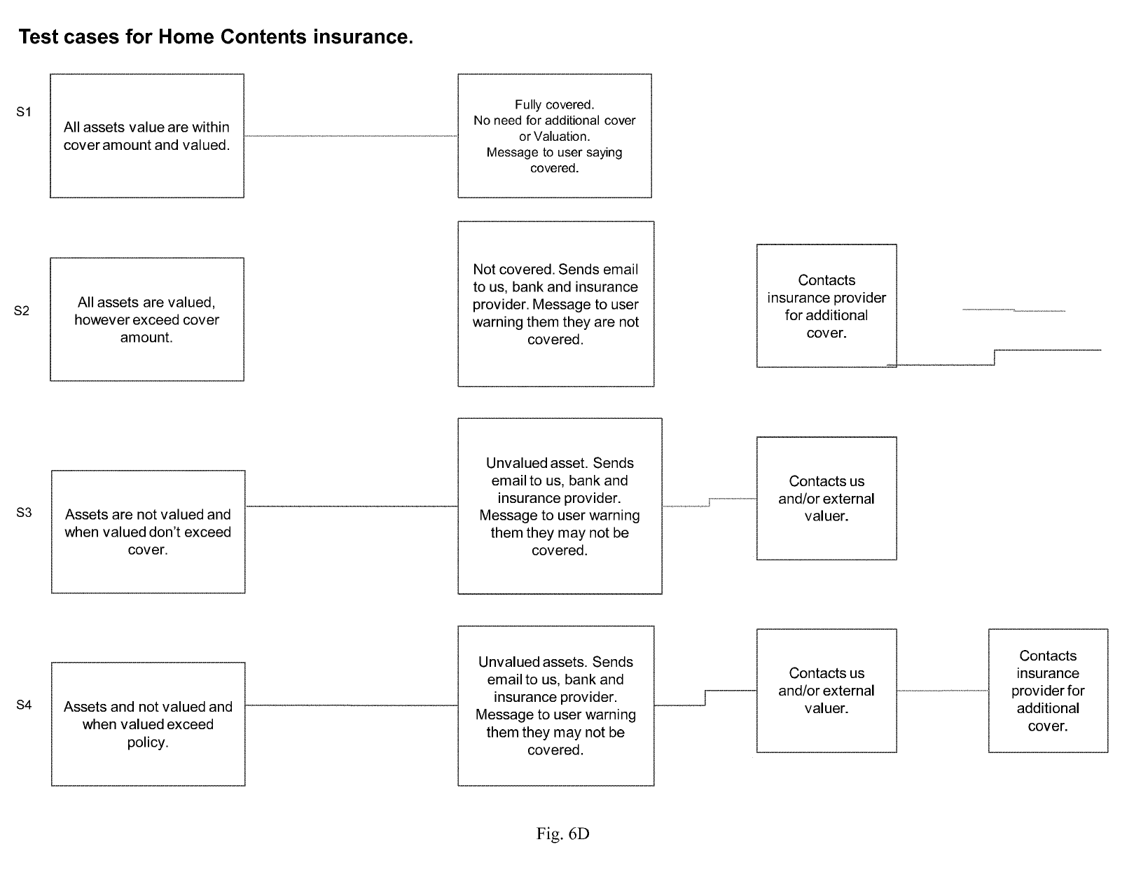

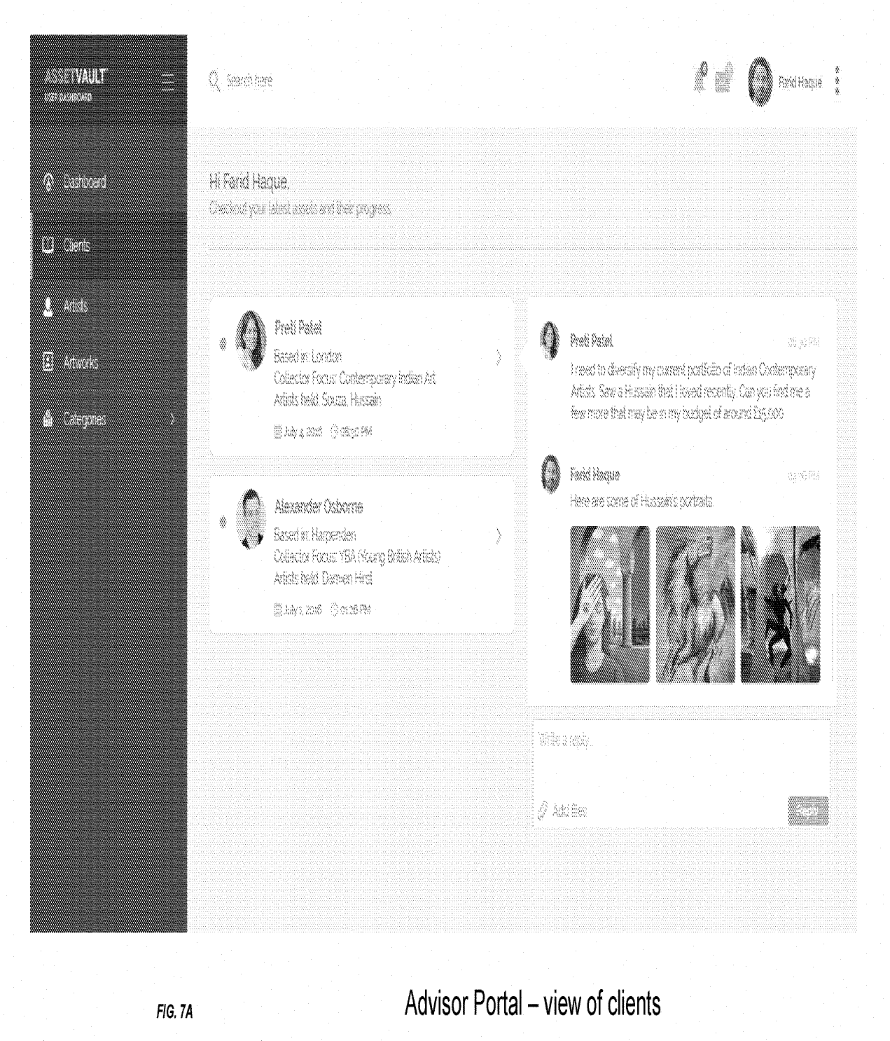

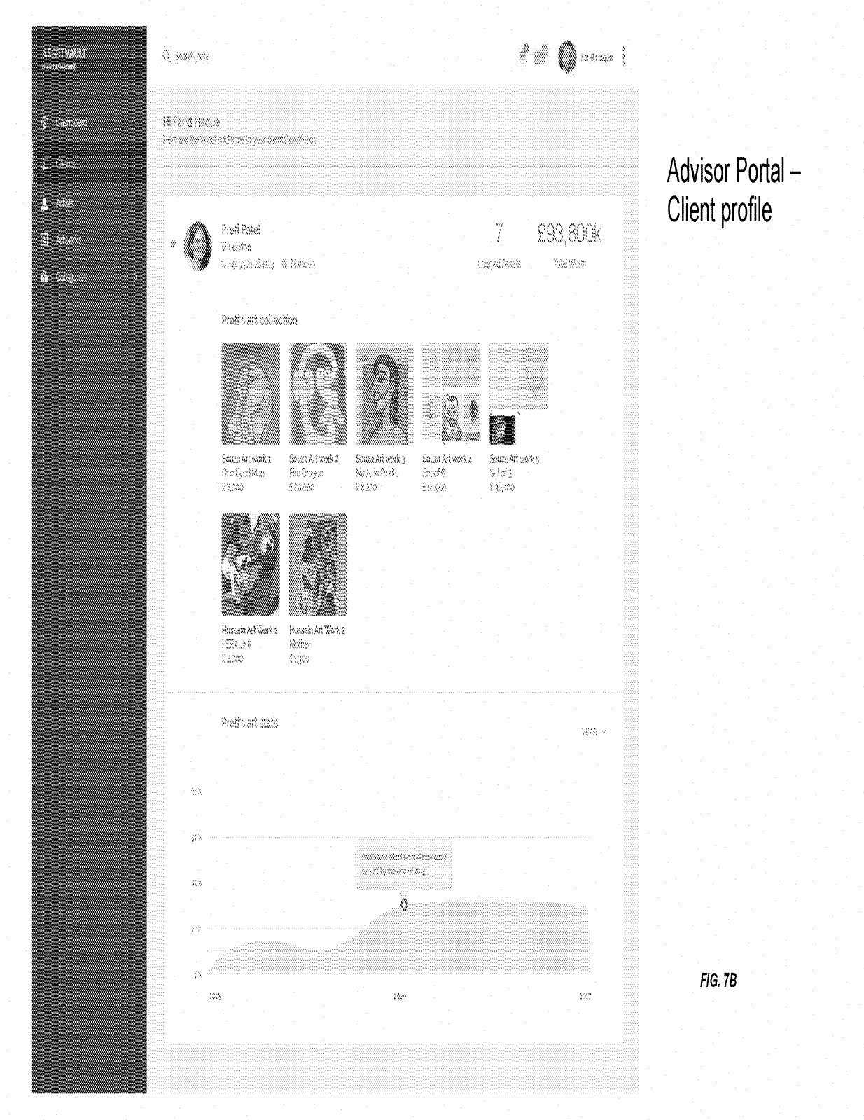

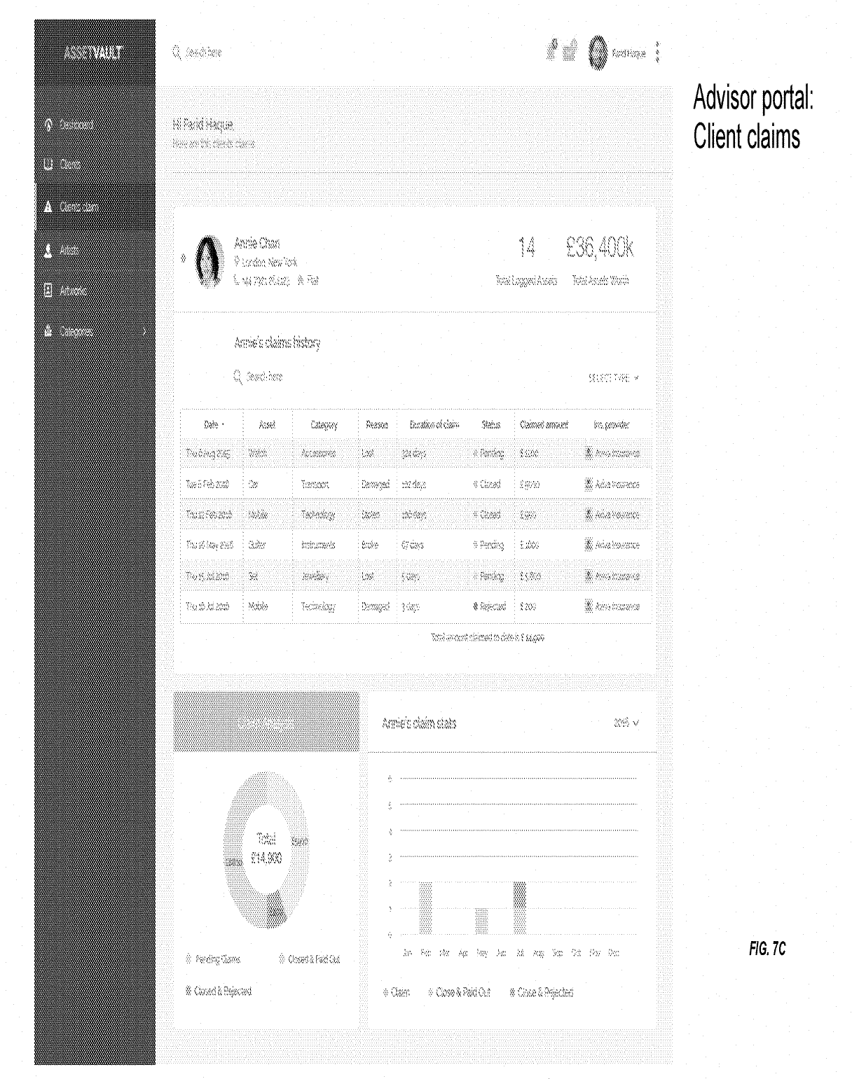

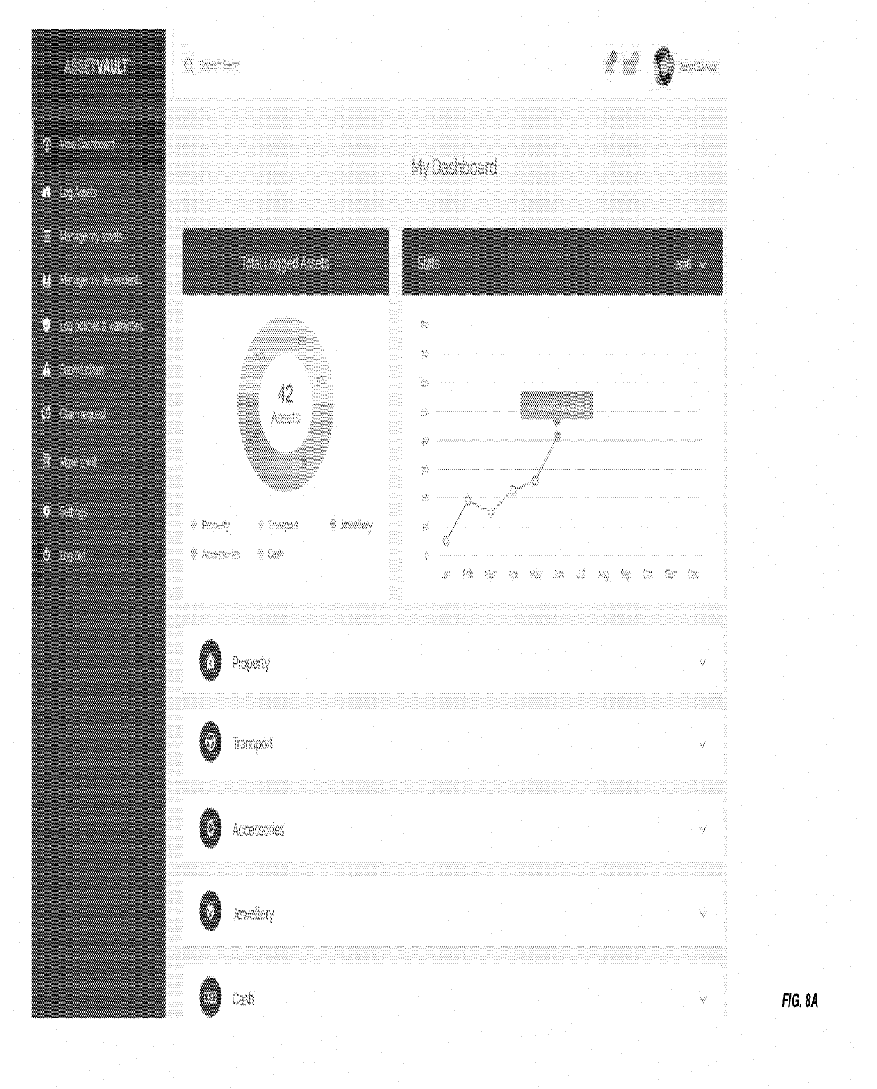

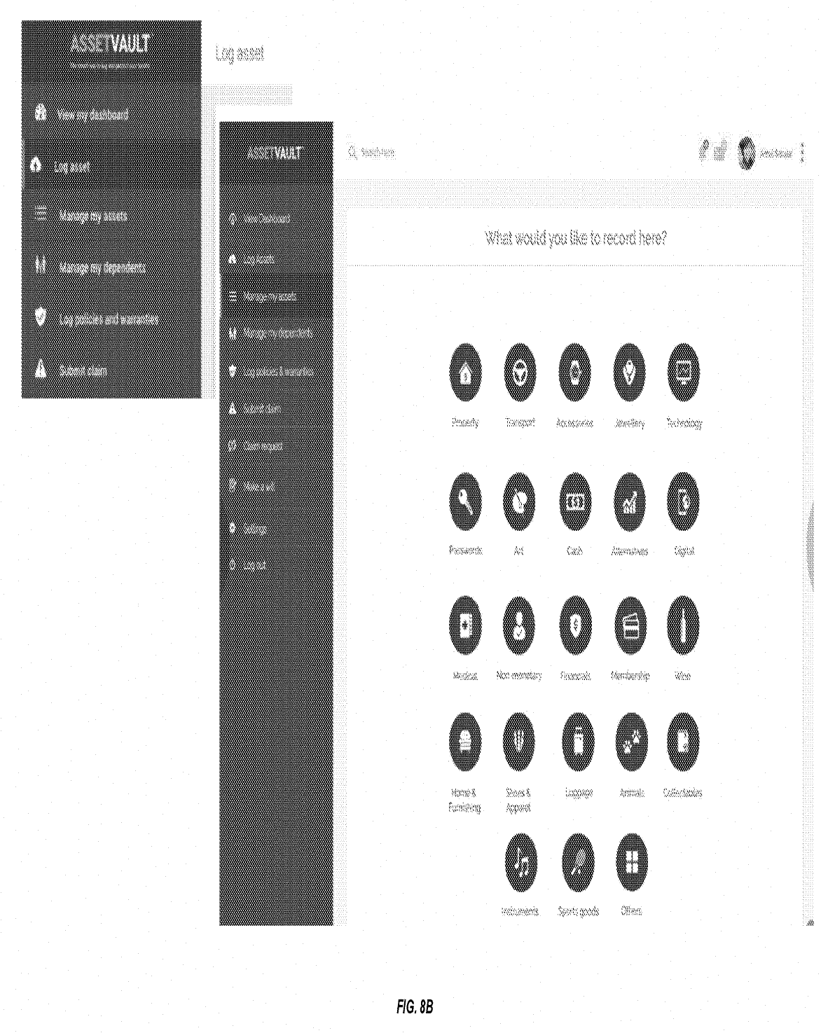

Example flows for recording insurance or warranty for assets recorded in the ledger platform and flows illustrating example processes to facilitate preparation and submission of insurance claims are further illustrated in FIGS. 5A-D and FIGS. 6A-C. Tables I-IV below describe example insurance claim processes and decision flows for different insurance types and various ownership and insurance scenarios.

TABLE 1
Example insurance claim process
(car insurance)-Permutations & Combinations:

| | | Scenario 2: | Scenario 3: |
|---|---|---|---|
| | | Multiple Cars | Multiple Cars |
| | Scenario 1: | Owned (different | Owned |
| Type | Single Car owned | insurance) | (same insurance) |
| Car | P1: One car with | P1: Multiple cars | P1: Multple cars |
| Insurance | one insurance | with different | with the same |
| | policy already | insurance | insurance policy |
| | tagged to asset | policies tagged. | tagged (2 cars are |
| | Expected outcome: | Expected outcome: | under the same policy). |
| | The form is | When you claim | Expected outcome: |
| | pre-filled | on Car | When you claim on |
| | with all the info | Insurance → | Car Insurance → |
| | | Ask you which | Ask you which |
| | | car and then auto | car and then auto |
| | | pre-fill the form | pre-fill the form |
| | | with all Car and | with all Car and |
| | | policy information | policy information. |

TABLE II
Example Insurance claim process
(Home insurance)-Permutations & Combinations

| Type | Scenario 1: Single Home Owned | Scenario 2: Own multiple homes |
|---|---|---|
| Home | P1: One home with one insurance | P1: Multiple homes with different |
| Insurance | policy already tagged to asset | insurance policies tagged. |
| | Expected outcome: | Expected outcome: |
| | The form is pre-filled with all the | When you claim on home Insurance → |
| | info | Ask you which home and then auto pre-fill |
| | | the form with all home and policy information. |
| | P2: One home with one insurance | P2: Multiple home with different insurance |
| | policy but NOT tagged | policies BUT not tagged. |
| | Expected outcome: | Expected outcome: |
| | The form is pre-filled with the homes | When you claim on home Insurance → |
| | information but asks you to Tag the | Ask you which car and then → Proceed |
| | policy (only show those policies that | to Tagging the policy to the |
| | are home insurance policies) | appropriate car → auto pre-fill the form |
| | | with all Car and policy information. |
| | P3: One home logged in ledger | P3: Multiple homes with different |
| | platform no insurance information | insurance policies BUT not tagged. |
| | Expected outcome: | Expected outcome: |
| | Ask user to submit Insurance | When you claim on Home Insurance → |
| | Policy info (before we can assist you | Ask you which home and then → if the |
| | with the Claim) and then proceed | policies show but the right one is not |
| | with claim. Here you need to go | existing then → Create a new record for |
| | from Claim → Insurance Policy | a new policy → auto pre-fill the form |
| | logging → Back to the Claim | with all home and policy information. |
| | P4: One home logged in ledger platform | |
| | with out of date insurance information | |
| | Expected outcome: | |
| | One asset is selected: User should | |
| | be asked to verify if the insurance | |
| | details are correct and IF not then | |
| | update the insurance policy | |
| | information | |

TABLE III
Example insurance claim process (Home Contents): Permutations & Combinations

| | Scenario 1: | Scenario 2: |
|---|---|---|
| Type | Contents you own in your home | Contents you own away from home |
| Home | P1: All the contents affected by the | P1: All the contents affected by the |
| Contents | claim are already tagged in the policy. | claim are already tagged to the policy. |
| Insurance | Expected outcome: | Expected outcome: |
| | The form is pre-filled with all the info | The form is pre-filled aith all the info |
| | P2: All the contents is entered as an | P2: All the contents is entered as an |
| | asset already but it is not all tagged to the policy. | asset already but it is not all tagged to the policy. |
| | Expected outcome: | Expected outcome: |
| | Tag assets already logged to the ledger | Tag assets already logged to the |
| | platform, should be able to chose | ledger platform, should be able |
| | from your list of asssets. | to chose from your list of assets. |
| | P3: Some of the contents is entered in | P3: Some of the contents is entered |
| | the app however some is not. You | in the app however some is not. |
| | have a policy but not all assets. | Expected outcome: Should be able to |
| | Expected outcome: Should be able to | check box select some of the contents |
| | check box select some of the contents | already logged and also affected. |
| | already logged and also affected. | Should also have to option to add |
| | Should also have to option to add | more assets to the claim, this will |
| | more assets to the claim, this will take | take you through log asset process |
| | you through log asset process and then bring you back | and then bring you back to the claim. |
| | to the claim. | |
| | P4: None of the contents is entered in | P4: None of the contents is entered |
| | the app however a policy is logged. | in the app however a policy is |
| | E.g. your home contents comes with | logged. E.g. your home contents |
| | your home insurance so you logged | comes with your home insurance so |
| | it for that reason however have not | you logged it for that reason however |
| | logged any contents. | have not logged any contents. |
| | Expected outcome: Should alert you | Expected outcome; Should alert you |
| | to the fact that you have no home | to the fact that you have no home |
| | contents items logged. Should be able | contents items logged. Should be |
| | to add new items and tag them to claim. | able to add new items and tag them to the claim. |
| | P5: All the contents is entered in the | P5: All the contents is entered in the |
| | app however there is not policy | app however there is not policy |
| | tagged to it or entered. | tagged to it or entered. |
| | Expected outcome: Should be able | Expected outcome: Should be able |
| | to insert a new policy-takes your to | to insert a new policy-takes your to |
| | add insurance process and then back | add insurance process and then back |
| | into a make a claim process. | into a make a claim process. |
| | P6: Not all the assets are inserted into | P6: Not all the assets are |
| | the app and there is no policy. | inserted into the app and there is |
| | Combination P3 and P5. | no policy. |
| | Expected outcome; | Expected outcome; Should be able |
| | Should be able to create new policy | to create new policy and also add |
| | and also add new assets and tag them to policy. | new assets and tag them to policy. |

TABLE IV
Accessories Insurance: Make a Claim process-Permutations & Combinations

| | | Scenario 2: | Scenario 3: |
|---|---|---|---|
| | Scenario 1: | One item | Multiple items Owned |
| Type | Item owned | multiple policies | (same insurance) |
| Accessories | P1: One item with one | P1: One item with | P1: Multiple items with |
| Insurance | insurance policy/ | different insurance | the same insurance policy |
| | warranty already | policies tagged. | tagged (2 items are under |
| | tagged to asset | Expected outcome: | the same policy). |
| | Expected outcome: | When you claim on | Expected outcome: When |
| | The form is pre-filled with all the info | accessory Insurance → | you claim on accessory |
| | | Ask you which item | insurance → Ask you which |
| | | and then asks you to | item and then auto pre-fill the |
| | | select from tagged | form with all item and |
| | | policies because you | policy information. |
| | | may want to claim on | |
| | | accessory insurance or | |
| | | on home contents | |
| | | insurance depending | |
| | | on the incident/pay out. | |
| | P2: One item with | P2: One item with | P2: Multiple items with the |
| | one insurance policy/ | different insurance | same insurance policy BUT |
| | warranty but | policies BUT not | not tagged (2 items are |
| | NOT tagged. | tagged. | under the same policy). |
| | Expected outcome: | Expected outcome: | Expected outcome: |
| | The form is pre- | When you claim on | When you claim on item |
| | filled with the item | accessory Insurance → | Insurance → Ask you which |
| | information but asks | Ask you which | item and then → Ask to Tag |
| | you to Tag the policy | accessory and then → | policy if it exists → auto |
| | (only show those | Proceed to Tagging | pre-fill the form with all item |
| | policies that are | the policy to the | and policy information. |
| | accessory insurance/warranty policies) | appropriate accessory → | |
| | | auto pre-fill the form | |
| | | with all accessory | |
| | | and policy information. | |
| | P3: One item in AssetVault, | P3: One item with | P3: Multiple item with the |
| | no insurance/ | different policies BUT | same insurance policy BUT |
| | warranty information | not entered. | not tagged (2 items are under |
| | Expected outcome: | Expected outcome: | the same policy). |
| | Ask user to submit | When you claim on | Expected outcome: |
| | Insurance/warranty info | Accessory Insurance → | When you claim on |
| | (before we can assist | Ask you which item and | Accessory Insurance → |
| | you with the Claim) | then → if the policies | Ask you which item and |
| | and then proceed with | show but the right one | then → policy does NOT |
| | claim. Here you need | is not existing then → | exist and needs to be |
| | to go from Claim → | Create a new record | entered → auto pre-fill the |
| | Insurance/warranty | for a new policy → auto | form with all item and |
| | Policy logging → Back to the Claim | pre-fill the form with all | policy information. |
| | | item and policy information. | |

The host system includes 3rd party integrations with third party service providers such as banks, lenders, insurers, law firms, accountancy firms and/or data sources for analytics. Such integrations through APIs can also facilitate the auto-logging and automatic storage of information regarding items or services purchased in real time in the digital asset catalogue provided via the ledger platform 212. For example, transactions/purchases over a certain amount can be detected through Apple Pay or Google Wallet plugins.

FIG. 3 depicts an example block diagram of a host server 300 able to securely manage, monitor, catalogue or log assets via a decentralized ledger and facility various applications and add-on services (third party or hosted) thereof.

The host server 300 can include, for example, network interface, a catalogue engine 361, a user tracking engine 364, an asset tracking/monitoring engine 380, a recommendation engine 368, a machine learning engine 370, an insurance and/or warranty manager/provider engine 375, a legal services engine 385, a financial advisor portal administration engine 390 and/or 3rd party APIs. The host server 300 may include internally or be externally coupled to a user repository 118, a user analytics repository 120, a third party data/content repository 122, an encryption key repository 124, an asset catalogue & analytics repository 126, and/or a legal document repository 128, as illustrated by way of example in FIG. 1A. Additional or less components/modules/engines can be included in the host server 300 and each illustrated component.

The network interface can be a networking module that enables the host server 300 to mediate data in a network with an entity that is external to the host server 200, through any known and/or convenient communications protocol supported by the host and the external entity. The network interface can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or its functionality distributed. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C.

101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

The host server 300, is in one embodiment the disclosed system or a portion of the disclosed system which provides a cryptographic platform (e.g., including host server 100 and/or ledger platform 112 of FIG. 1A) for exchanging, recording, information or assets or facilitating transfer of ownership or title to said assets.

Example implementations may retrieve and/or provide one or more records or information transactions (e.g., records and/or transactions relating to logging, management, monitoring of assets, the information/data/metadata related to the asset and/or accessing said information/data/metadata) to a ledger, (e.g., a ledger (distributed or decentralised) administered by the ledger platform 112). The information transactions can include encrypted information intended for and/or to be accessed by a given party or parties (e.g., a user's spouse, children, other family members, other beneficiaries, trustees, financial advisors, legal advisors, insurance advisors, and/or accountants).

In one embodiment, the encrypted information may be encrypted with the intended party's public key such that a private key associated with the intended party is required to decrypt the encrypted information. The encrypted information can be decrypted with an associated private key such that it can be displayed to, accessed by, and/or modified by the intended recipient. Information transactions including any additional information encrypted by the intended recipient's public key can also be generated and provided to a ledger (e.g., a ledger (distributed or decentralized) administered by the ledger platform 112).

As such, in examples of implementations, the cryptographic platform facilitates secure and private communication, storage, logging, transfer, recordation, cataloguing of information (e.g., information regarding assets, finances, insurance policies, warranties, users, legal documents, etc.) amongst multiple parties via information transactions provided to, stored on and/or retrieved from the ledger. Furthermore, the cryptographic platform enables confidential, verifiable, and immutable recording and/or reporting or exchange of information and/or transactions including various encrypted information (e.g., private communications). In some implementations, the system(s) and/or method(s) for providing a cryptographic platform for exchanging information as described herein may be used as a means of information or asset transfer/exchange from one to many and/or many to one (e.g., from one party to multiple parties and/or from multiple parties to one party). In some embodiments, the parties may include one or more of multiple end parties, multiple sub-parties of a single party (e.g., to facilitate exchange of information internally and/or among subordinate entities), and/or other parties.

In one embodiment, the catalogue engine 361 further includes a cryptography engine 362 and a security key manager 363. The cryptography engine 362 may further include an encryption engine. The cryptography engine 362 and/or the security key manager can authorize and manage the administration of security keys, passwords, biometric data used to access the ledger platform.

The user tracking engine 364 can include, for example, a family relationship tracking and monitoring engine 365, a legal, accounting, financial advisor tracking engine 366, and/or a permissions manager 367. The permissions manager 367 can include, for example, a public/private key administration engine 368 to administer keys to users of the ledger platform and other authorized viewers or editors of assets and information recorded in the ledger platform. In one embodiment, the asset tracking/monitoring engine 308 includes a dynamic valuation engine 381 suitable for in valuing asset value and performance dynamically in real time or near real time, or periodically—real time or updated value can be used in various financial and insurance applications.

The machine learning engine 370 can include, for example, an analytics generator 371 and/or an actionable insight provider engine 372, each of which or the combination of which, in some embodiments, along with the recommendation engine 368, provides artificial intelligence (Al) features or bots in the host server 300 to detect and notify users of actionable items to leverage or protect their assets. The machine learning engine 370 can implement by way of example, off the shelf or proprietary object recognition, natural language processing (NLP), translation, OCR image processing and/or image classification techniques.

The insurance manager/provider engine 375 can be hosted within the host server 300 or be in part integrated with a 3rcl party insurer or insurance provider. The engine 375 can include a monitoring engine 377 and/or a dynamic recommendation engine 378. The legal services engine 385 includes for example, a will, trusts and estate administration engine 386. The legal services engine may be hosted within or by the host server 300 or partially integrated with a 3rct party legal services provider.

The will, trusts and estates administration engine 386 provides and intuitive manner for customers to create and execute a will (e.g., a digital will, e-will, or eWill). The host server 300 facilitates the witnessing, signature process so the process of creating a valid will can be fully digitized if so desired. Legal requirements of different jurisdictions to generate a valid will are tracked and executed by engine 386, for example the host server 300 can provide e-signature hosting services that comply with the laws of various countries and jurisdictions.

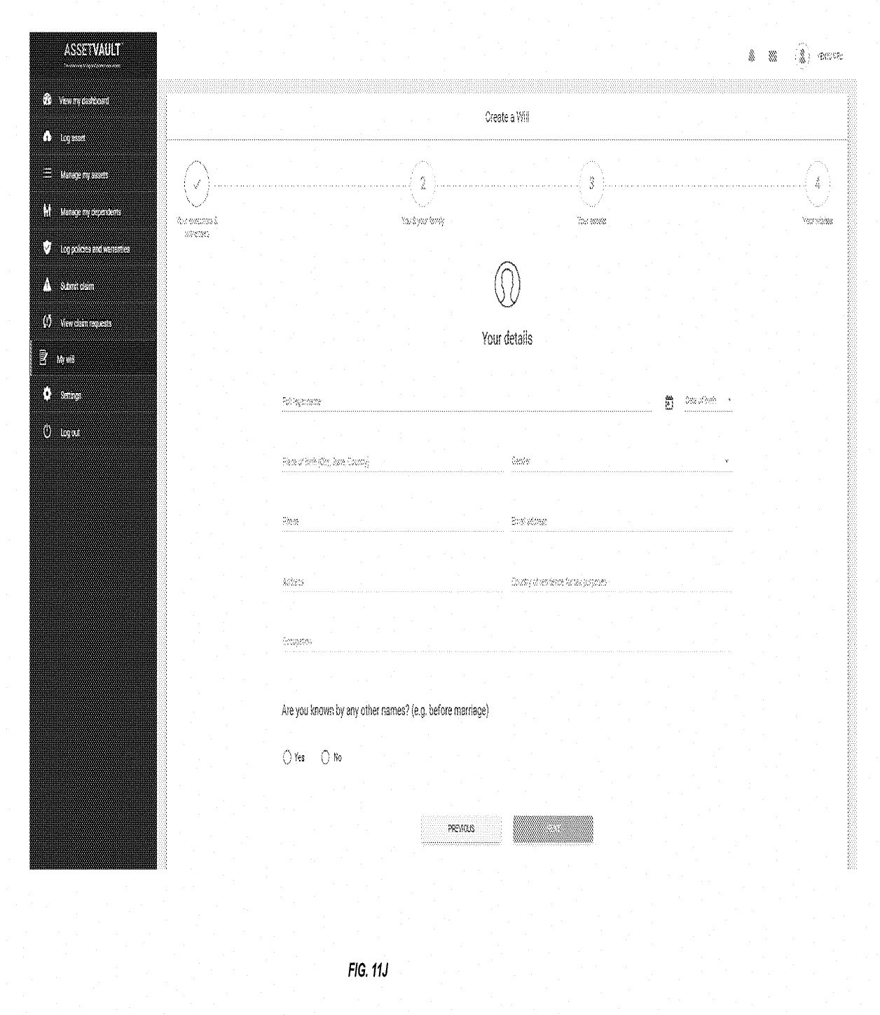

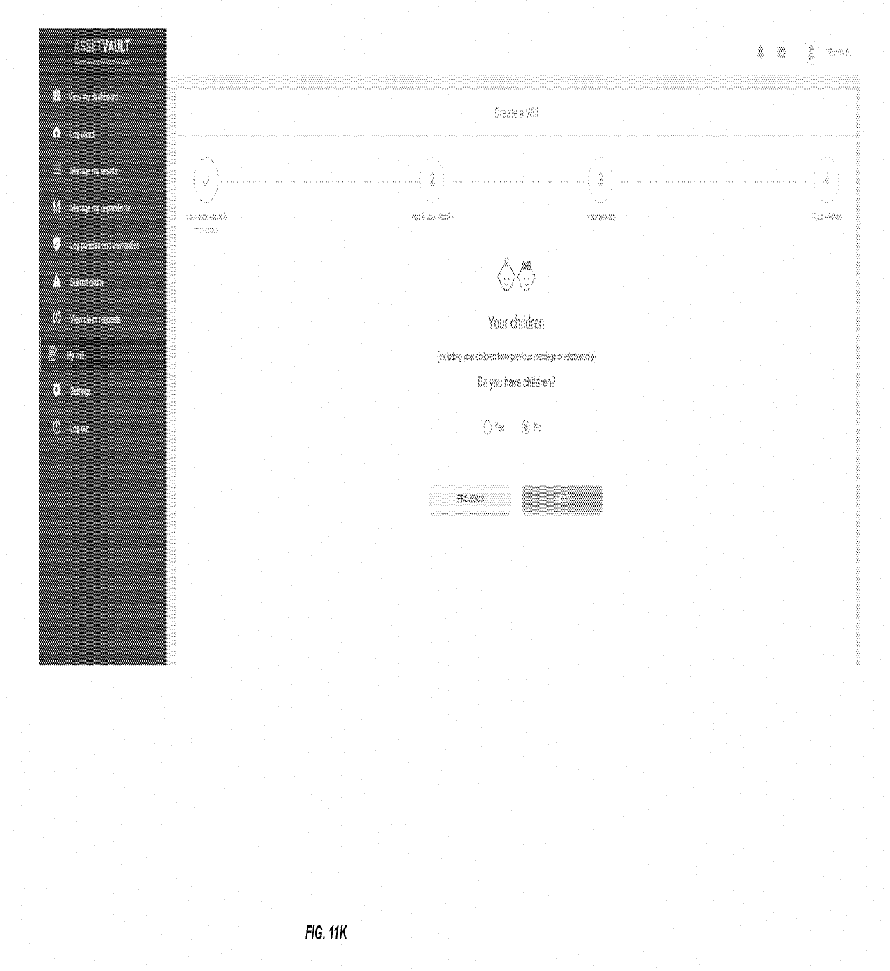

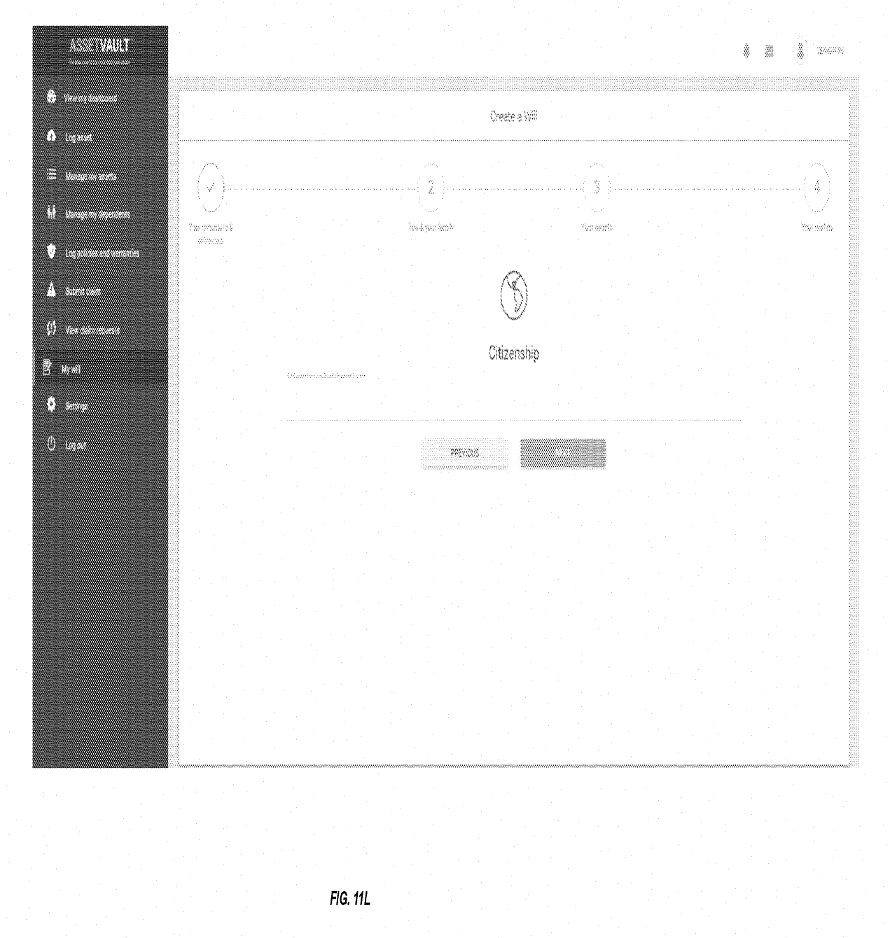

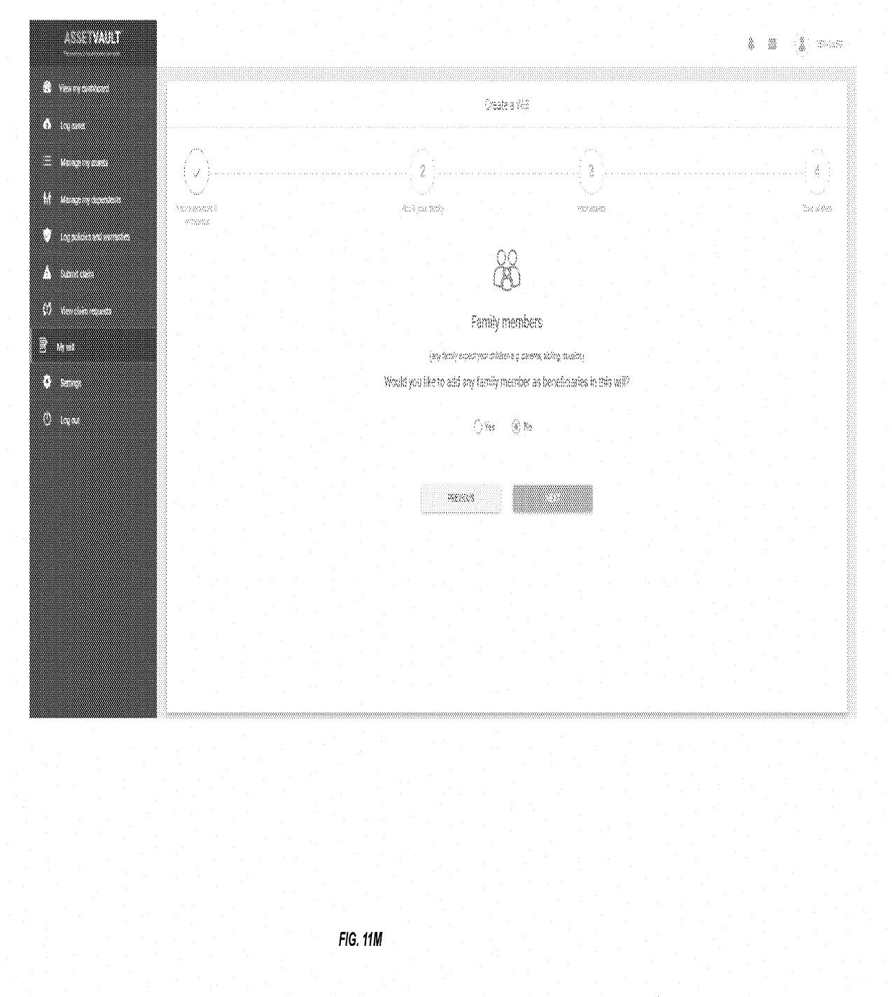

In one embodiment, the digitally created will (e.g., living will) can include free text space so the user may add assets manually outside of the host server 300 to include cataloged and non-cataloged assets. Engine 386 allows users to select beneficiaries for subcategories within each category. And to split assets across beneficiaries. In one embodiment, user input and/or third party (e.g., lawyer, advisor) input of the will can be facilitated. Example flows for creating a will using the host server 300 are illustrated in the example screenshots of FIG. 11A• FIG. 16.

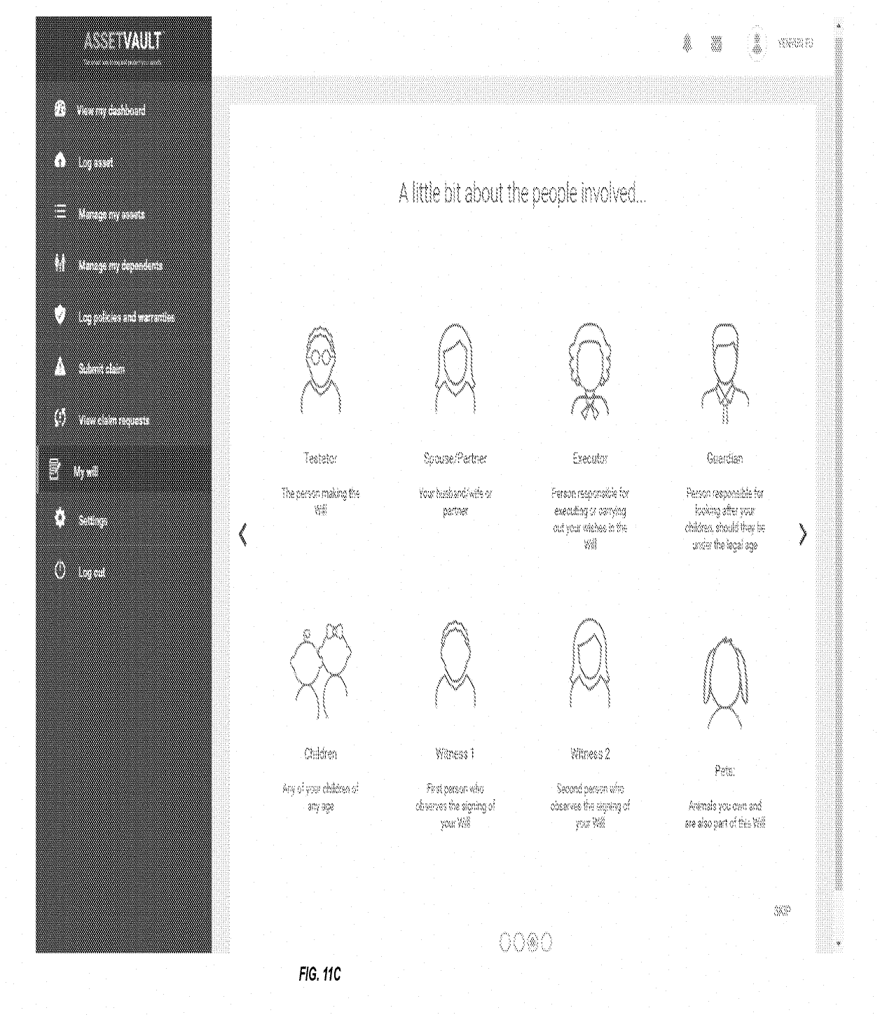

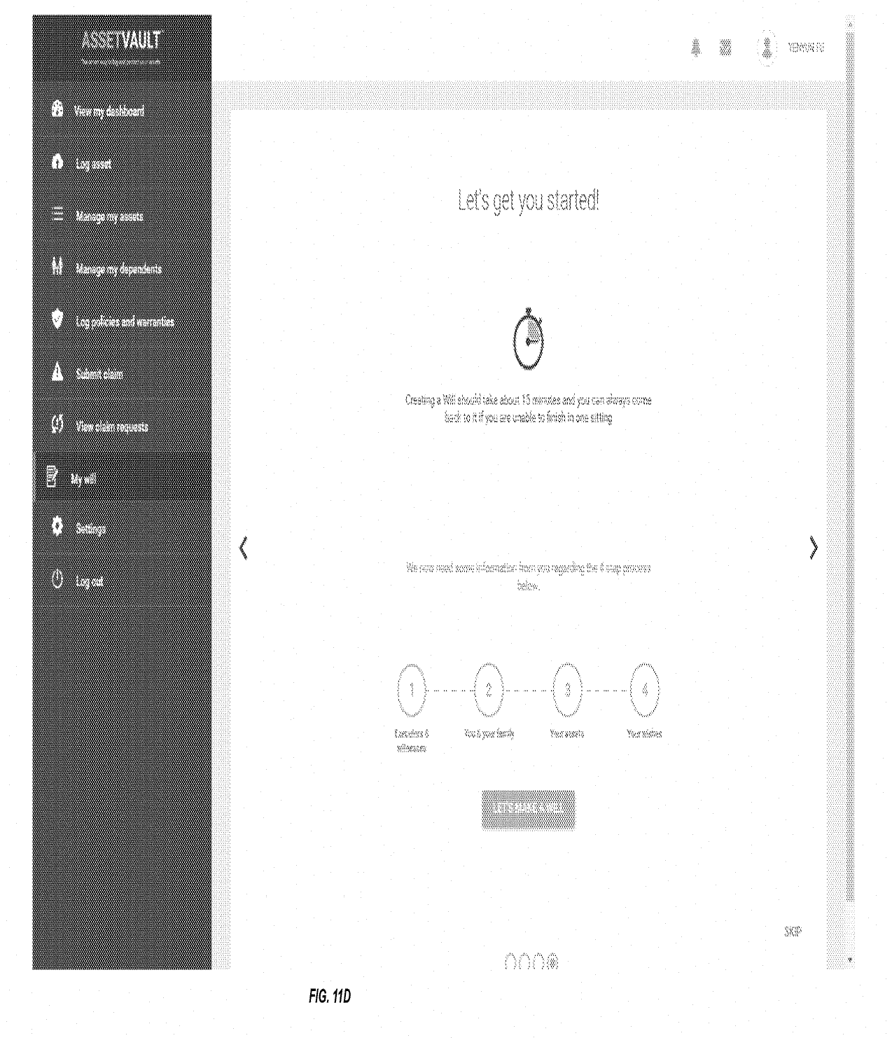

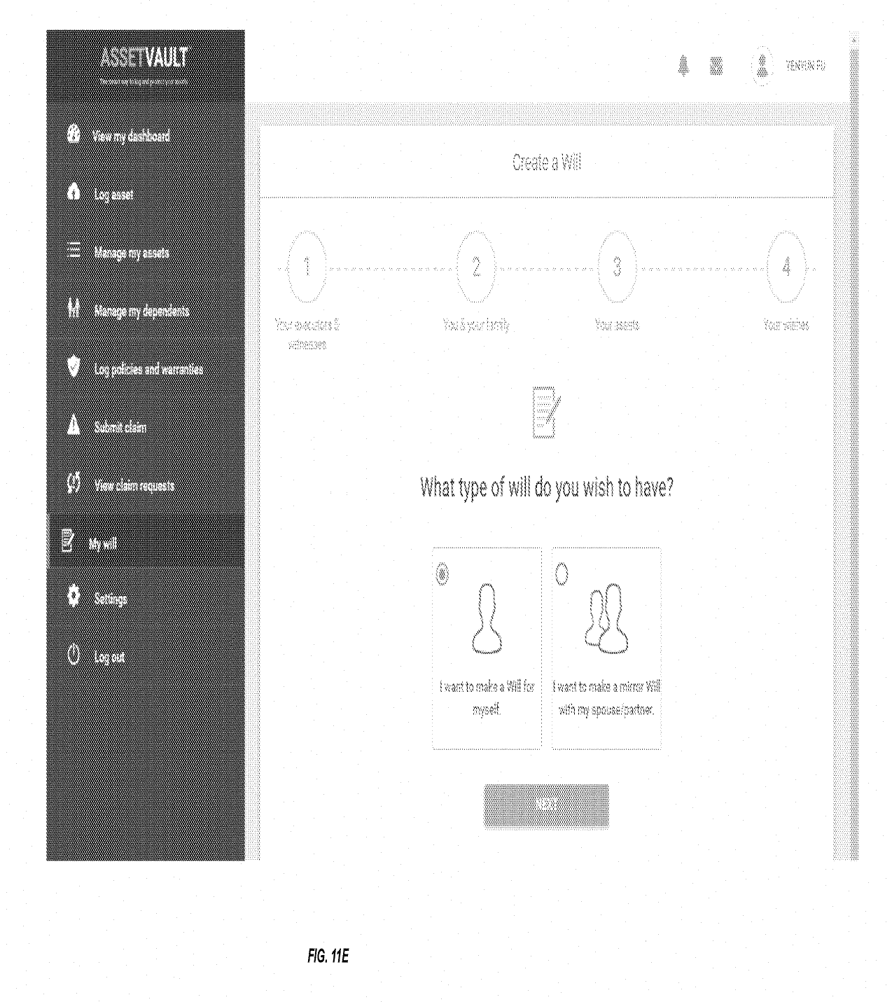

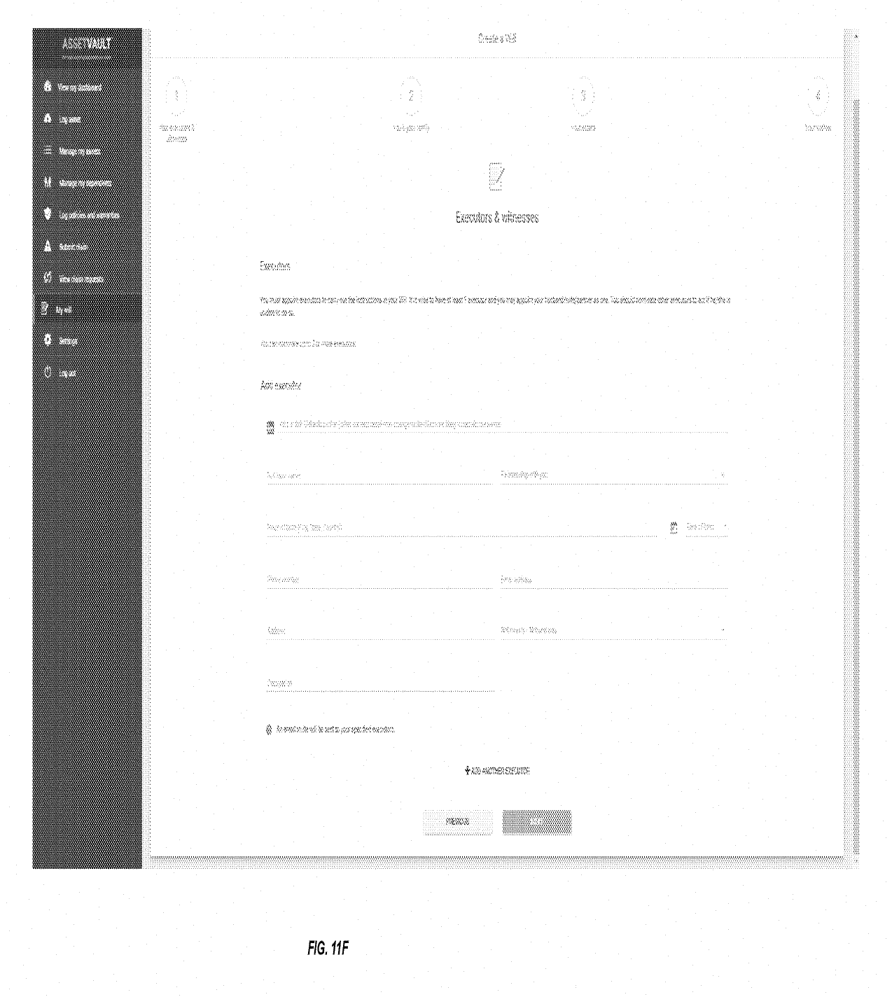

The engine 386 can also periodically automatically remind the user to update the will, or remind the user to update the will upon detection of a life event (e.g., reaching a certain age, change in marital status, addition to household members by marriage or by birth, etc.). Values of assets can also be shown in will (e.g., current value, last known value by 3 rd party valuator, original purchase price, etc.). In addition, guardians can be appointed in wills as well as substitute guardians. The example flows for facilitating the digital will creation and generation process are further illustrated in FIG. 9A-B.

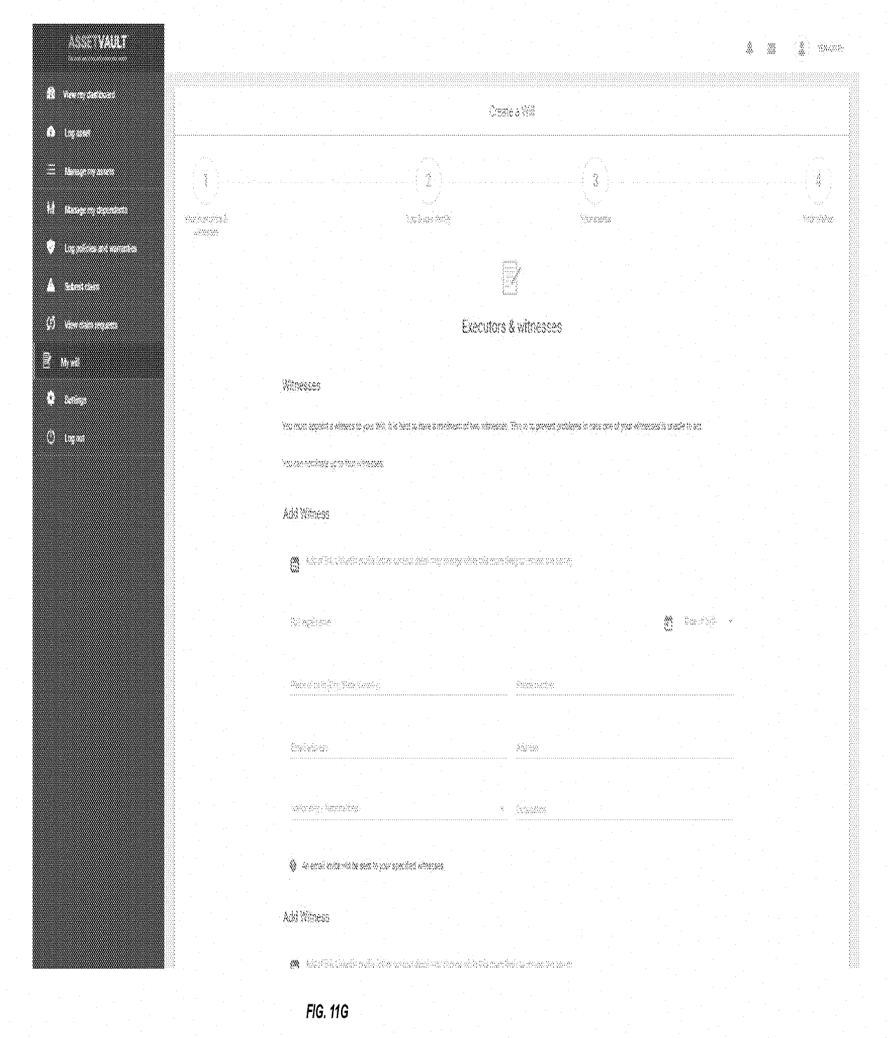

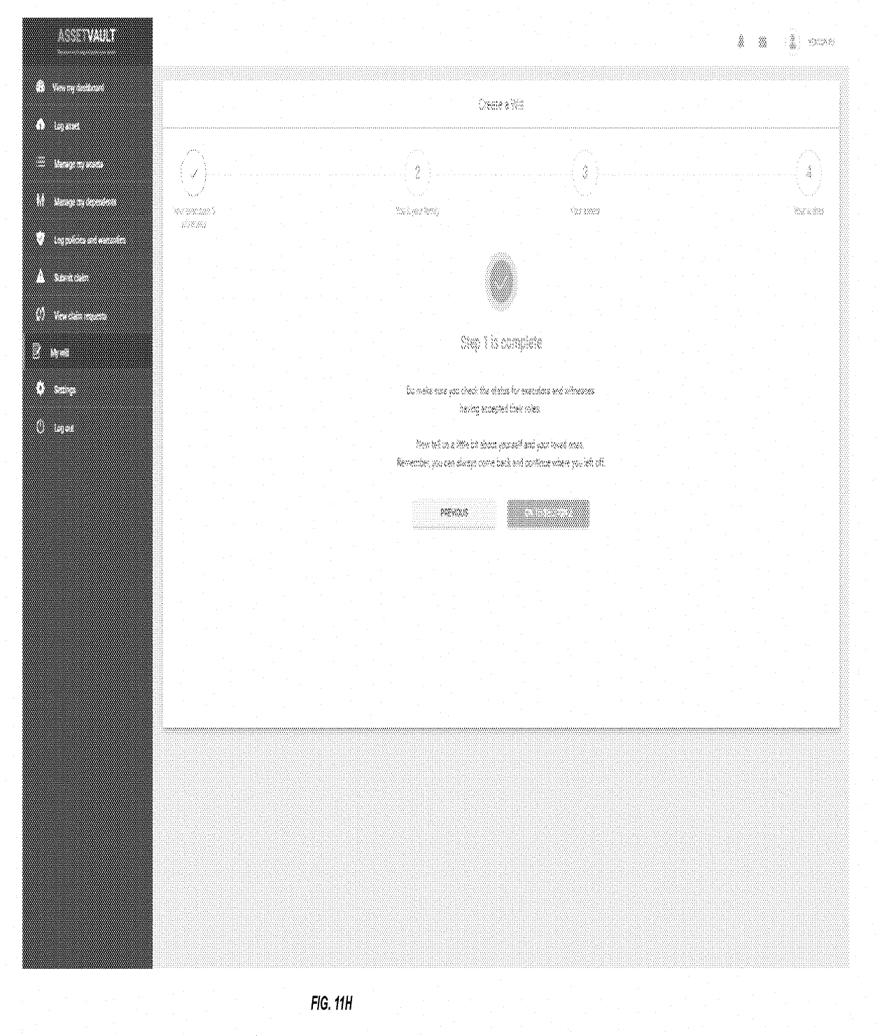

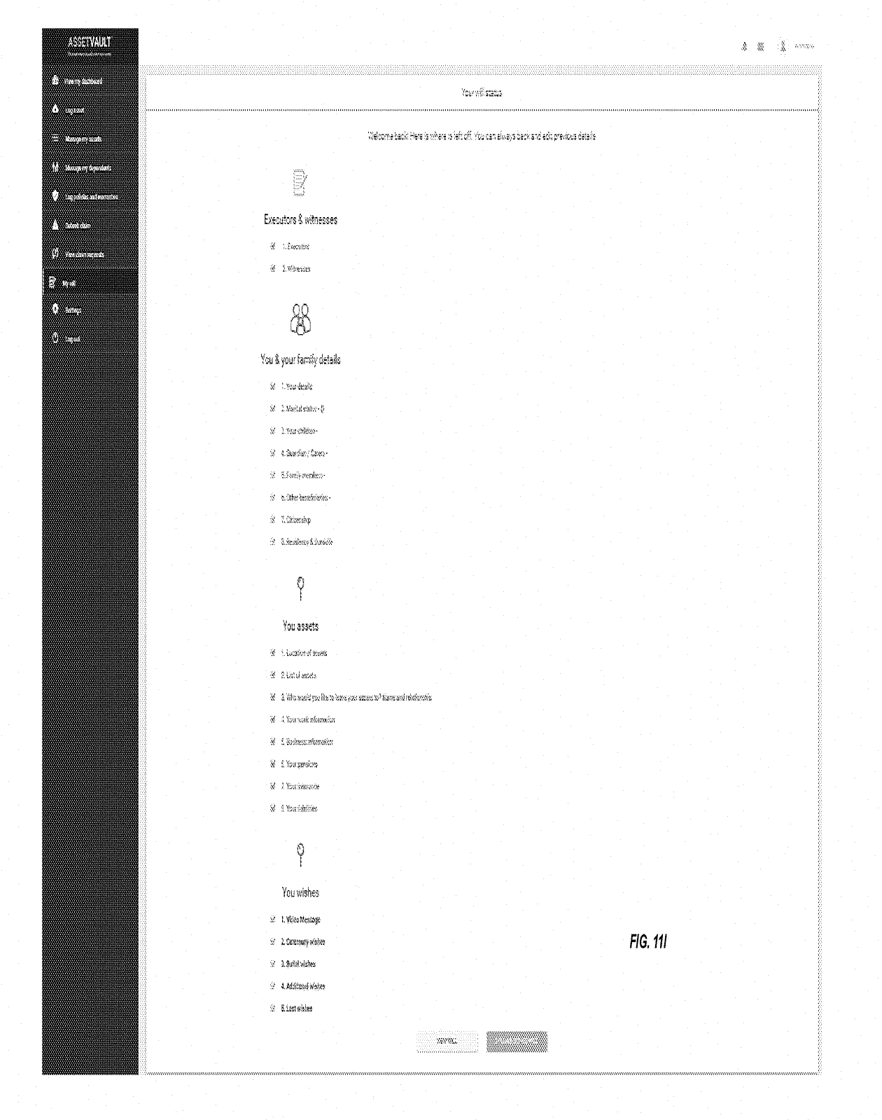

Note that executors are also specified in the digital wills and the host server 300 executes a flow which validates that the appointed executors and witnesses agree to performing their roles and are authenticated via two factor authentication, 2FA biometrics, or other known or new security means. The flows for notifying and authorizing and appointed executor of a will are further illustrated in FIG. 10A-10G.

Examples of asset categories that can be logged in the ledger platform (cryptographic platform) are shown below in Table V. Examples of some data fields for certain asset categories are shown in Table VI.

TABLE V
Asset Categories/subcategories

| Property | /Accessories | Non-monetary | Digital |
|---|---|---|---|
| Plot | Gold, silver, precious | Photographs | Bank accounts |
| Town home | metals | ID proof: Passport, | Pensions |
| Duplex/Triplex | watches | Driver's license | ISAs |
| Apartment buildings | Rings | Educational | Wallets: digital |
| Hotel | Necklaces, other male | qualifications | currencies |
| Commercial real estate | or female accessories | Professional | Brokerages |
| Capital equipment | Diamonds | Certifications | Loans |
| | Handbag | Diplomas | P2P Lending |
| | Shoes | Birth Certificate | Mortgages |
| | Belts | Marriage Certificate | Scis investments |
| | Cufflinks | Medical records | Crowdfunding investing |
| | | | Private equity |
| | | | investments |
| | | | Alternative imvestments |
| | | | (Venture capital, Angel |
| | | | investments) |
| Transport | Passwords | Publications | Sports |
| Cycle | Facebook | Books | ski boots and gear |
| Others: Boat, Plane, | Linkedin | Magazines | Snooker sticks |
| jetway, segway | Bank accounts | Comic books | Polo gear |
| | | Newspaper | Diving gear |
| | | (clippings) | |
| | Antiques, other | | |
| Technology | collectibles | Pets/Animals | Cash |
| gaming systems | Designer furniture | Horses | USD |
| Headmounted devices | Stamps | Dogs | GBP |
| | Instruments (Pianos, | Cats | EURO |
| | Violins, Guitars) | Camels | Singaporean Dollar |
| | | | Hong Kong Dollar |
| | | | Australian Dollar |
| | | | all other fiat currencies |
| Art | Wine | | |

TABLE VI
sample fields for example asset categories

| Property | Jewelry/Accessories | Vehicles |
|---|---|---|
| Type: residence, flat | Upload image of item | Car, Yacht, Bikes, Jets etc |
| apartment, | Attach receipt | Manufacturer |
| Location: geo tag | Manufacturer | Year |
| Value £: purchase | Date of purchase | Condition: Fair, Good, |
| value | Value £: purchase value | Very good, Excellent |
| Date of purchase | Insurance (upload details | (slider) |
| Book value | if applicable): Provider | Milage |
| Description | (Name e.g. HSBC), | Registration number |
| Insurance | Policy Number, | Free description field |
| Warranty | Expiration date | Value £: purchase value |
| Imagest | Image of policy will | Date of purchase |
| | do too | market value, replacement |
| | | value (AV shows these) |
| | | Where it resides? |
| | | Insurance |
| | | Warranty |
| | | Images |

The host server 300 represents any one or a portion of the functions associated with the modules. The host server 300 can include additional or less modules. More or less functions can be included, in whole or in part, without deviating from the novel art of the disclosure.

FIG. 4A-B depict flow charts illustrating example processes for a user to catalogue assets and its associated data/information in a ledger platform (e.g., ledger platform 112 or 212), for a new user and an existing/returning user.

FIG. 5A-D depict flow charts illustrating example processes for recording insurance or warranty for assets recorded in the ledger (e.g., ledger platform 112 or 212), by new users and existing/returning users.

The insurance policies and/or warranties recorded may be policies associated with assets already recorded in the ledger. The system allows such added insurance policies and/or warranties to be tagged with the associated recorded assets. New policies/warranties not associated with an asset logged in the ledger platform can also be added.

FIG. 6A-C depict flow charts illustrating example processes to facilitate preparation and submission of insurance claims of assets logged using the insurance policies recorded in the ledger platform. FIG. 6-D depicts a flow chart illustrating example processes for the host server via AI and machine learning techniques, to assess and evaluate sufficiency of an insurance policy (e.g., home contents insurance recorded in the ledger platform).

FIG. 7A-C depicts example screenshots showing views of an advisor portal administered by the host server showing user information, asset information, insurance information and/or other financial information stored, generated and/or logged on the ledger platform.

FIG. 8A-H depict example screenshots of the web application administered by the host server for the secure management, monitoring, cataloguing of assets and asset information and providing access to add on services (e.g., advanced machine learning, analytics, artificial intelligence and actionable insights) and third party applications/services (legal, accounting, financial advisor, insurance provider, etc.).

In addition, the user interfaces such as user dashboard of FIG. 8A can include an activity feed (dynamic, real time, or periodically updated) indicating actions a given user has taken (e.g., adding asset information, updating asset information, adding new insurance or updating thereof, depiction of real time or near real time industry data (e.g., financial, insurance, etc.). One embodiment includes generation and depiction of Al-based suggestions via an implemented bot (financial bot or insurance bot). The AI based suggestions can include recommendation of new or updated coverage, or updates/notifications on warranties.

One embodiment further includes a search field in the user interfaces of the web application enabling users to search the catalogued assets, policies, warranties, or legal documents stored in the ledger. In some embodiments, content tiles can be depicted and determined based on assessment and machine learning of user behaviour, interests learned over time. The depicted content tiles can suggest collectable items such as art, wine, antiques, specialty gears, electronics, etc. based on types of assets the user has logged in the ledger platform. The content tiles can also be used for third party upsell of financial or insurance products tailored for the user.

FIG. 9A-B depict flow charts illustrating example processes for the host server (e.g., host server 100 or 300) to intelligently determine or generate appropriate will templates to provide to the user and to facilitate completion of the will using information of the user's assets and the user's family stored in the ledger platform (e.g., ledger platform 112 or 212). FIG. 10A-G depicts example screenshots showing processes for the host server (e.g., host server 100 or 300) to securely notify a designated executor of a testator's triggering life event and securely providing access of, the testator's will recorded in the ledger platform, to the executor, according to one embodiment.

FIG. 11A-P depict example screenshots of the web application administered by the host server for obtaining user information, family information and information about other potential beneficiaries for use in administering and facilitating the creation of a will (e.g., a digital will, e-will, eWill). In some embodiments, similar processes can be used to facilitate the creation, generation, administration, and/or management of trusts and/or other legal documents or inheritance related matters.

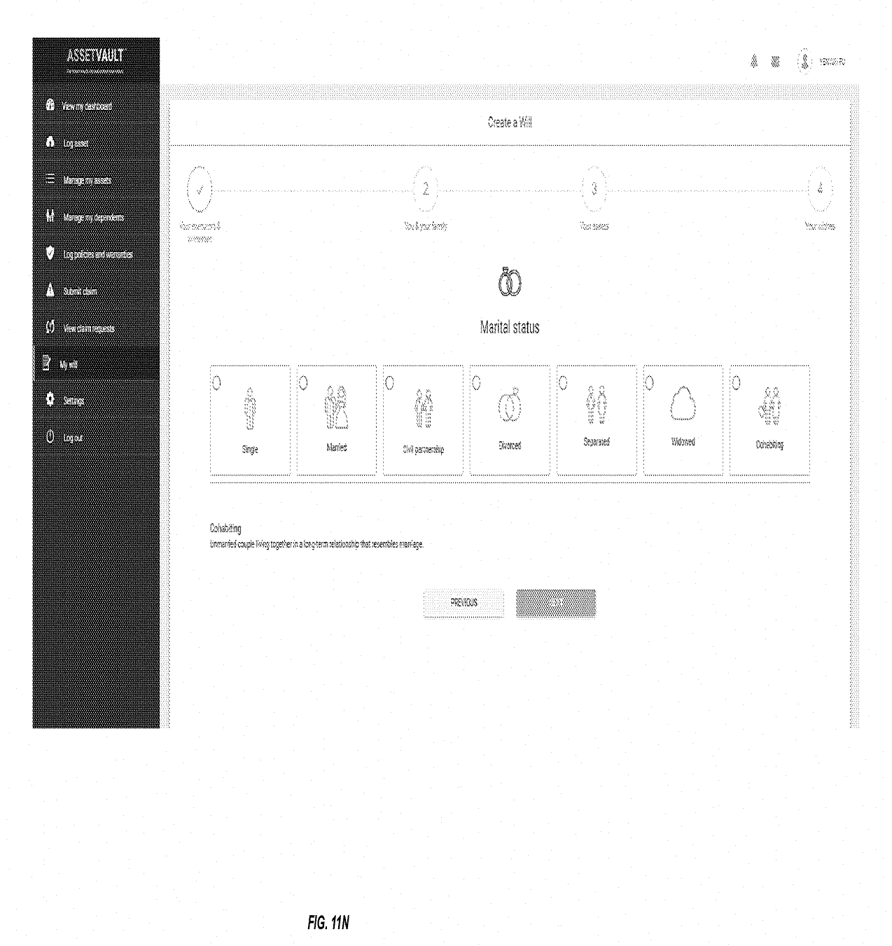

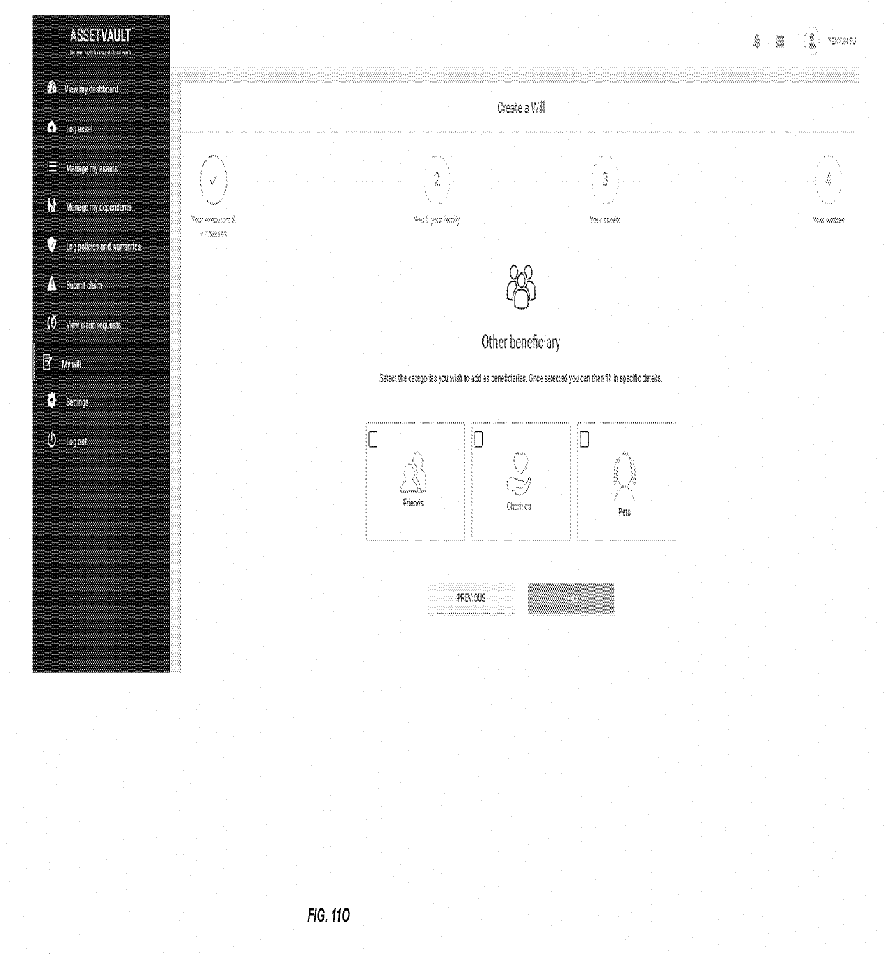

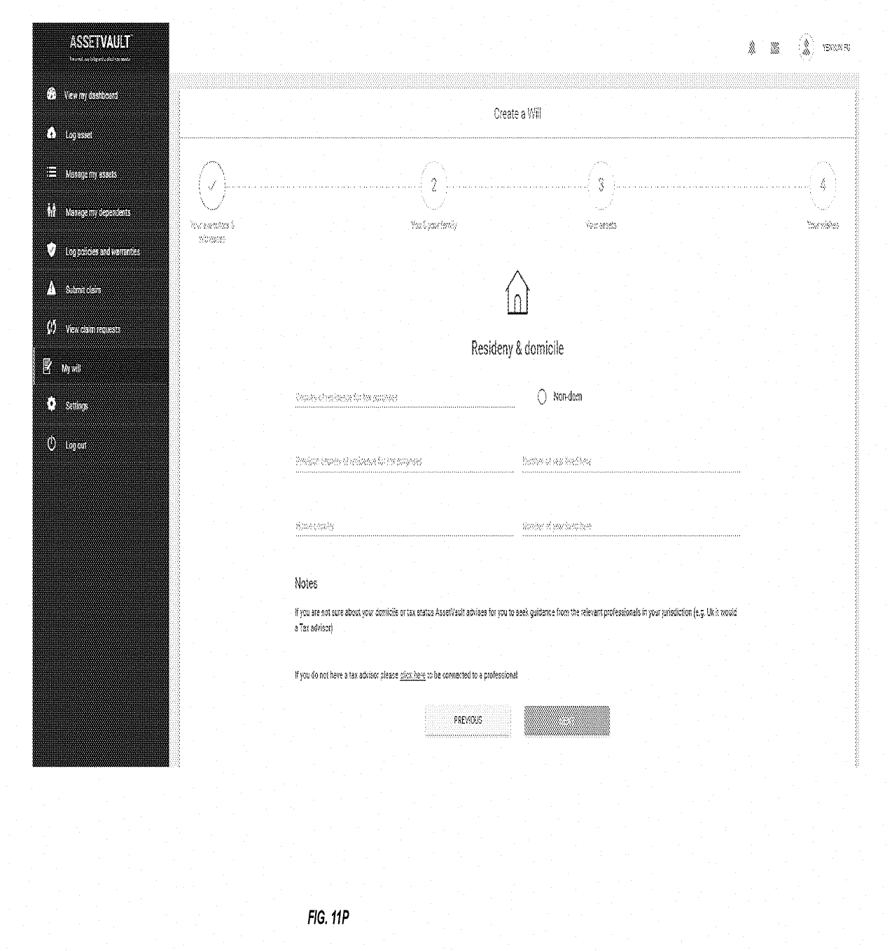

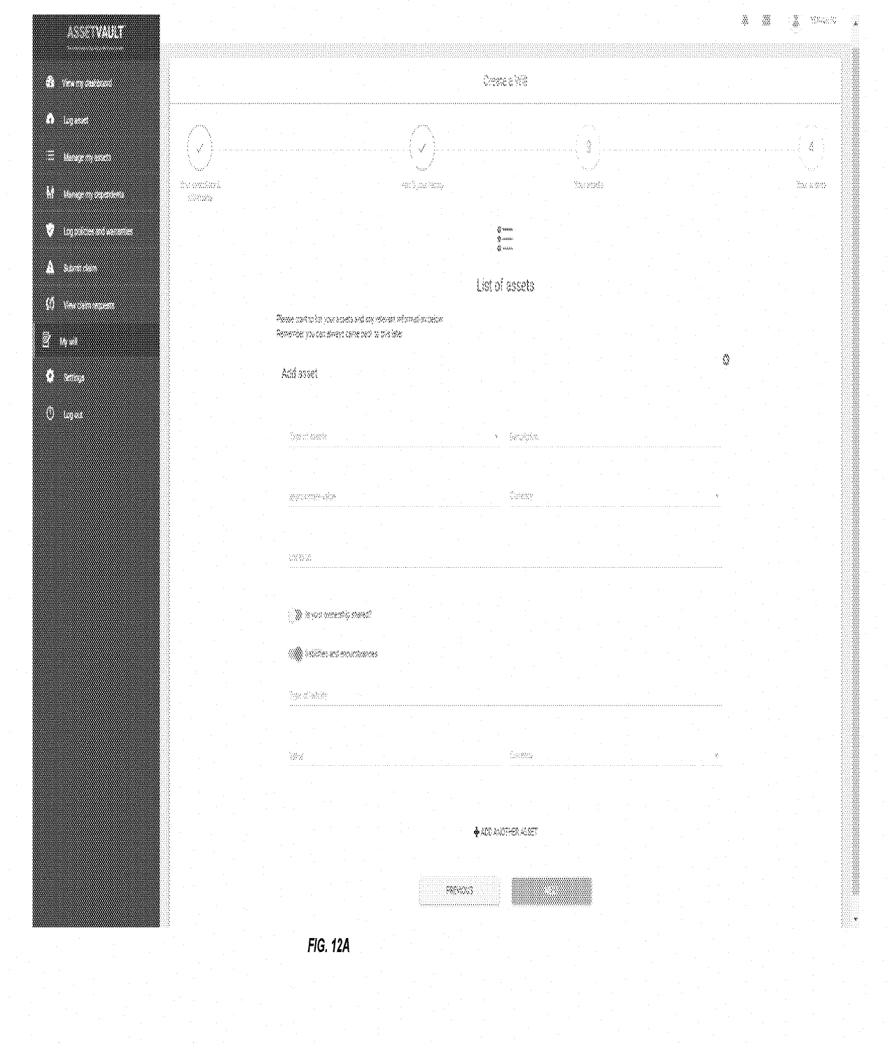

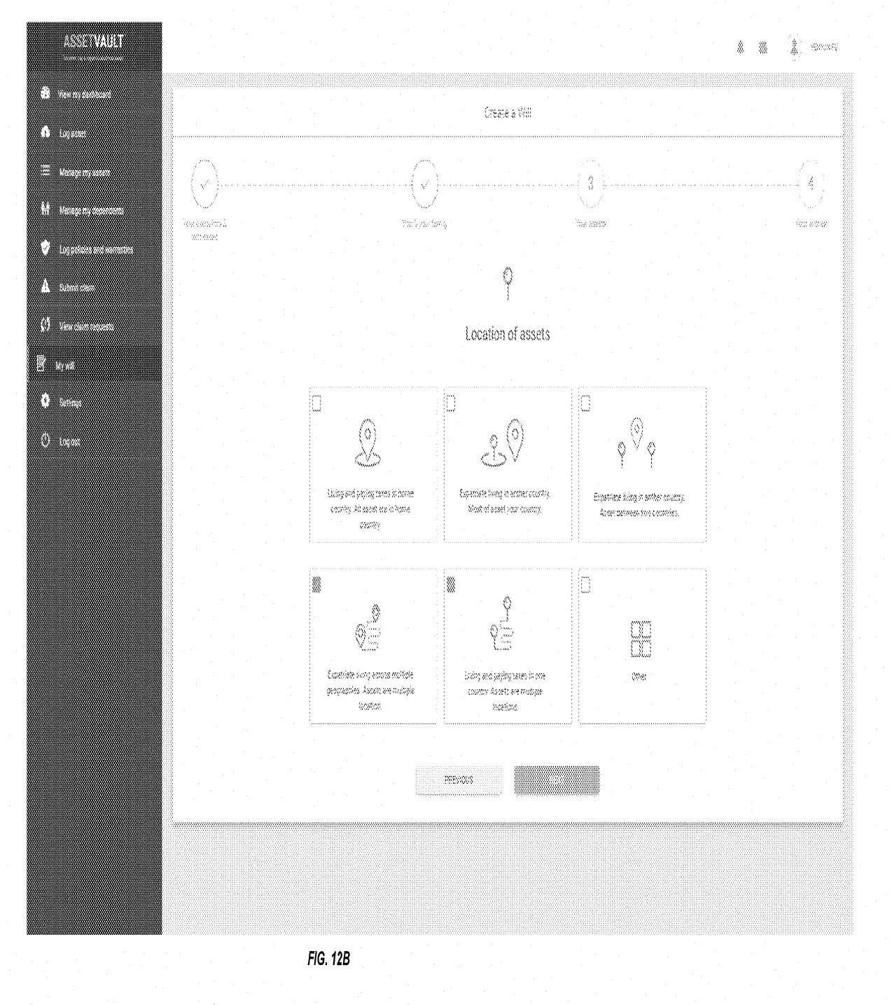

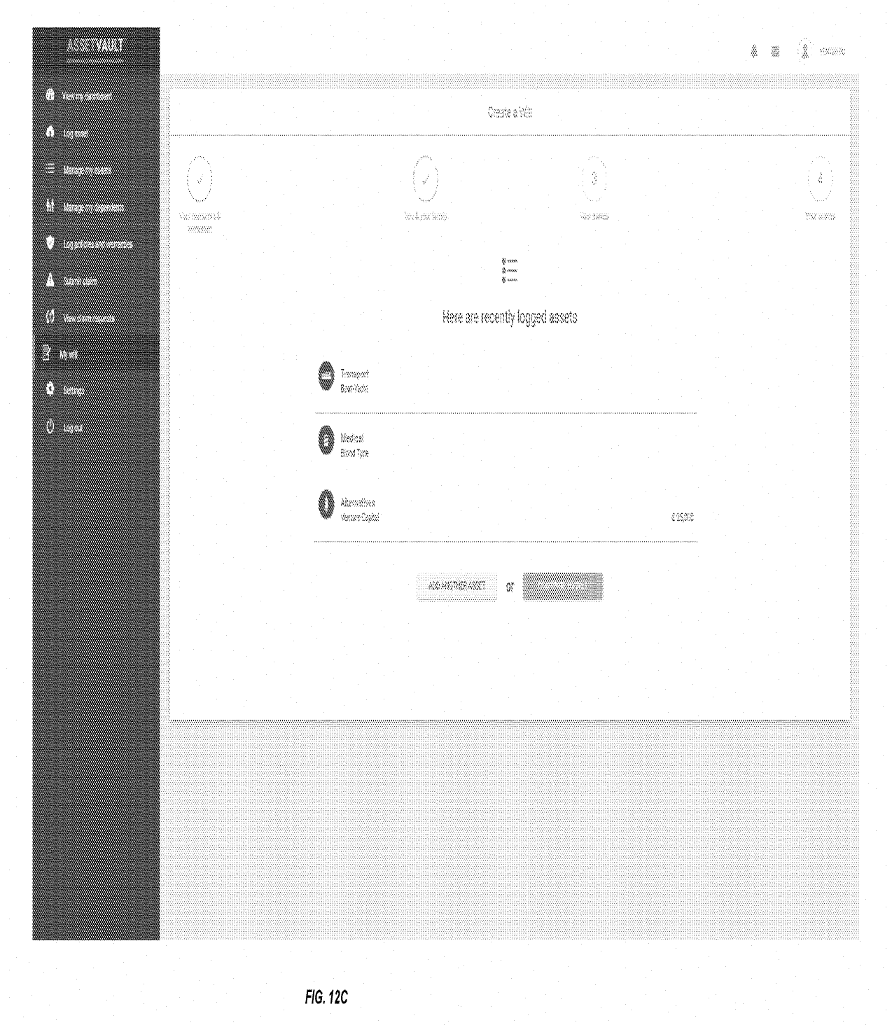

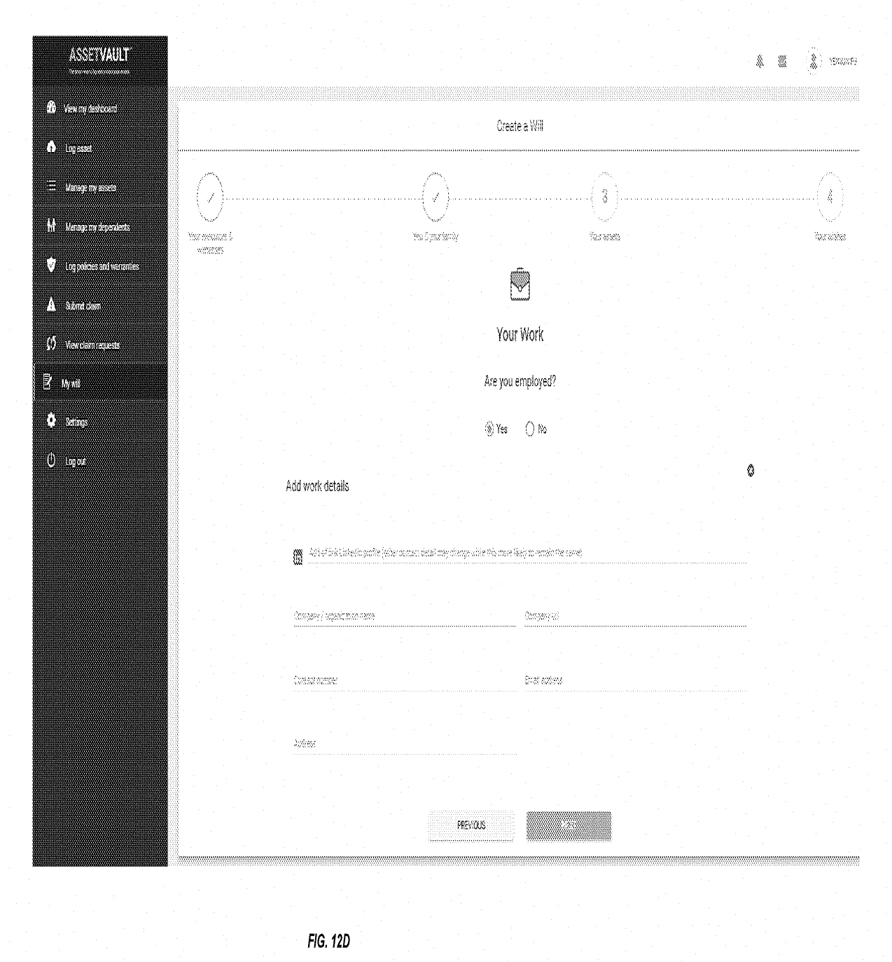

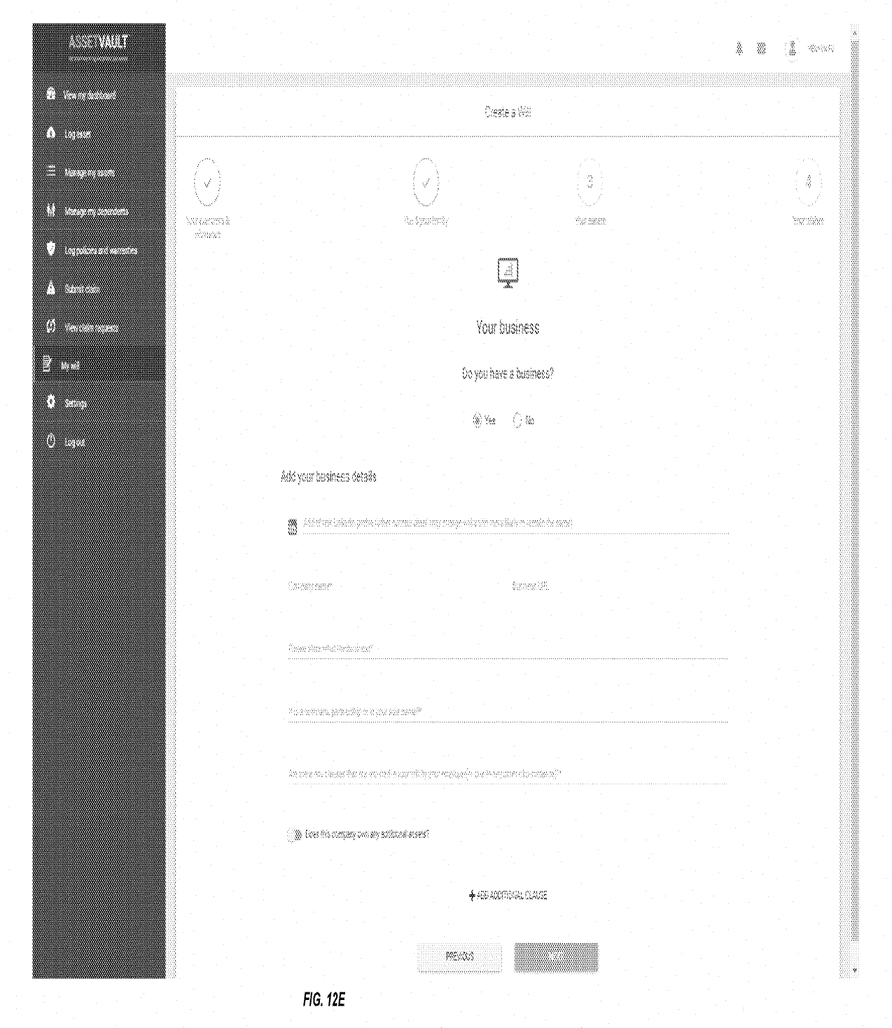

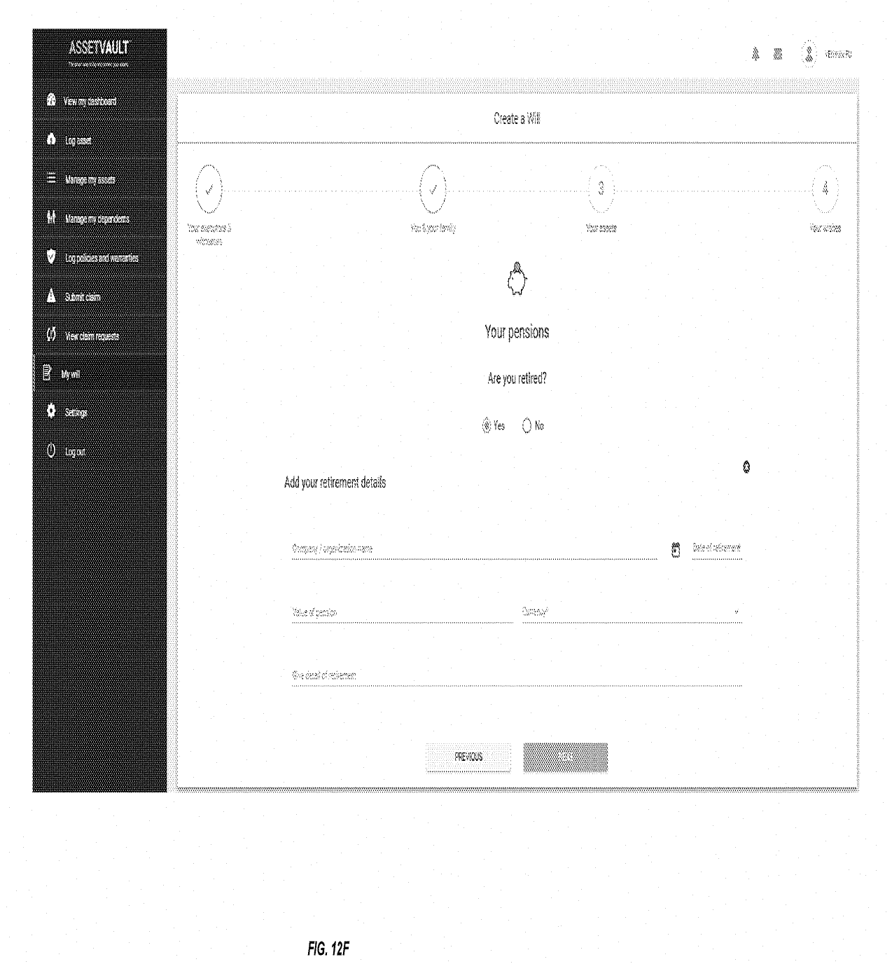

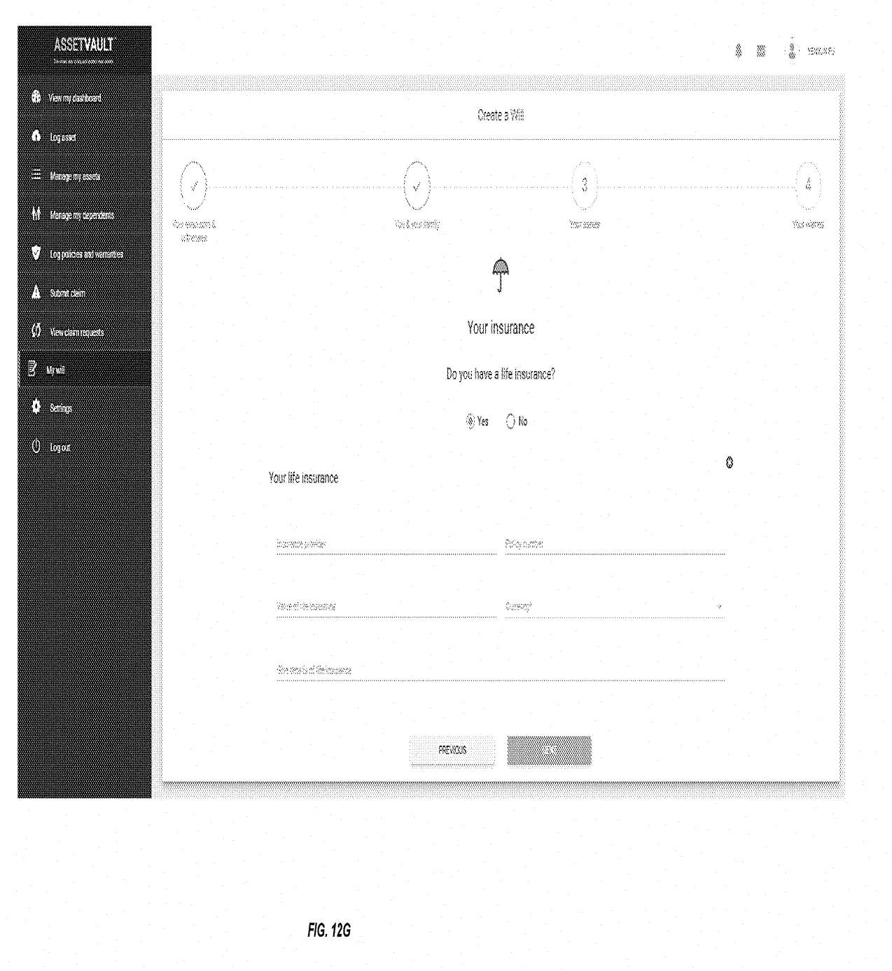

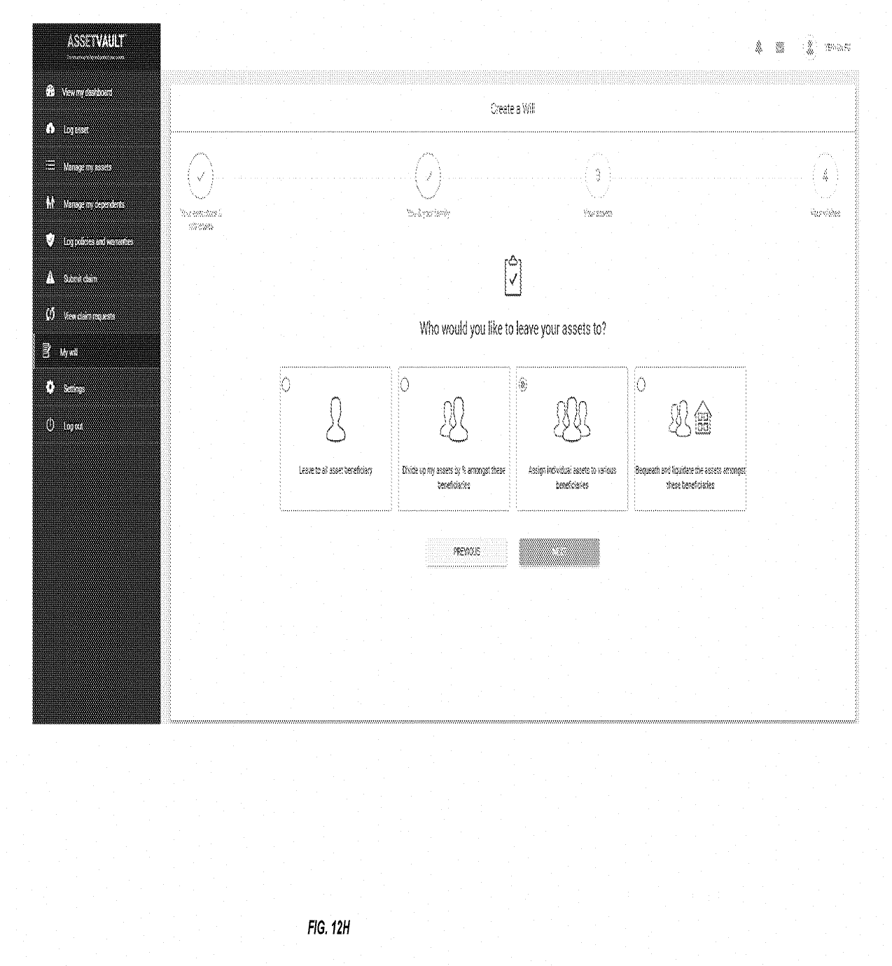

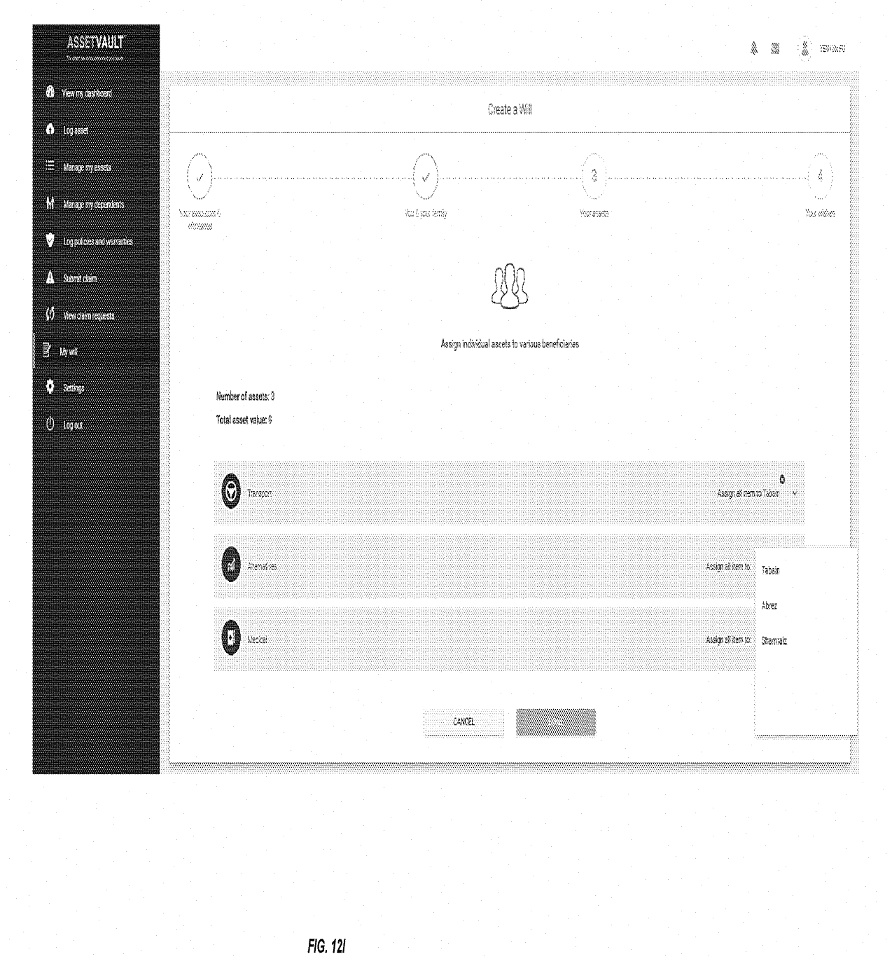

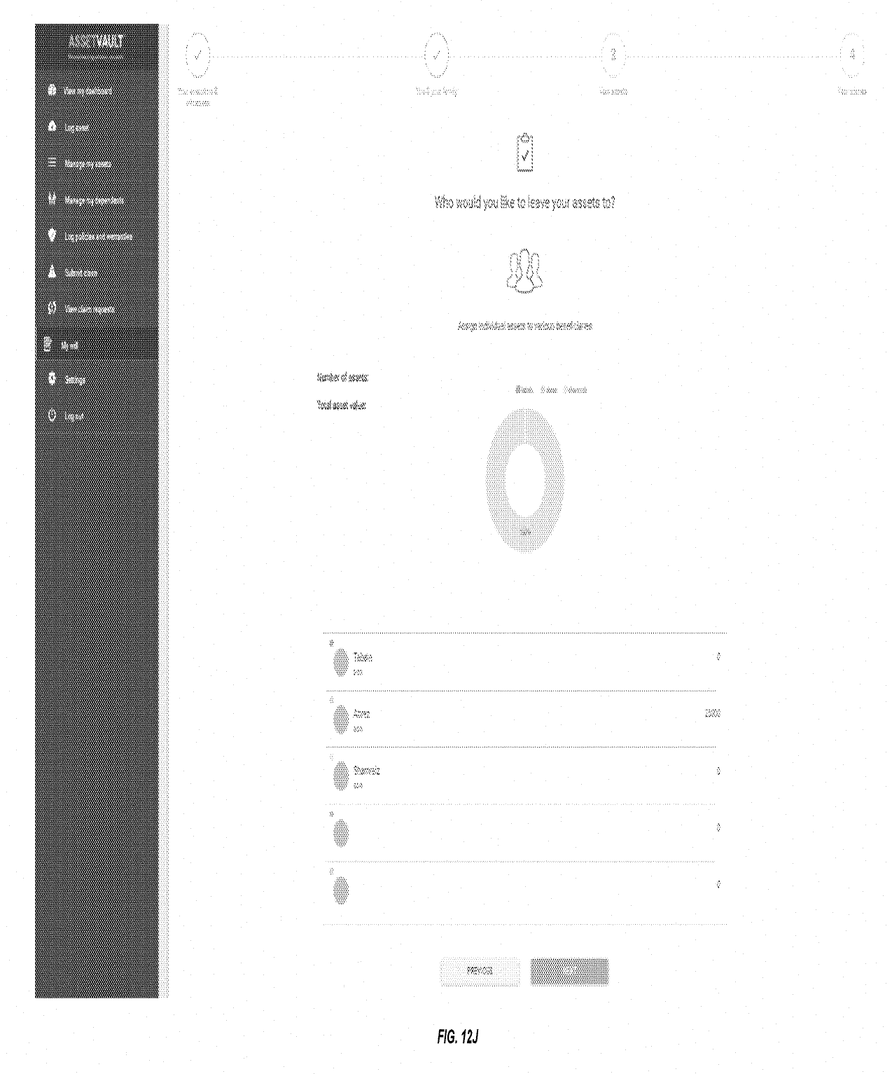

FIG. 12A-J depict example screenshots of the web application administered by the host server (e.g., host server 100 or 300) for obtaining asset list, asset information/data/metadata, user's business information, employment information, retirement account information, pension, insurance information, and enabling the user to specify details in bequeathing assets for the administering and the creation of a will (e.g., a digital will, e-will, eWill to be stored and managed on the ledger platform (e.g., ledger platform 112 or 212)). In some embodiments, similar processes can be used to facilitate the creation, generation, administration, and/or management of trusts and/or other legal documents or inheritance related matters.

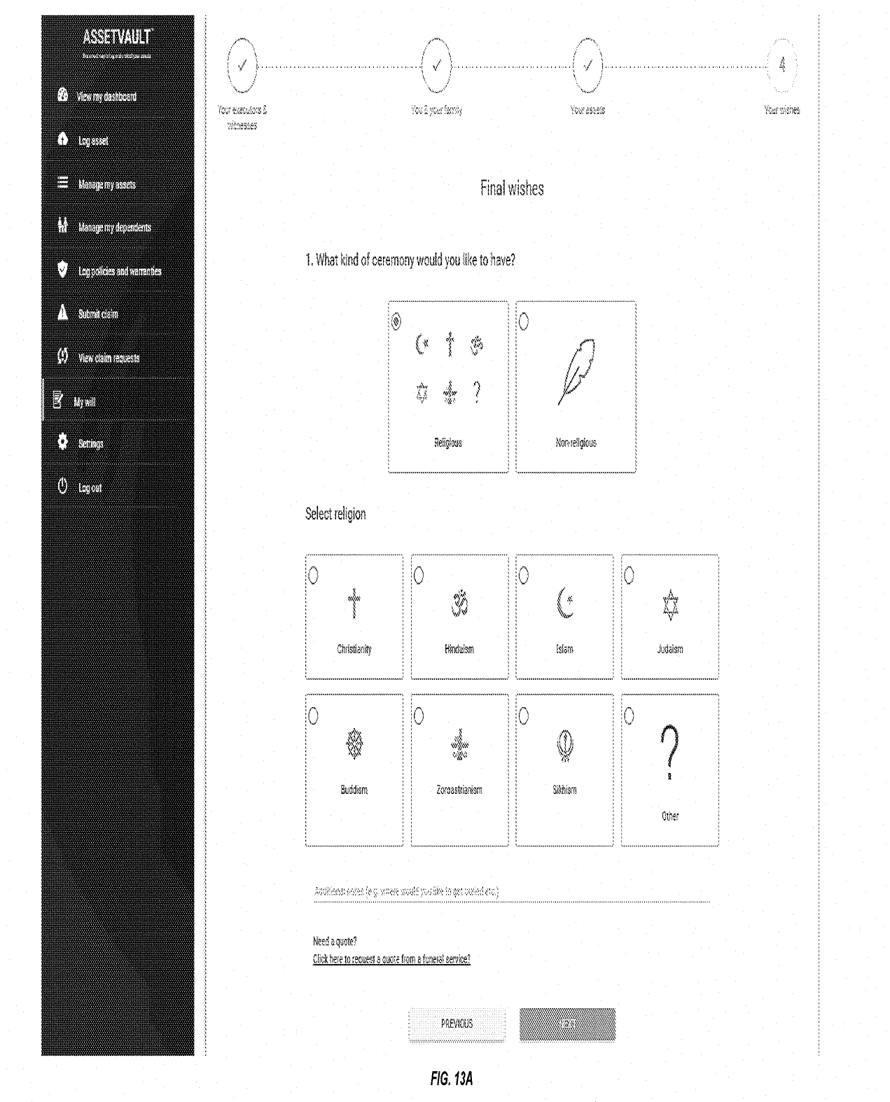

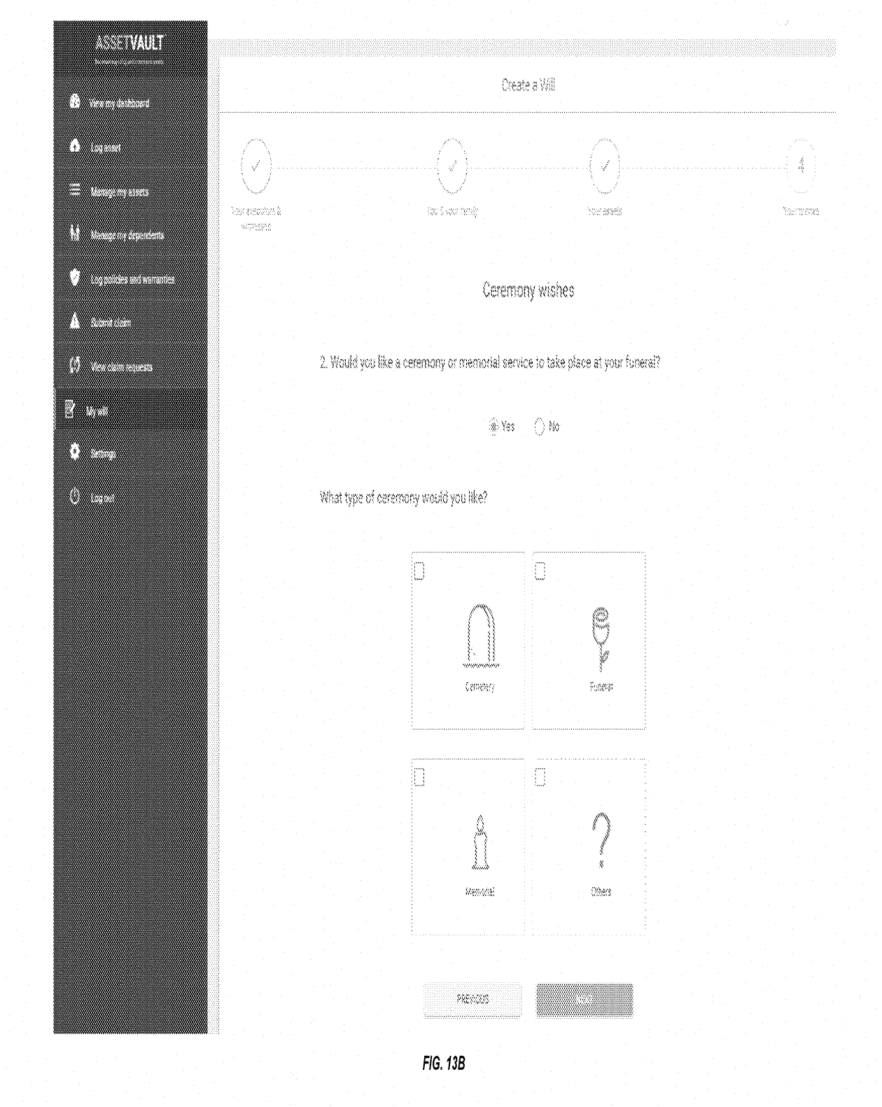

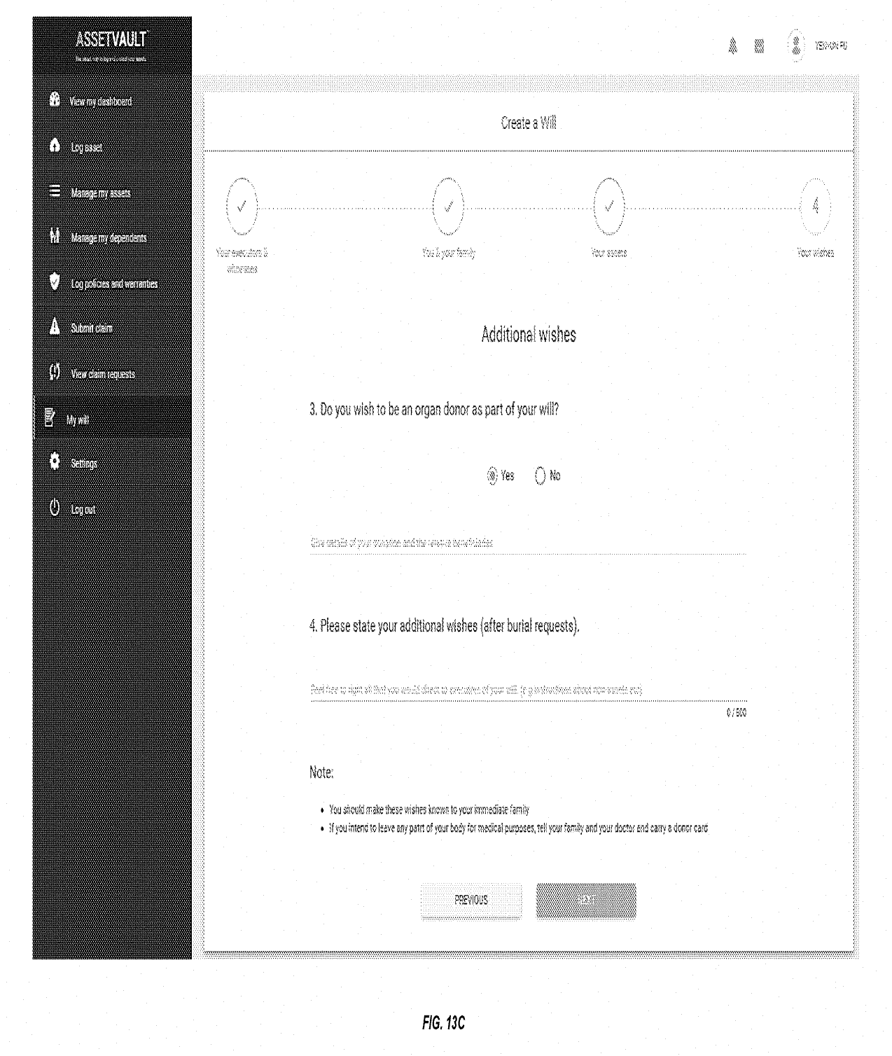

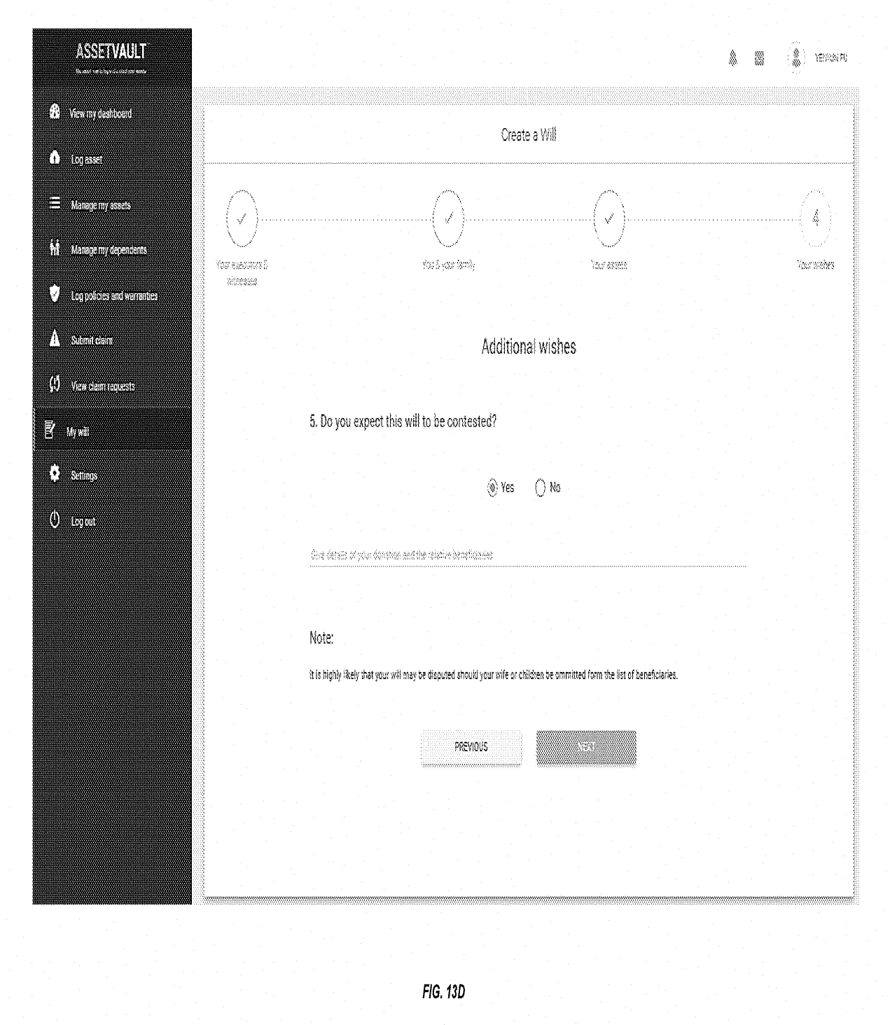

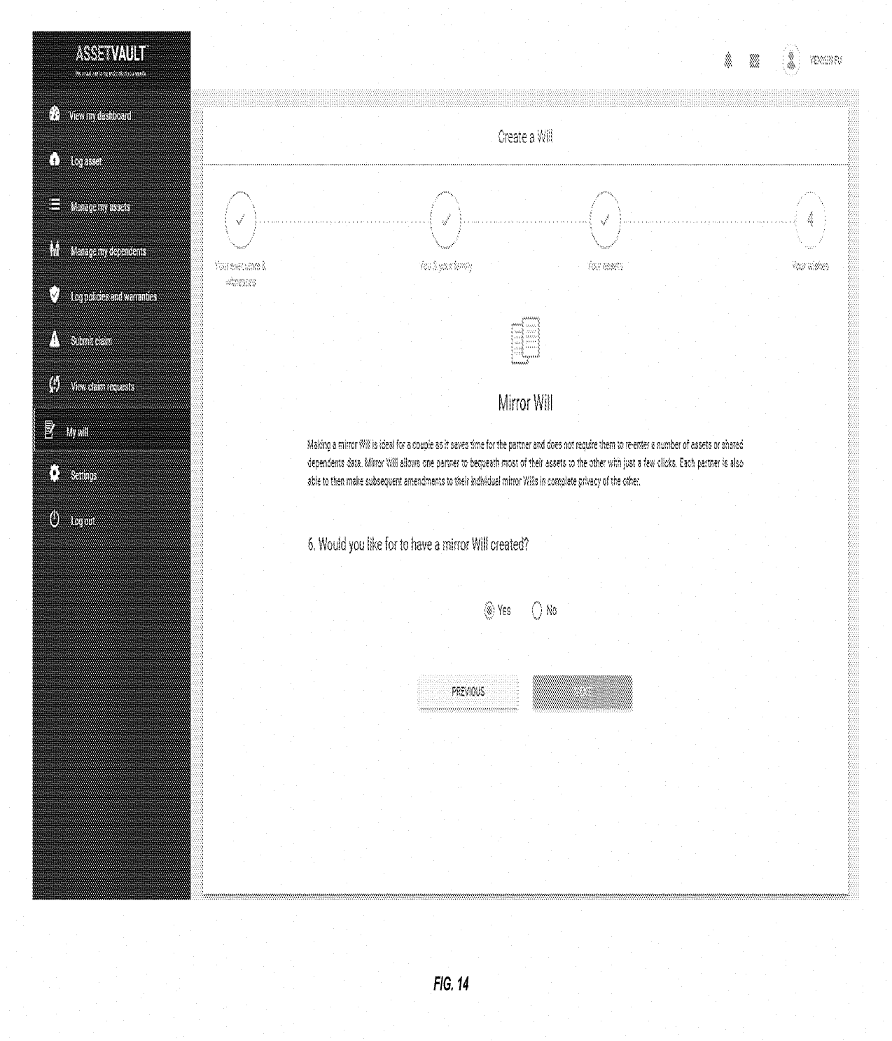

FIG. 13A-D depict additional example screenshots of the web application administered by the host server (e.g., host server 100 or 300) for determining a user's preferences regarding funeral ceremony type, religious affiliation and any other wishes, according to one embodiment. FIG. 14 depicts an example screenshots of the web application administered by the host server (e.g., host server 100 or 300) which enables the user to create a mirror will. An example of a mirror will is included in Appendix I. FIG. 15 depicts an example screenshot of the web application administered by the host server (e.g., host server 100 or 300) which enables the user to create a video message to be delivered to family members or other beneficiaries upon the occurrence of a life event, according to one embodiment. FIG. 16 depicts an example screenshots of a will and testament created by the host server (e.g., host server 100 or 300) for a user and recorded in the ledger platform (e.g., ledger platform 112 or 212) for access and administration by authorized individuals (e.g., executors, trustees, family members, other beneficiaries), according to one embodiment.

FIG. 17A-N depict example screenshots of a mobile application administered by the host server (e.g., host server 100 or 300) for secure management and monitoring of assets and asset information on a ledger platform (e.g., ledger platform 112 or 212) in accordance with embodiments of the present disclosure, according to one embodiment.

In one embodiment, there is a will template document associated with a corresponding jurisdiction. For example the system can store a will template that is usable in the U.S. in the State of New York, or a will template for use under the laws of England, or Hong Kong. The template document is filled in with information that the system already has learned from interaction with the customer, for example, name, address, next of kin. In this embodiment, the user can select what location their residence is, and, utilize the template that corresponds to their residential location. In addition, some jurisdictions require a will drafted under that local law to govern the disposition of assets within that jurisdiction. In this embodiment, if the system detects that the input data describing an asset includes a location in one of these jurisdictions, a new, additional will template is utilized for that specific asset. The system will automatically populate this new will document with the asset located in that jurisdiction, as well as populating the name and residence of the testator user. Once this additional document is generated, it is tracked and stored in the manner of the first will, but its applicability will be with regard to the location and therefore jurisdiction of the asset or assets located in that jurisdiction.

The system can be adapted to have a dynamic asset catalogue associated with a customer who has a will or testamentary document in the system. Using this mechanism, the customer can keep updating and though assignment or bequeathing a specific asset to an individual or part to a number of people would require re-execution of the eWill (or “electronic will”) if unexecuted at the very least the list of assets is up to date and would go into the residuary estate. In another embodiment, the testator/user, can update the list of assets that is associated with a will. For example, if Joe Smith acquires a vacation home, Blackacre, the asset list can be amended to recite Blackacre. In one embodiment, the user can input selection data indicating that Blackacre is subject to an existing provision that governs the disposition of real property. In another, the disposition of Blackacre may be specified, e.g. the recipient is designated and the provision integrated into the will. In this case, the will may have to be re-executed.

The system also has a facility to use recorded video to document the electronic signature process of a testamentary document. Multiple videos can be recorded and then provided to those that the testator wants to leave private messages to. This helps with identifying the testator also as well as helping older testators with verifying that no senility has set in. The system may also be adapted to include a set of test questions to the testator and record the answers in order to demonstrate that the testator was not suffering from dementia or outside pressure to sign the documents.

In one embodiment, the eWill may be executed with witnesses on line. In this embodiment, the system responds to a command from the user to enter the “Execution” mode. At this point, if the user has not input the identities of the witnesses to be used, the system requests from the user the identities of the required witnesses. This may be input as alphanumeric text or by means of selecting within a dialogue box, a person or persons listed in the user's contact list. In one embodiment, the witness contact information includes data representing a way of contacting or communicating with them electronically, for example, by email, telephone call or text. The system can then formulate an invitation message comprised of a hyper link, and further comprised of alpha numeric text information reciting a schedule for the will to be executed. This invitation is transmitted electronically to the witness. As a result, at the appointed time, the system activates the hyperlink in the invitation message so that the witness can use their remote device to activate the hyperlink and as a result, a process starts on the server side and a process on the remote computer the user is operating, so that an environment is created that is perceived as a video chat room, that is, the camera on the user's computer is activated and the video data routed through the server to the witness' computer, and the computer on the witness' computer is activated and the camera data from that routed to the server and the testator's computer. In this manner, the witnesses may observe the testator and witness the signature of the testator on the electronic will document.

In one embodiment, during the execution session, the witnesses and the testator can all see and hear each other. Furthermore, the server can record the three screen shots that are being shared, that is, make a real-time recording of the chat room session. The recording is audiovisual data stored in a computer file on the server or on a disk farm accessible by the server. This file recording may be used later to verify the witness and the health of the testator. Execution of the eWill is completed by the testator and witnesses signing the document, using e-signatures or more conventionally, by uploading a signature page with their signature on it. The sequence is for the testator to sign first, and then the witnesses. Upon completion, the video recording is stopped so that a complete digital video file may be saved in the system. A hash code or digital signature is generated for this file and embedded into it in order that later, it can be confirmed to be genuine. The same process applies to any image of a wet-signature used by a witness instead of an electronic signature. The video file and image file are stored in a data repository and a reference to them are added to the system database record associated with the testator and this will. The hash code or digital signature is then entered into the ledger in order to carefully secure the integrity of the video. The hash code is also entered into the will data record so that the executed will data record may be indexed. During execution of the document, the document is presented in the video chat room as a shared web-page. The testator has to click their electronic signature first (or upload a wet signature) while the witnesses logged in an active. Once testator has clicked, witnesses click to sign, then execution is completed. The electronic will is then recorded, stored, and encrypted, and/or signed and then the signing key can be inserted into the secure ledger.

The system can also be adapted to maintain in its database and secure ledger references to life insurance policies to benefit the customer's next of kin or other specified beneficiaries. The system can store a insurance policy contract as an electronic document that is digitally signed and has a key that is integrated into the system ledger in order to confirm its validity.

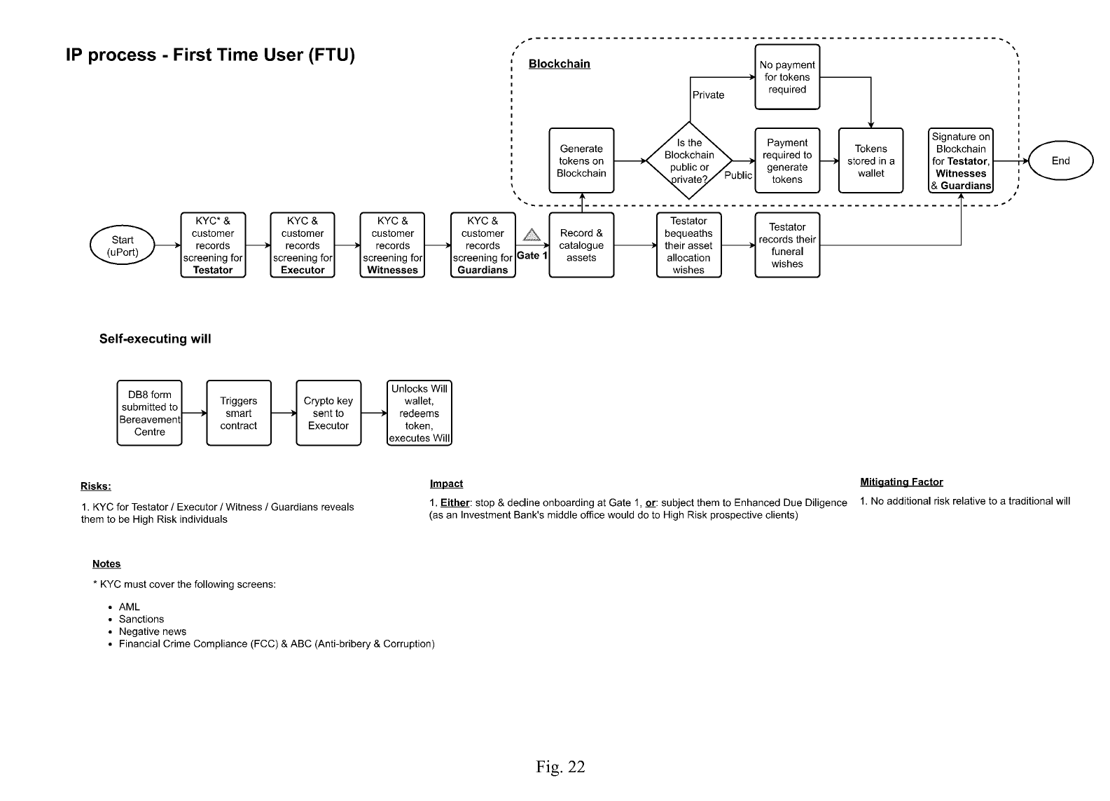

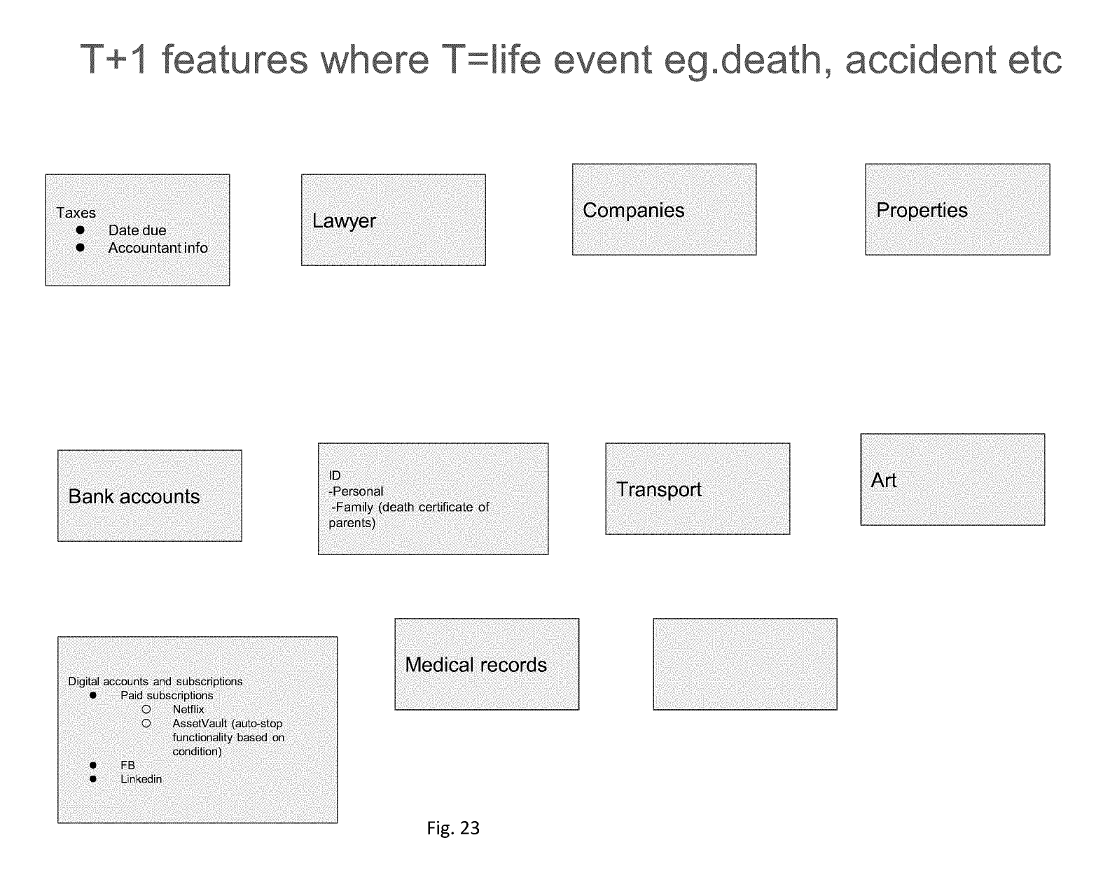

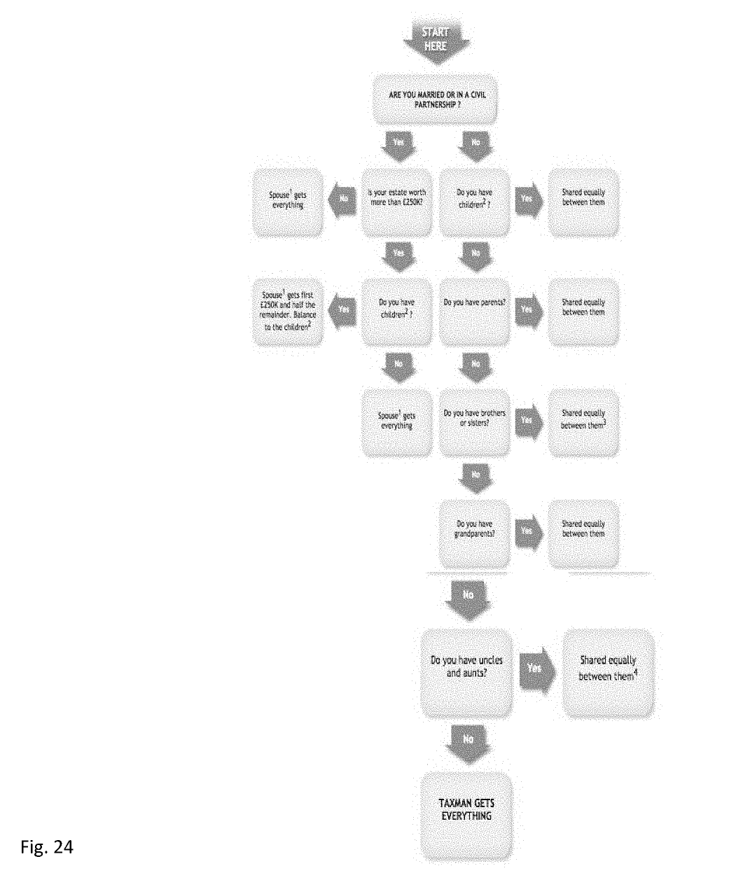

Turning now to FIG. 22, the system is adapted to automatically generate a testamentary document. By testamentary document, it is meant legal documents that are or are similar to a will, a trust, a life insurance policy or other legal document that governs the disposition of the customer's assets or benefits upon their demise or incapacity. In the first step, an executor or executors must be appointed. The customer may select executors from a pull down menu, who have been pre-approved by the system. Alternatively, the customer may input the name and contact information for a proposed executor as alphanumeric text. The system can search a database of individuals to check their credit records, criminal records, or other legal status records in order to obtain information or parameters about that individual. Examples of such parameters are: whether they have declared bankruptcy, whether they have been convicted of a crime, whether their credit record indicates a credit risk. These parameters can be used by the system to determine the adequacy of the executor by calculating a quality score function that takes the search result parameters as input. One example is to calculate a quality score that is a linear combination of the parameters. If the calculated score is exceeds a predetermined threshold, the proposed executor is approved and the process continues. When the executor is assigned, the executor is provided a private digital decryption key and the entire will data record is encrypted with the executor's public key. In other embodiments the administrator of the system shares that private key with the executor. In yet other embodiments, the encryption keys can be structured so that the administrator has a master key over all of the executor private keys, that is, the executor private keys may be stored by using the administrator's public key to encrypt them. In addition, the testator would have a key that permits the testator to have read only access to that version of the electronic will data record. Revisions would require recycling through the execution phase so that a new digitally signed or encrypted document version is created with its new time stamp.

Next, the actual electronic will, is prepared, and is comprised of a data record that contains the pertinent information that the will governs as well as the governing language of the will in the form of text. First, the customer inputs data that lists the assets, and selects the type of asset, either by typing in the category, or selecting from a set of predetermined categories that are displayed in a pull down menu. For example, the customer may select “real property”, and then type in “Whiteacre”, and an address: “123 Old Farm Road . . . .” Additionally, they may select “Artwork” and type in “Starry Night by Vincent Van Gogh.” Each asset in the list is then associated with a encryption key or digital signature element, called a token. Tokens are stored as part of the will data record. When an asset is entered, the entry includes a time stamp. To create the tokens, the system inserts the asset entry into the data record representing the will, and then the entire data record is digitally signed to create a token for the data record in the secure ledger system. The will data record may be expanded by adding or removing assets, in which case the data record is signed anew, and the ledger updated with the new token and time stamp. The time stamps themselves may be digitally signed so that the sequence of changes to the will and the asset list are verifiable.

The electronic will data record is in essence a set of rules because each asset and its disposition can be considered a rule, conditioned on a logical event, for example, the demise of the testator, and the age of the beneficiary, for example. The rules results are determined and its result may also be the re-allocation of an asset token from the will to the beneficiaries' will data record, an update to the ledger with that change. In another embodiment, each token represents a planned conveyance from the customer as testator to the beneficiary or heir. The token may represent a stated percentage ownership in a larger asset. The electronic wills may be maintained as a private database of encrypted will data records, and the ledger only contains the keys and tokens that verify the will data records as being genuine and unmodified.

The operation of the system results in a database of electronically encoded wills that are digitally signed, and further, their encryption tokens are stored in a secure ledger. The ledger may use encryption techniques, such as digital signing, to establish the veracity of the ledger contents—such that ledger contents cannot be altered or removed without being detectable. The ledger may take many forms. In one embodiment, the entire ledger is encrypted by an administrator of the system (or one with administrative authority). In this case, each revision to the ledger is encrypted using the public key of the administrator each time it is updated, and the prior encrypted version discarded. In another embodiment, each new element in the ledger, as it is added, is digitally signed against the prior ledger contents, in order that the new element and the prior ledger contents constitute a verified update. In some embodiments, the digital signature calculation or encryption calculation utilizes numbers that are pairs of predetermined prime numbers. In other embodiments, the digital signature or encryption calculation utilizes pre-determined hash functions. The ledger may utilize distributed architectures, peer-to-peer architectures or be maintained privately.

When the customer passes away, the system is then utilized to begin the process of asset distribution to the heirs or designated beneficiaries. First, the executor is contacted by the system, using the information provided. The executor logs into the system using the private key. This triggers a number of actions as a result of the electronic will being organized in the data structure. If the will specified beneficiaries that are also users of the system, the system uses the disposition rules encoded in the will to update the asset lists of the beneficiaries with the assets designated in the will that has been triggered. Where an asset it listed as passing to a group of heirs, then their respective asset lists are updated with the designated share in the will. In some embodiments, the rules that are to be triggered are determined and then displayed to the executor. The executor can then select one, several or all of the rules to be processed. For rules that the executor chooses not to process, for example, where additional legal confirmation may be required, the system maintains a new data element for the customer data record that tracks which rules were processed and which are pending. As the executor completes their task, this data record may be updated.

The system verifies the prior execution of the will by checking that the time stamp on the will entry in the ledger is the latest one. In this embodiment, the system obtains the time stamp from the latest change stored in the will data record, and then verifies that the data record has not been tampered or revised by using the encryption token stored in the ledger document. The executor fetches the unencrypted electronic will document using their private key, and uses the ledger to confirm that the document is genuine. In order to protect the integrity of the data, the Executor only has read only permission.

The payout operation may be triggered by the Executor logging into the system and inputting a command that represents notification of the demise of the customer. In other cases, it may be receiving an electronic message from an appropriate government agency constituting a death certificate or a judge's order. The executor would have to confirm the document and a mechanism to receive a validation result is provided. The will data record is then updated to include as an element the status flag of the document as active. A flag in system to is utilized to activate executor once the certificate is input. In one embodiment, the executor gets their keys upon the validation of the death certificate by the system administrator, that validation is a click through that gets time stamped and put into the ledger, a scan of the certificate is input and added the will data record. That image is also is processed to calculate a hash that is inserted into the image file. In other embodiments, the executor is provided the private key on demand by the executor, and then the executor either inputs the death certificate or receives it from the system. The executor can then, by means of a digital signature, certify to the certificate's genuineness and the will data record would then be updated with that certification, thereby activating the will to be processed.

In any case, the administrator, upon receiving the death certificate document can verify its correctness by inspection. The document is scanned into an image file and stored in the database with a reference that connects it to the customer's electronic will. If there is more than one Executor then all may have access to the database and the ledger independently. The system may use a process to check that the other executor is consenting to being an executor. A consensus model for the logic may be used for distributing both keys. For example, an executor may have to click through an on-line contract consenting to being the executor in order to obtain the private key. In this manner, if one executor dead or declines to be executor, they don't get the key and system logic then does not require their signature in order to process any pending will rules that dispose any interest in any assets.
For a given will, there is a data record that is created and stored in a database comprised of at least several elements:
Customer contact information. (encrypted with customer public key).
Will document (encrypted with customer key public)
Identity/contact of the executor (decrypted, in the clear)
Public key of this will (unencrypted)
Recording of the execution process with witnesses.
Identity of witnesses (encrypted with customer key)
1. Second copy of the will encrypted with executors public key or
2. Key architecture where executor and customer can access the will document independently with 2 different keys, but not simultaneously, after death the executor key is active and testator key is deactivated. So that where it says “customer public key” the executor can still access after the customer is determined to have passed away.

The system process, in one embodiment, is conducted as follows:
1. Receive a command to create an ewill. This would typically be performed at the server as a result of a customer operating a browser on their remote device, and the browser software interacting with the server over HTTP, or more likely HTTPS. The customer may input their information to be stored in the data record, including full legal name, address, tax identifier (or other government issued identification number), a picture of themselves.
2. The server then creates in the database an ewill data record, and begins storing the initial information into the corresponding data element locations for the data record. Further, the system can create a unique user-id number that can be used so that the data records may be processed in a relational database or for other purposes, where anonymity is required.
3. The customer can then input a list of assets. This can include identities of bank accounts, by name, institution, account number, office location. This can also include the address of properties. In addition, the system can receive property tax identifiers or other indicia that the applicable governing jurisdiction uses to specify a particular property. The customer can use a pull down menu to select an asset type to be associated with the asset entry.
4. The customer can then designate beneficiaries. This may be done by inputting alphanumeric text data representing specific names, for example, of children, with their addresses and tax identifiers. These identities are then stored in the data record as beneficiaries.
5. The customer can then select rules that designate which assets are allocated to which beneficiary, and how the asset is shared, or not. For example, the customer could allocate the family estate, Whitacre, to one beneficiary, and select a sharing allocation of “100%”. This can be accomplished by selecting a designated asset, and then selecting by menu, a designated beneficiary, and then inputting the percentage number. Alternatively, the allocation rule can be selected for a bank account asset as being directed to more than one beneficiary, with an allocation for “25%” for 4 children. Other forms of designation can be selecting a default term like “per stirpes”, which defaults to share equally among the descendants. In this manner, the ewill data record is comprised of data elements that operate as distribution rules when activated on the customer's demise, i.e. the customer, as testator is designating by logical rules input into the system how the listed assets are distributed. In the end, there will be alphanumeric text in the data record that represents rules of distribution for the designated assets. A rule may be comprised of alphanumeric text data that represents a reference to the asset, a reference to one or more beneficiaries, and a reference to a share amount.
6. Additional rules may be selected for assets that are not listed, for example, that remaining assets not listed are distributed “per stirpes”, or alternatively, “equally among named beneficiaries.” Additionally, there may be a default designation selected that remaining assets are shared among all descendants equally.
7. Other rules typical in a testamentary document may be selected, for example, the system can query whether for a particular asset, if the beneficiary has pre-deceased, that the share be distributed “per stirpes” to the beneficiaries' issue.
8. Once the customer is satisfied with the ewill document (document meaning the ewill has encoded in the system), the ewill data may be printed out on a form for the customer's records. However, at this point, it typically is not legally binding.
9. The customer can then open dialogue box in order to input text representing the identity of two witnesses and an executor. The information input may include legal name, address, tax identifier and a picture, email address or other electronic contact designation. This information is stored in the data record representing the ewill. In one embodiment, the administrator of the system may be designated as an executor.
10. The system can then automatically contact the witnesses to obtain their consent. If the person does not respond within a predetermined time, or answer with a “no”, then the system sends the customer a message indicating that and invites the customer to re-designate a witness.
11. Once the two witnesses have been designated, the system then uses their identifying information to formulate queries that are submitted to one or more databases that store information about credit histories, criminal histories and the like. If the system comes up with information that according to heuristic rules encoded in the system that are applied to the data received from the database, are relevant to the fitness of any of the three parties, the system transmits a message to the customer indicating the situation, using the received information and the output of the heuristic rules. For example, if submission of a person's name into the U.S. PACER system results in obtaining their name on a legal case, and the system further downloads the complaint, and the text contain the string “fraud”, the system can formulate a message that may be transmitted to the customer that recites “Person X has been sued for fraud in New York, N.Y., and the case is still pending.” The customer is then presented with a window that permits them to re-designate a new executor, or accept the currently designated one.
12. Once the executor and two witnesses have consented, the system is in a state that it may then schedule an execution of the ewill. The logic of this step may be modified in order to comply with applicable jurisdictions, typically as designated by the location of the customer's domicile, as input by the customer. For example, the number of witnesses, their age or location may be different than the example given. The system can transmit emails to the customer and two witnesses specifying a proposed time. The witnesses and customer may cycle through several of these emails to specify a unified time for an execution session.
13. When the designated session arrives, the system transmits links to the customer and the two witnesses. The customer and witnesses operate browsers on their respective remote devices, such that, when the links are activated, the system launches a chat room application, where the cameras and microphones on all three remote devices are activated, and audio visual data received from one remote device is shared with the other two.
14. The shared screen includes a representation of the e-will created by the customer. Further, the system transmits to the browsers code that when operated by the browser permits the customer and witnesses to input an electronic signature, or upload a scan of a signature. In addition, the system commences recording the video chat room session, including the shared screen.
15. During the session, the customer than activates their electronic signature, or uploads a scan of their signature. This is presented on the screen to the two witnesses. At this point, the witnesses can activate their electronic signature or upload a scan of their signature in order that the executed ewill has two witnesses.
16. The system stores the electronic or scanned signatures in the data record for the ewill, an further digitally signs and stores the recorded video file and stores a reference to the video file in the ewill data record.
17. The system is now prepared to encrypt and digitally sign the entire ewill. First, the date and time are stored in the data record representing the ewill. This is essential information in order that the system determine which of these documents are the “last” will of the customer. The encrypted ewill is stored in the database, and further, an unencrypted database entry is included where the customer name and identity is linked to the encrypted ewill. In addition, an encryption token or digital signature is generated for the ewill. This token is then inserted into the ledger in order that the entire transaction be recorded and at a future date, determined to be genuine. The step of transmitting an image of a printable version of the document (as noted in step 8) may be performed here, and representations of the electronic signatures included in the printable image.
18. If the customer (i.e. testator) decides to change the e-will, they will have to log in and use their decryption keys to open the document. In reality, a new ewill is created and stored as a new data record. The document is read into the system in order to create a new data record that can be further modified. The document is not effective until the steps beginning at 10-17, above are repeated in order that it become the “last” will of the customer.
19. When the customer/testator has died, then the unencrypted database will store a data element indicating that the ewill is active. This may include public documents, for example, a data record is updated to include a death indication and a reference to a stored file containing the scanned death certificate or other document, for example, a judges order that a missing person is dead or an order that the person is incapacitated.
   One consideration for the ledger is to make the data structure resistant to malicious acts over the long term. One technique is to maintain a private ledger that is housed in a secure computer account and facility. In one embodiment, a quantum-resistant signature scheme is used, which replaces any vulnerable public key cryptography (PKI) used for signing and verifying transactions with lattice-based encryption key constructions. In one embodiment, the ledger doesn't utilize the PKI or product of primes methodologies, but rather pre-known hash or cyclical functions applied to the data set whose computational complexity exceeds typical PKI encryption schemes. In another embodiment, the system prints out a physical copy of the eWill, with a hash value printed on the bottom of each page. That hash value can be validated later to confirm the printed page is genuine. In yet another embodiment, the hash function can ignore blank spaces and blank lines in order that these formatting conventions don't confuse the hashing function if the text has to be hand-entered from the paper document in order to verify the hash value.

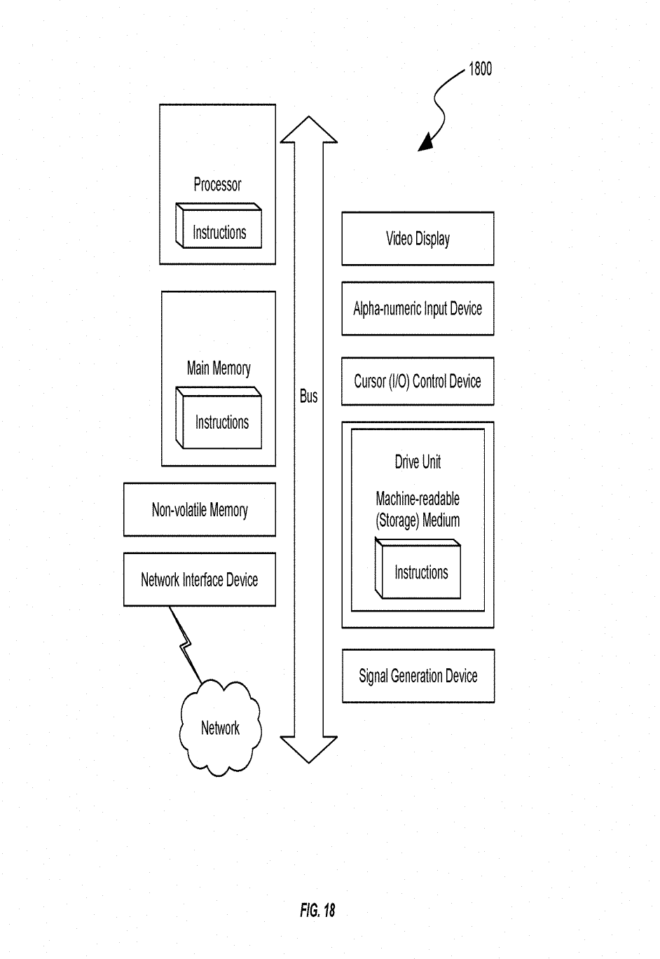

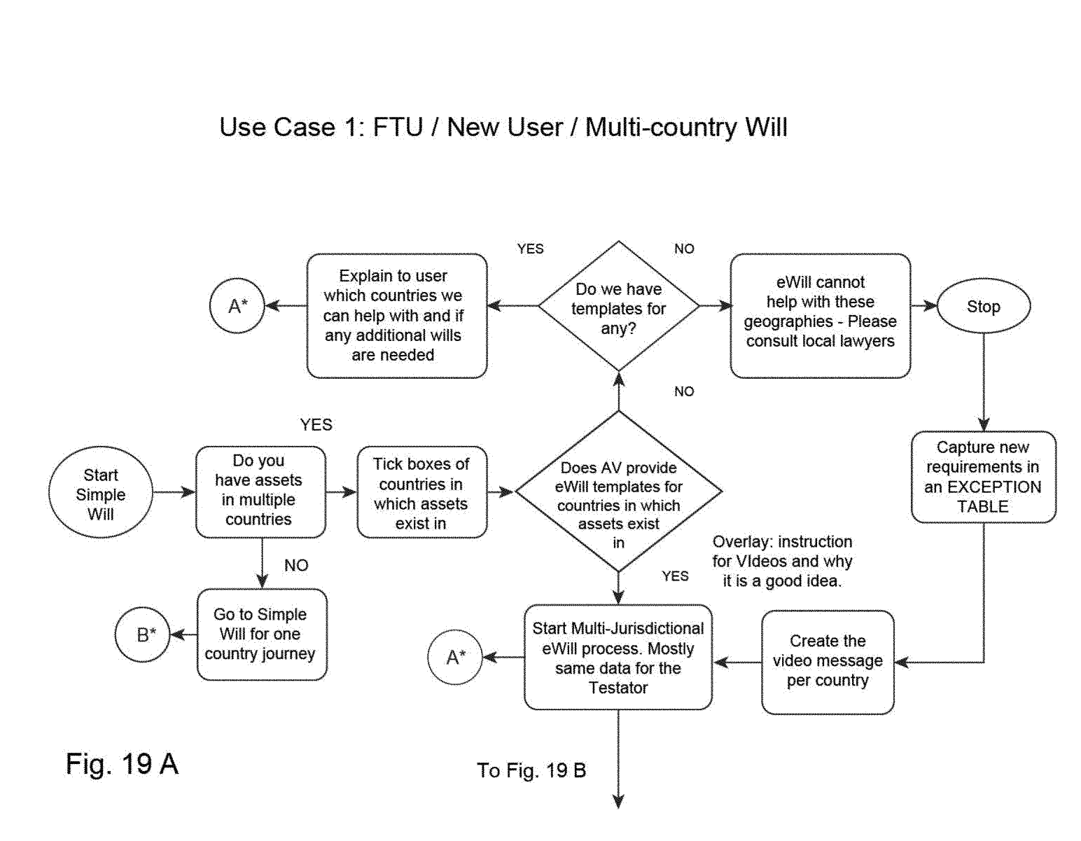

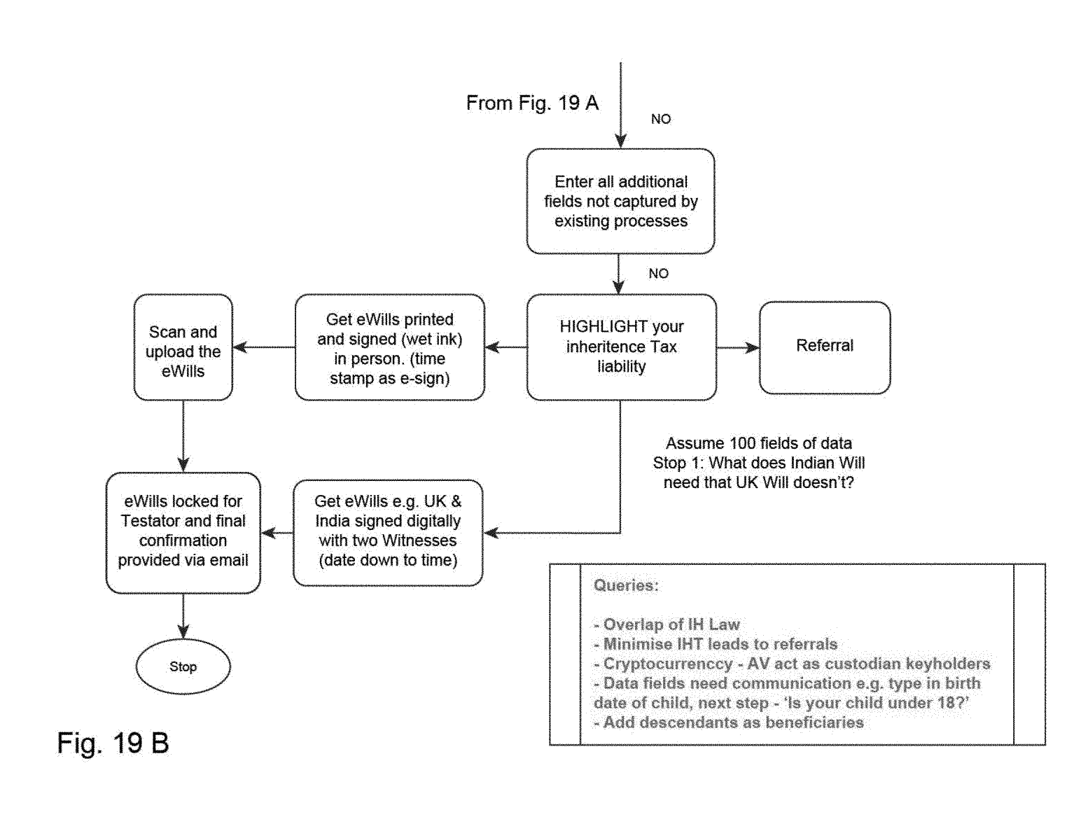

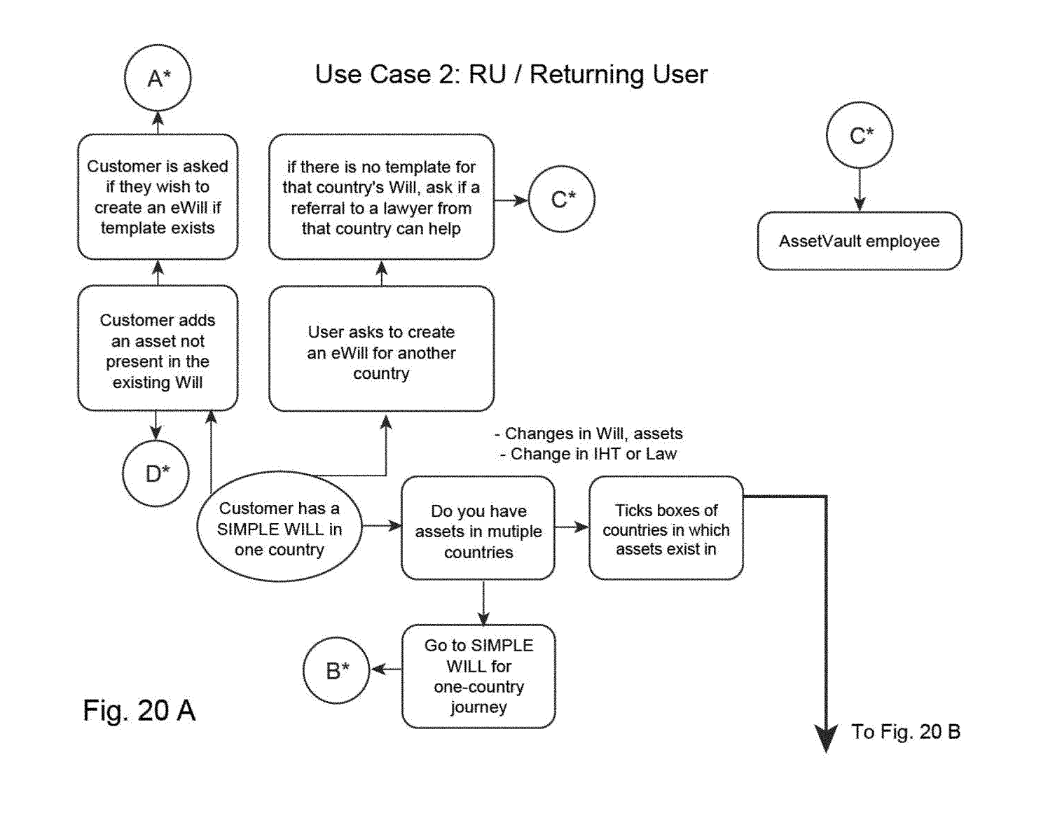

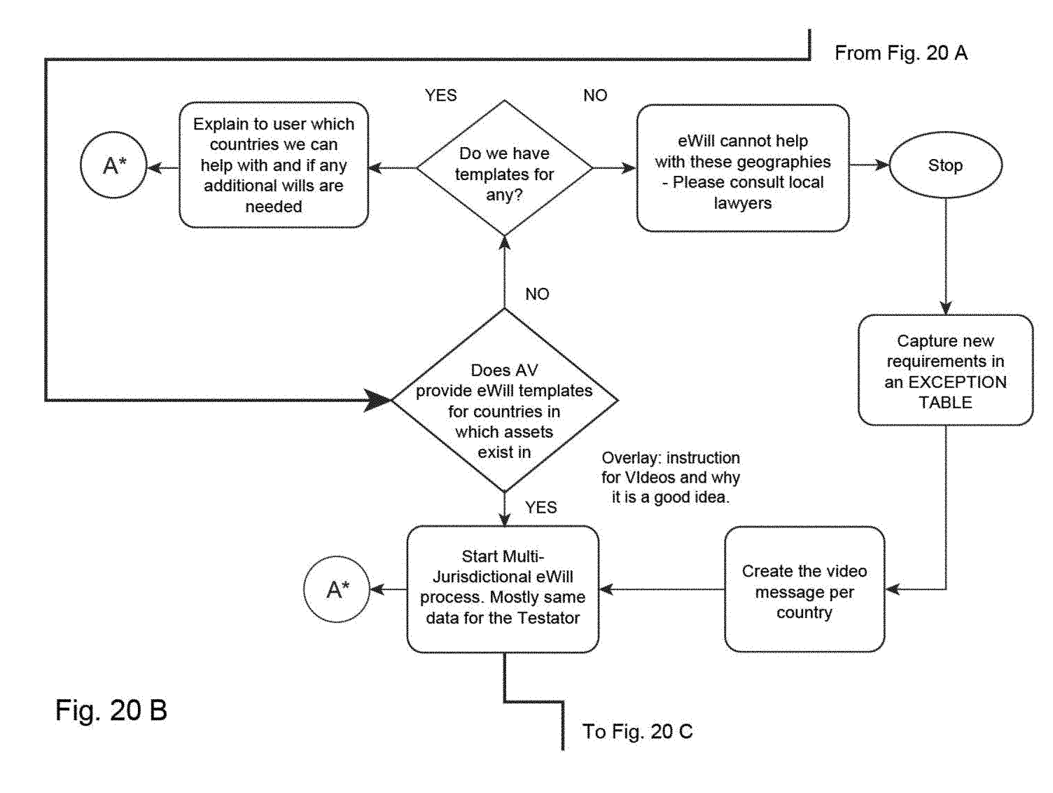

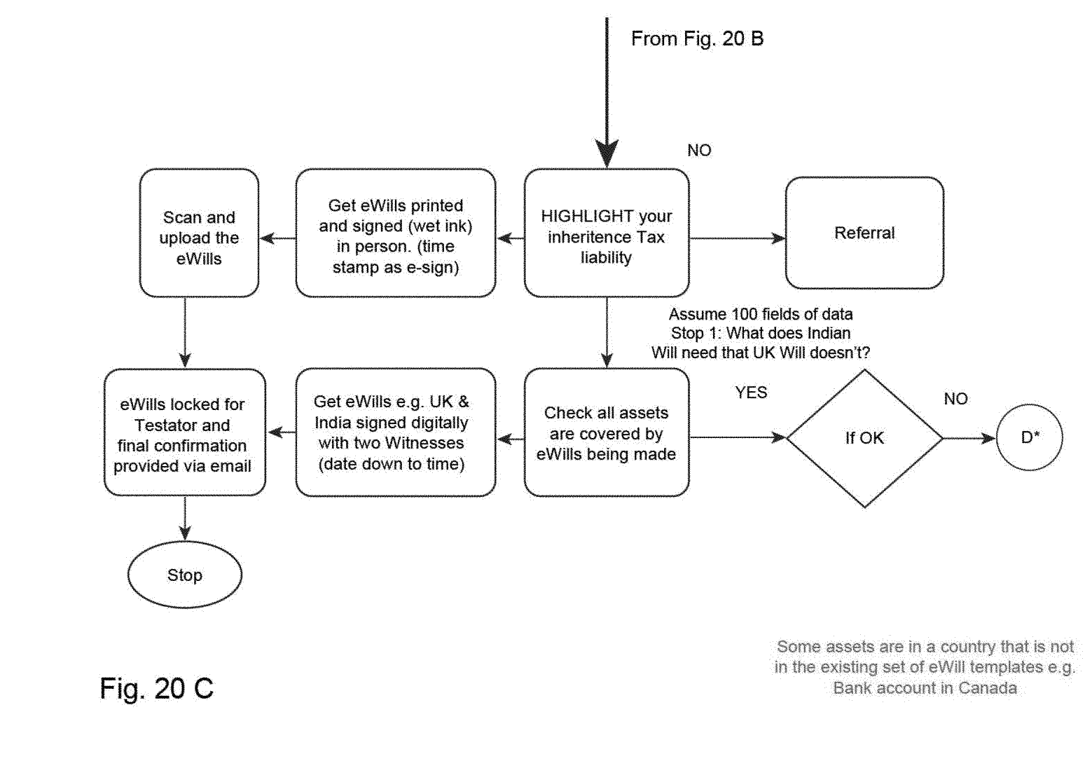

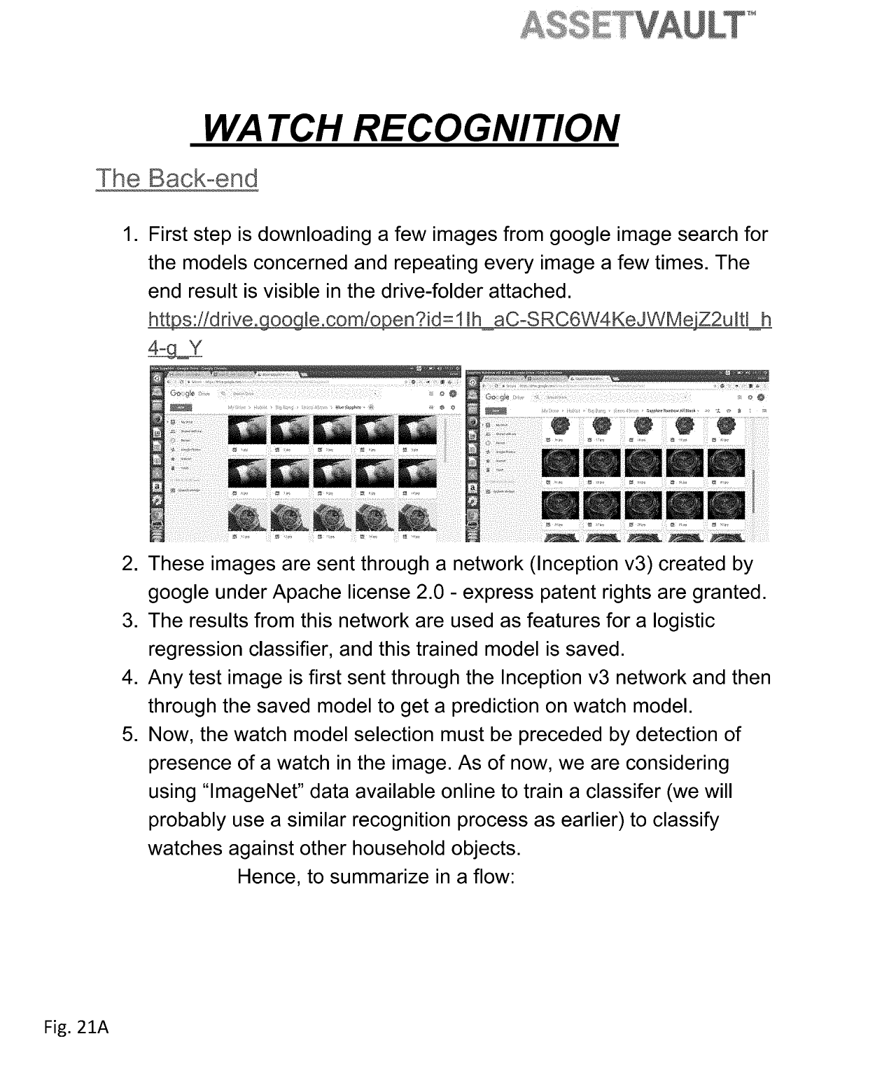

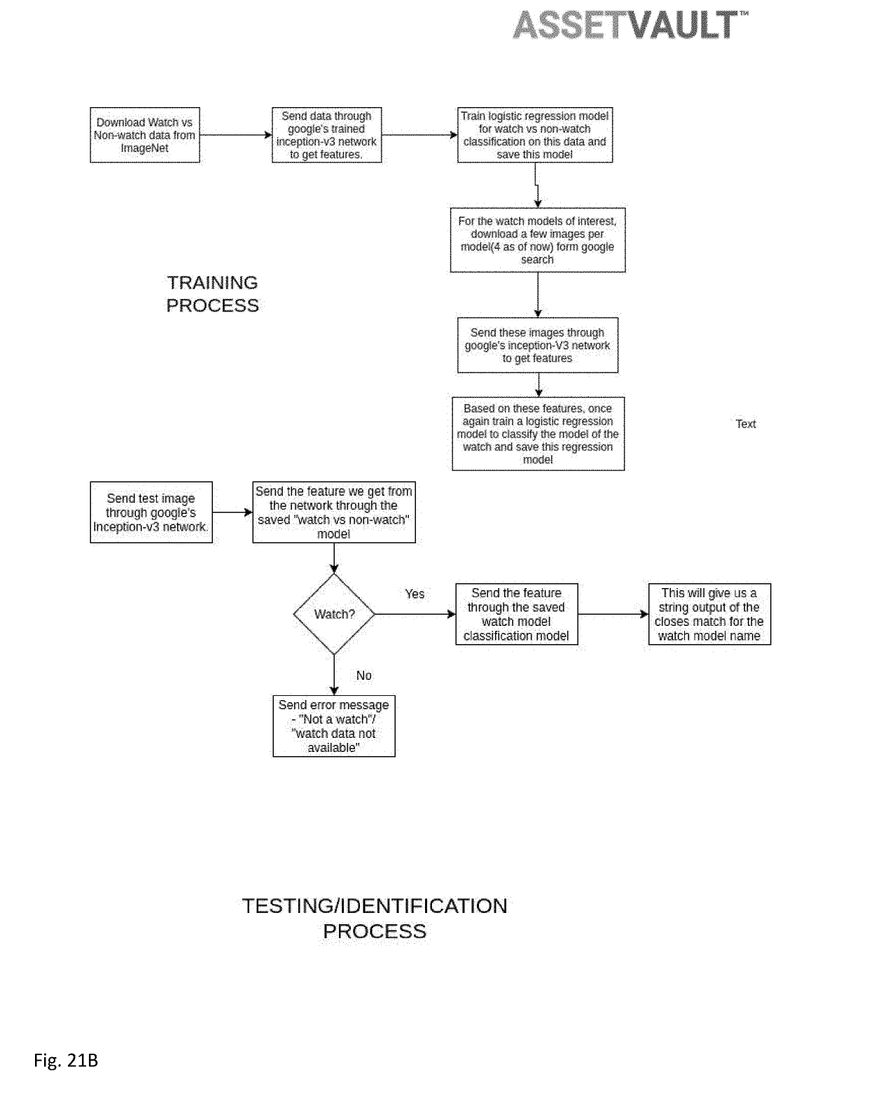

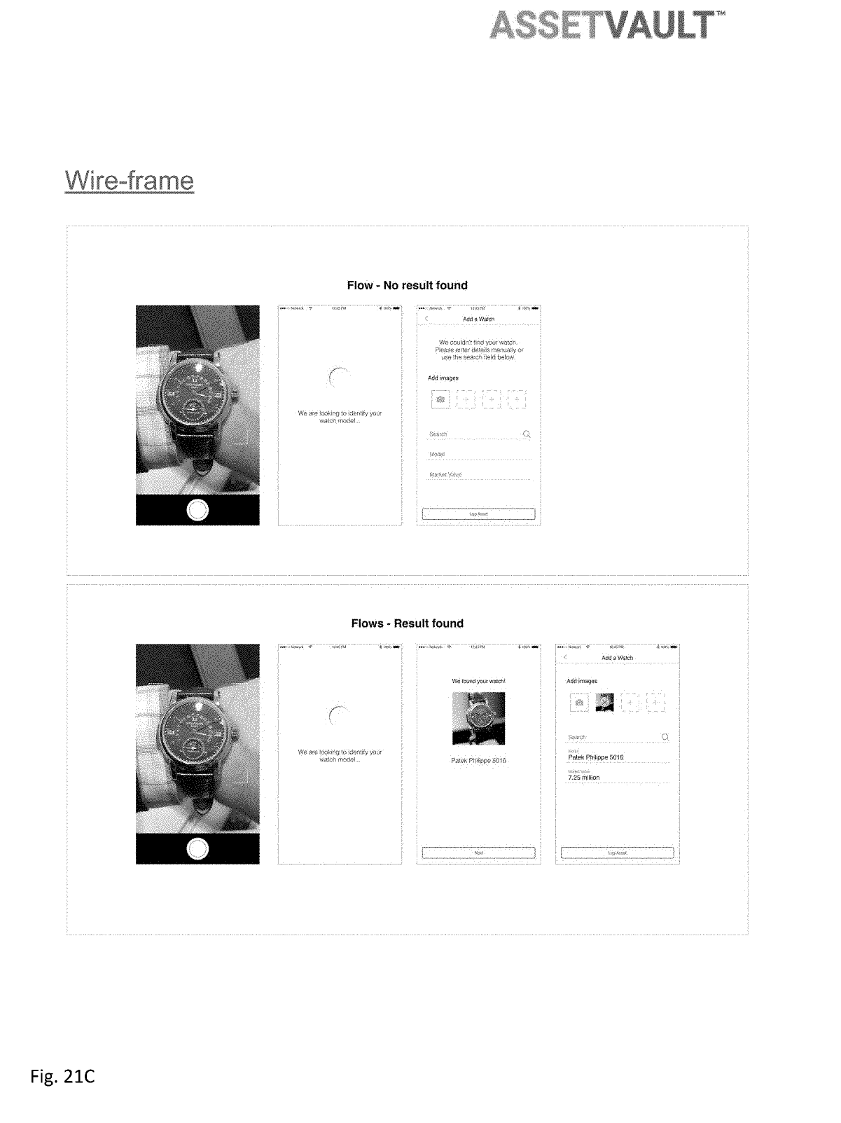

FIG. 18 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. Additional embodiments are described in the attached Appendix, which is incorporated into this Specification for all that it teaches.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand• held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine• readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1800 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, 16, other aspects may likewise be embodied as a means-plus-function claim, or in other forms, such as being embodied in a computer-readable medium. (Any claims intended to be treated under 35 U.S.C. § 112, 16 will begin with the words “means for”.) Accordingly, the applicant reserves the right to add additional claims after filing the application to pursue such additional claim forms for other aspects of the disclosure.

### Operating Environment:

Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems. In some instances, especially where the mobile computing device 104 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The user's computer may be a laptop or desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The system and method described herein can be executed using a computer system, generally comprised of a central processing unit (CPU) that is operatively connected to a memory device, data input and output circuitry (I/O) and computer data network communication circuitry. A video display device may be operatively connected through the I/O circuitry to the CPU. Components that are operatively connected to the CPU using the I/O circuitry include microphones, for digitally recording sound, and video camera, for digitally recording images or video. Audio and video may be recorded simultaneously as an audio visual recording. The I/O circuitry can also be operatively connected to an audio loudspeaker in order to render digital audio data into audible sound. Audio and video may be rendered through the loudspeaker and display device separately or in combination. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The system may be comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture do not limit the claimed invention.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of a website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML or scripting languages that are executed by Internet web-browsers) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Also, while processes or blocks are at times shown as being performed in series, these processes or blocks may instead be performed or implemented in parallel, or may be performed at different times.

1. (canceled)

2. (canceled)

3. A computer system comprised of at least one server and at least one remote device connected to the at least one server using a data network, for securely verifying a signature data object associated with a predetermined document stored on the server comprising:
a module adapted by logic to implement a video chat room session that for a predetermined period of time by receiving from one of the at least one remote devices an audiovisual data stream;
transmitting to each of the other at least one remote devices the audiovisual stream received from the one remote devices;
and recording the audio visual data stream that is received for the predetermined period of time into at least one video data file stored on the server;
a module adapted by logic to transmit to at least one remote device data at least a portion of the predetermined document;
a module adapted by logic to receive from at least one remote device the data object representing a signature,
a module adapted by logic to generate a first cryptographic token to be associated with the document, use the security token to modify at least a portion of a ledger data structure to associate the document with the recorded video and the received electronic signature and store the modified portion of the ledger data structure.

4. The system of claim 3 where the ledger module is further adapted by logic to store the signature data object integrated with the document file.

5. The system of claim 3 where the ledger module is further adapted by logic to modify the predetermined document file by digitally signing it using the first or a second cryptographic token.

6. The system of claim 3 where the ledger module is further adapted by logic to digitally sign the video data file using the first or a second cryptographic token.

7. The system of claim 3 where the ledger module is further adapted by logic to digitally sign the received signature data object using the first or a second cryptographic token.

8. The system of claim 3 where the predetermined period of time terminates in dependence on the time of receipt of the signature data item.

9. The system of claim 3 where the document file is encrypted and the system is adapted to decrypt the document file prior to transmitting the portion of the file.

10. The system of claim 5 where the ledger module is further adapted to encrypt the modified document file using the first or a second cryptographic token.

11. The system of claim 6 where ledger module is further adapted to encrypt the video file using the first or a second cryptographic token.

12. The system of claim 7 where the ledger module is further adapted to encrypt the signature data object using the first or a second cryptographic token.

13. A method executed by a computer system comprised of at least one server and at least one remote device connected to the at least one server using a data network, for securely verifying a signature data object associated with a predetermined document stored on the server comprising:
commencing a video chat room session for a predetermined period of time by receiving from one of the at least one remote devices an audiovisual data stream;
transmitting to each of the other at least one remote devices the audiovisual stream received from the one remote devices;
and recording the audio visual data stream that is received for the predetermined period of time into at least one video data file stored on the server;
transmitting to at least one remote device data at least a portion of the predetermined document;
receiving from at least one remote device the data object representing a signature,
generating a first cryptographic token to be associated with the document;
using the security token to modify at least a portion of a ledger data structure to associate the document with the recorded video and the received electronic signature; and
storing the modified portion of the ledger data structure.

14. The method of claim 13 further comprising storing the signature data object integrated with the document file.

15. The method of claim 13 further comprising modifying the predetermined document file by digitally signing it using the first or a second cryptographic token.

16. The method of claim 13 further comprising digitally signing the video data file using the first or a second cryptographic token.

17. The method of claim 13 further comprising digitally signing the received signature data object using the first or a second cryptographic token.

18. The method of claim 31 where the predetermined period of time terminates in dependence on the time of receipt of the signature data item.

19. The method of claim 13 where the document file is encrypted and further comprising the step of decrypting the document file prior to transmitting the portion of the file.

20. The method of claim 15 further comprising encrypting the modified document file using the first or a second cryptographic token.

21. The method of claim 6 further comprising encrypting the video file using the first or a second cryptographic token.

22. The method of claim 7 further comprising encrypting the signature data object using the first or a second cryptographic token.

23. A method executed by a computer system comprised of a server and the user's remote device and a witness' remote device, of verifying an electronic will document comprising:
Commencing a video chat session hosted on the server between a user's remote device and the witness' remote device;
Displaying in the chat session a will document;
Receiving from the user an electronic signature associated with the document;
Transmitting to the witness remote device the receipt of the electronic signature;
Recording the video chat session and encoding the recorded video into a digital video file;
Determining a digital signature for the digital video file;
Updating and storing a data record associated with the user to include a reference to the digital video file;
Recalculating a security token for the data record associated with the user;
Updating a ledger to include the security token and a reference to the updated and stored data record.
